(19) United States
(12) Patent Application Publication
(10) Pub. No.: US 2013/0145307 A1
(43) Pub. Date: Jun. 6, 2013

(54) DISPLAY APPARATUS AND DISPLAY METHOD

(71) Applicant: CANON KABUSHIKI KAISHA, Tokyo (JP)

(72) Inventor: Katsuhiko Kawasaki, Kawasaki-shi (JP)

(73) Assignee: CANON KABUSHIKI KAISHA, Tokyo (JP)

(21) Appl. No.: 13/677,624

(22) Filed: Nov. 15, 2012

(30) Foreign Application Priority Data
Dec. 1, 2011 (JP) 2011-264115

(51) Int. Cl. G06F 3/0488

(52) U.S. Cl. CPC G06F 3/04886
USPC 715/781

(57) ABSTRACT

A display apparatus according to the present disclosure displays a first page display region where a first page of a content is displayed, a second page display region where a second page of the content is displayed, and a fore edge region indicating presence of a page different from the first page and the second page. When touches to two positions including a first touch position on the first page display region and a second touch position on the fore edge region are detected as a touch operation of a user, the second page is changed to a page corresponding to the second touch position without changing the first page.

### BACKGROUND

### Description of the Related Art

In recent years, so-called electronic books have remarkably proliferated. Electronic books display an electronic book formed from image data (electronic document) of a plurality of pages on a display, thereby allowing the user to browse. In a conventional electronic book, the user presses the next page button or previous page button to increment or decrement the page to browse. There is also a method of dragging a double-page spread in the turning direction to turn over the page.

As a page turning method for an electronic book, the following method has been proposed (for example, Japanese Patent Laid-Open No. 2000-242390). That is, the user first touches the fore edge (the double-page spread portion on the side opposite to the spine) of a displayed electronic book and draws (drags) it. The page number of the page in the fore edge at the drawing position is extracted and displayed in a balloon. When the user moves the drawing finger off, the display jumps to the page of the page number displayed in the balloon. When the user touches the background portion, a bookmark is placed on the displayed page. A page number, a thumbnail screen, or a table of contents is displayed in the balloon as reference information.

In the page turning method described in Japanese Patent Laid-Open No. 2000-242390, reference information displayed in the balloon includes a page number, a thumbnail screen, and a table of contents. Even if the user wants to enlarge and read the reference information in the balloon, the reference information cannot be displayed as a reference destination page (reference page) of the same display area size or character size as that of the page (origin page) that is currently being displayed.

Additionally, in the page turning method described in Japanese Patent Laid-Open No. 2000-242390, if the user moves the hand off during drawing, the display jumps to the page in the balloon. Hence, the user cannot select whether to return to the origin page or jump to the reference page while simultaneously reading the origin page and the reference page and comparing the contents. It is also impossible to select a new page to browse by thumbing through the reference page while keeping the origin page fixed or thumbing through the origin page while keeping the reference page fixed. That is, the conventional technique of displaying an electronic book is susceptible to improvement in a flexible page display operation performed on a paper book.

### SUMMARY

According to first aspect of the invention, there is provided a display apparatus comprising: a display unit that displays a first page display region where a first page of a content is displayed, a second page display region where a second page of the content is displayed, and a fore edge region indicating presence of a page different from the first page and the second page; a detecting unit that detects a touch position on the first page display region, the second page display region, and the fore edge region displayed by the display unit; and a changing unit that, when touches to two positions including a first touch position on the first page display region and a second touch position on the fore edge region are detected as a touch operation of a user, changes the second page to a page corresponding to the second touch position without changing the first page.

According to second aspect of the invention, there is provided a method of controlling a display apparatus, comprising: a display step of displaying, on a display screen, a first page display region where a first page of a content is displayed, a second page display region where a second page of the content is displayed, and a fore edge region indicating presence of a page different from the first page and the second page; a detecting step of detecting a touch position on the first page display region, the second page display region, and the fore edge region displayed on the display screen; and a changing step of, when touches to two positions including a first touch position on the first page display region and a second touch position on the fore edge region are detected as a touch operation of a user, changing the second page to a page corresponding to the second touch position without changing the first page.

According to third aspect of the invention, there is provided a display apparatus comprising: a display unit that displays a display region where a content is displayed, and a fore edge region indicating presence of a page different from the page of the content displayed in the display region; and a detecting unit that detects a touch position on the display region and the fore edge region displayed by the display unit, wherein when touches to two positions including a first touch position on the display region and a second touch position on the fore edge region are detected as a touch operation of a user, the display unit displays a region where a first page of the content is stationarily displayed in the display region, and a region where pages of the contents are displayed while being turned over in correspondence with the second touch position.

According to fourth aspect of the invention, there is provided a method of controlling a display apparatus, comprising: a display step of displaying, on a display screen, a display region where a content is displayed, and a fore edge region indicating presence of a page different from the page of the content displayed in the display region; and a detecting step of detecting a touch position on the display region and the fore edge region displayed on the display screen, wherein when touches to two positions including a first touch position on the display region and a second touch position on the fore edge region are detected as a touch operation of a user, in the display step, a region where a first page of the content is stationarily displayed in the display region, and a region where pages of the contents are displayed while being turned over in correspondence with the second touch position are displayed on the display screen.

Further features of the present invention will become apparent from the following description of exemplary embodiments (with reference to the attached drawings).

### BRIEF DESCRIPTION OF THE DRAWINGS

FIG. 1 is a block diagram showing the arrangement of an electronic book according to the first embodiment;

FIGS. 2A and 2B are views showing the outline of the electronic book according to the first embodiment;

FIGS. 3A to 3H are views showing a page turning operation in a general paper book;

FIGS. 4A and 4B are views showing a page data structure according to the first embodiment;

FIGS. 5A and 5B are flowcharts showing page turning processing according to the first embodiment;

FIG. 6 is a flowchart showing single touch processing according to the first embodiment;

FIG. 7 is a flowchart showing double touch processing according to the first embodiment;

FIGS. 8A to 8T are views showing an example of screen transition by a page turning operation according to the first embodiment;

FIGS. 9A to 9I are views showing an example of screen transition by a page turning operation according to the second embodiment;

FIGS. 10A to 10C are views showing a page data structure according to the third embodiment;

FIG. 11 is a flowchart showing page turning processing according to the third embodiment;

FIG. 12 is a flowchart showing release state processing according to the third embodiment;

FIGS. 13A and 13B are flowcharts showing single touch processing according to the third embodiment;

FIGS. 14A and 14B are flowcharts showing double touch processing according to the third embodiment;

FIGS. 15A to 15R are views showing an example of screen transition by a page turning operation according to the third embodiment;

FIGS. 16A and 16B are views showing a page data structure according to the fourth embodiment;

FIG. 16C is a view showing a state in which the user is operating the electronic book;

FIG. 17 is a flowchart showing page turning processing according to the fourth embodiment;

FIG. 18 is a flowchart showing mode switching processing according to the fourth embodiment;

FIGS. 19A and 19B are flowcharts showing single touch processing according to the fourth embodiment;

FIGS. 20A and 20B are flowcharts showing double touch processing according to the fourth embodiment;

FIGS. 21A to 21L are views showing an example of screen transition by a page turning operation according to the fourth embodiment;

FIGS. 22A to 22C are views showing an example of fore edge display according to the fifth embodiment; and

FIGS. 23A to 23D are views showing another example of fore edge display according to the fifth embodiment.

### DESCRIPTION OF THE EMBODIMENTS

Hereinafter, embodiments of the present invention will be described with reference to the accompanying drawings. It should be noted that the following embodiments are not intended to limit the scope of the appended claims, and that not all the combinations of features described in the embodiments are necessarily essential to the solving means of the present invention. Each embodiment of the present invention is directed to a technique of, when displaying an electronic document on the page basis, enabling a flexible page display operation such as referring to another page in the same size, jump, or return while browsing an arbitrary page.

### First Embodiment

### Outline of Processing

The present invention implements the following functions in a display apparatus for displaying an electronic document having a plurality of pages on the page basis. First, a first page display region where a first page of the plurality of pages of the electronic document is displayed, a second page display region where a second page is displayed, and a fore edge region indicating the presence of pages other than the first and second pages are displayed. A user touch position on each displayed region is detected, and the first and second pages are set in accordance with the detection result. In a double touch state in which touch continuation at two positions is detected, pages corresponding to the two touch positions are set as the first and second pages.

The first and second pages are thus displayed in a comparable state. This enables to perform a page turning operation of, for example, selecting a page to browse or turning over the second page while keeping the first page fixed, as in a normal book.

Arrangement of Electronic Book

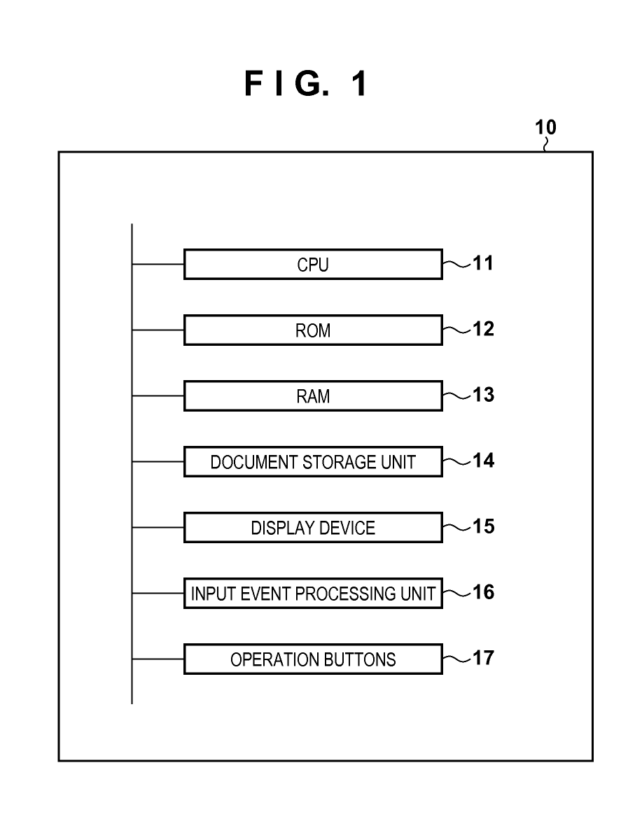

FIG. 1 is a block diagram showing the arrangement of an electronic document display apparatus for implementing an electronic book in the present invention. Referring to FIG. 1, reference numeral 10 denotes an electronic document display apparatus main body. The electronic document display apparatus 10 includes a CPU 11, a ROM 12, a RAM 13, a document storage unit 14, a display device 15, an input event processing unit 16, and operation buttons 17. The electronic document display apparatus 10 operates by causing the CPU 11 to read out a document browsing program stored in the ROM 12 and execute it. During the operation, variable data or document data to be used during execution of the document browsing program is read or written using the RAM 13. The document storage unit 14 stores electronic book contents (electronic documents) formed from texts and images in the order of pages. Note that the components of the electronic book contents are not particularly limited. An electronic book can contain only texts like a novel, or a mixture of texts and images like a paper, or only images like a photographic collection or an album. The display device 15 is formed from a display device such as a liquid crystal display, and a touch panel provided in front of the screen of the display device. The display device 15 displays a double-page spread of an electronic book, a fore edge for page turning, and other operation menus, and also detects a touch of a user's finger. The display device 15 is used to display a pseudo page turning operation screen corresponding to a touch operation. Note that the principle of the touch panel is not particularly limited as long as it can detect a plurality of touch positions. As a device for detecting a plurality of touch positions at once, a coordinate input device using a capacitance is known.

A user touch operation is detected and processed by the input event processing unit 16. The input event processing unit 16 analyzes to determine, for example, whether a touch on the display device 15 exists, whether a touch is a single touch operation or a double touch operation, or a touch is a tap operation or a drag operation. Touch states of this embodiment include a release state, a single touch state, and a double touch state. In the release state, no finger is in contact with the display device 15, and no touch is detected. In the single touch state, a touch at one position of the display device 15 is detected. In the double touch state, touches at two different positions of the display device 15 are detected. Note that state transition from the release state to the double touch state always occurs via the single touch state. The tap operation is an operation of tapping the touch panel by a finger. The drag operation is an operation of moving a finger kept in contact with the touch panel. If movement of a touch position is detected during touch continuation, this is determined as a drag operation state.

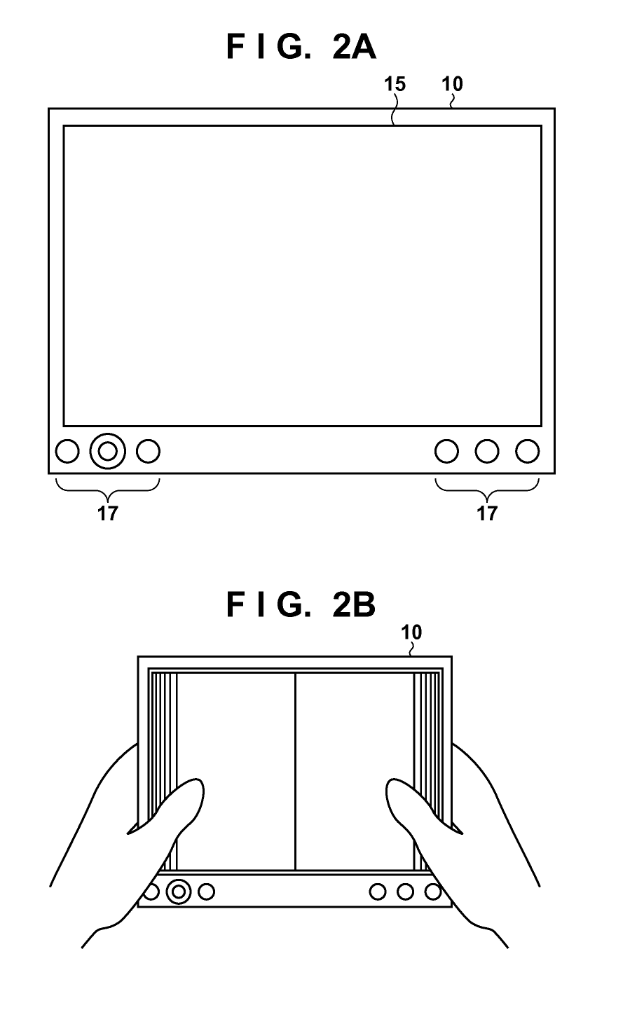

FIG. 2A illustrates the outline of the electronic document display apparatus 10 that is an electronic book. The electronic document display apparatus 10 will also be referred to as the electronic book 10 hereinafter. The display device 15 formed from a touch panel and a liquid crystal display, and the operation buttons 17 are arranged on the surface of the electronic book 10. FIG. 2B shows a state in which the user holds the electronic book 10 by two hands and performs the page turning operation while touching the display device 15 by fingers.

Page Turning Operation in Paper Book

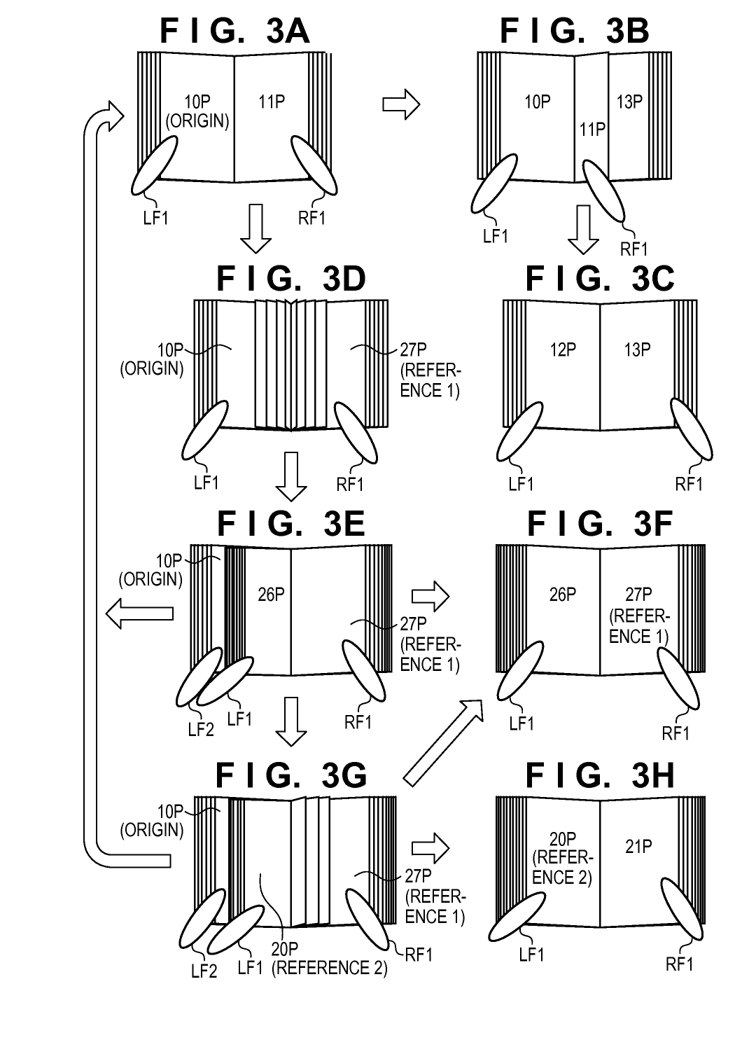

The page turning operation on a general paper book (to be referred to as a book hereinafter) will be described here with reference to FIGS. 3A to 3H. A page (origin page) the user is currently reading will be expressed as (origin), and pages (reference pages) the user has temporarily referred to while reading the origin page will be expressed as (reference 1), (reference 2), (reference 3), . . . in the order of reference hereinafter. A page of the book will be represented simply by P.

FIG. 3A illustrates a state in which the user opens 10P and 11P of the book and reads 10P (origin) while holding 10P by a left finger LF1 and 11P by a right finger RF1. When the user turns over 11P by the right finger RF1 from this state, as shown in FIG. 3B, 12P and 13P form the double-page spread, as shown in FIG. 3C. FIG. 3D shows a state in which the user thumbs through the pages from the state shown in FIG. 3A to refer to 27P (reference 1) while keeping 10P (origin) held by the left finger LF1. In the state shown in FIG. 3D, the user can read the origin page (origin) and the reference page (reference 1) in a similar manner, and can return to the origin page (FIG. 3A) or jump to the reference page (FIG. 3F). FIG. 3E illustrates a state in which the user thumbs through the pages by the left finger LF1 and searches for another reference destination while holding 10P (origin) by a left finger LF2 and also holding 27P (reference 1) by the right finger RF1. In this example, the user newly refers to 20P (reference 2), as shown in FIG. 3G. As described above, in the general paper book, the user can read the two reference pages (reference 1 and reference 2) in a similar way while securing the origin page (origin). In addition, it is possible to return to the origin page (origin) (FIG. 3A), jump to the reference page (reference 1) (FIG. 3F) or jump to another reference page (reference 2) (FIG. 3H). In page turning, the operation of returning to the origin page will be referred to as “return”, and the operation of jumping to the reference page will be referred to as “reference”.

As described above, the user can read the paper book while turning over the pages one by one, as a matter of course. The user can also refer to another page by thumbing through the pages while reading the origin page. At this time, the origin page and the reference page can replace each other. It is possible to refer to one page while reading the other page, and jump to either of the origin page and the reference page.

According to the above-described method of reading while thumbing through the other pages, the user can find the other associated pages using the information of the origin page as a key. The user can then efficiently access interesting associated information while following other associated pages one after another.

Page Data Structure and Page Display Format

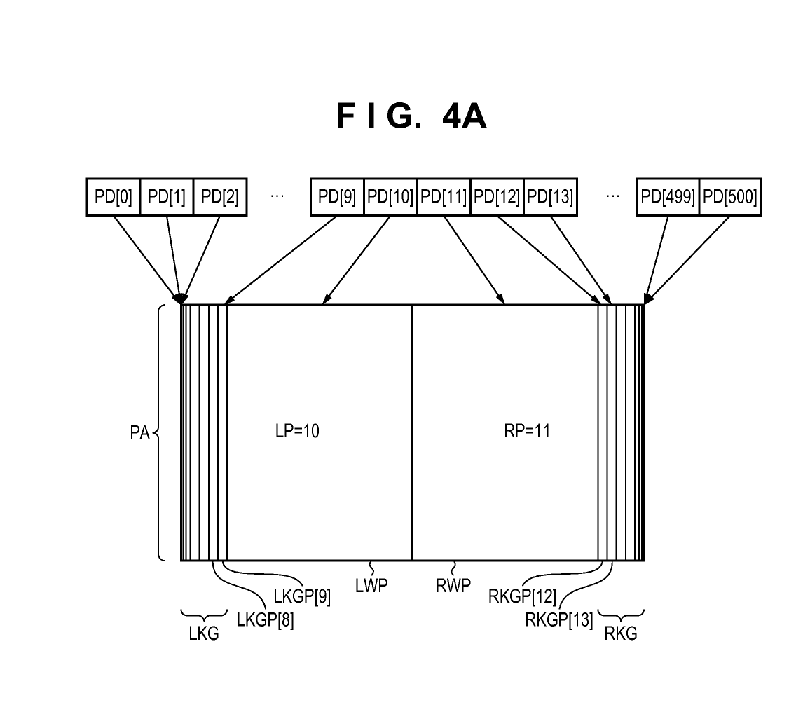

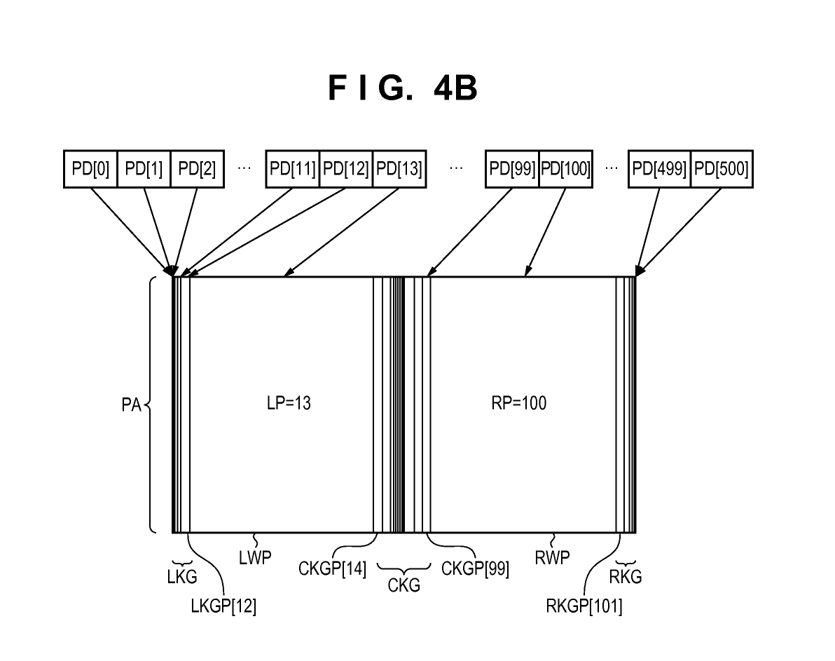

FIGS. 4A and 4B are views showing a page data structure and a page display format of the electronic book 10. Referring to FIGS. 4A and 4B, PD[i] indicates page data of the ith page which stores book contents (texts and images) loaded via a memory card or a network. PA indicates a whole page region where the entire book is displayed. The whole page region PA includes a left enlargement page LWP (first page display region) and a right enlargement page RWP (second page display region) for double-page spread display, and a fore edge region indicating the presence of pages other than the pages of the double-page spread. In the fore edge region, a plurality of fore edge page regions (to be simply referred to as fore edge pages hereinafter) corresponding to the pages in the regions are displayed. Each page data PD[i] has a set position and size n the whole page region PA and is displayed as an enlargement page or a fore edge page in the fore edge.

In this embodiment, a content of one page is displayed on each of the left enlargement page LWP and the right enlargement page RWP. The fore edge includes a left fore edge LKG (first fore edge region), a right fore edge RKG (second fore edge region), and a middle fore edge CKG (third fore edge region). The larger the number of associated pages is, the larger the display size (display width) of each fore edge is. As shown in FIGS. 4A and 4B, the left fore edge LKG displays left fore edge pages LKGP[9], LKGP[8], and the like. The middle fore edge CKG displays middle fore edge pages CKGP[14], CKGP[99], and the like. The right fore edge RKG displays right fore edge pages RKGP[12], RKGP[13], and the like.

The page data PD[i] are associated with the fore edge pages LKGP[i], CKGP[i], and RKGP[i]. In this embodiment, the page data PD[i] associated with a fore edge page such as LKGP[i] is also called a fore edge page. For example, a fore edge page associated with a left fore edge page, for example, a fore edge page PD[11] having an association LKGP[11]=PD[11] is displayed in a position and size designated by the left fore edge page LKGP[11].

The page data PD[i] are also associated with the left enlargement page LWP and the right enlargement page RWP. In this embodiment, the page data PD[i] associated with an enlargement page such as LWP is also called an enlargement page. For example, an enlargement page associated with a left enlargement page, for example, an enlargement page PD[12] having an association LWP=PD[12] is displayed in a position and size designated by the left enlargement page LWP. In this embodiment, the left enlargement page LWP and the right enlargement page RWP display the contents of the associated pages in almost the same size.

An example will be explained here in which book contents having a total of 500P are loaded. In this case, the loaded contents of 1P to 500P are stored in page data PD[1] to PD[500] on the page basis. Page data PD[0] is empty and represents the blank page at the start of the book. The data of the title or author of the book may be stored. Each page data PD[i] (i=0 to 500) is displayed as the left/right enlargement page or the left/middle/right fore edge page by changing the position and size.

FIG. 4A shows a display example of the left/right enlargement pages and the left/right fore edge pages in an operation of turning over the pages in the forward and backward directions one by one or thumbing through the pages in the forward and backward directions by single touch. In this case, page data PD[10] is displayed on the left enlargement page LWP, and page data PD[11] is displayed on the right enlargement page RWP. Note that the page number displays as the left enlargement page LWP is represented by LP, and the page number displays as the right enlargement page RWP is represented by RP. Hence, there is used an expression in which, for example, the page data PD[LP(=10)] is displayed on the left enlargement page LWP, and the page data PD[RP(=11)] is displayed on the right enlargement page RWP. Page data PD[9], PD[8], PD[7], . . . are displayed sequentially from the right side as left fore edge pages on the left side of the left enlargement page LWP. Similarly, page data PD[12], PD[13], PD[14], . . . are displayed sequentially from the left side as right fore edge pages on the right side of the right enlargement page RWP. The width of the fore edge page gradually decreases as the distance from the enlargement page increases. The left and right fore edges can display a sufficiently large number of (for example, 100) fore edge pages. In the display example shown in FIG. 4A, the contents are displayed on the enlargement pages PD[10] and PD[11]. Nothing is displayed on the fore edge pages PD[7], PD[8], PD[9], PD[12], PD[13], PD[14], and the like. That is, the contents corresponding to the fore edge pages are not displayed. Displaying to allow the user to visually recognize that the fore edges in number corresponding to the current double-page spread are exist suffices.

FIG. 4B shows a display example of the left/right enlargement pages and the left/middle/right fore edge pages in an operation of referring to another page by one finger while holding the origin page by the other finger by double touch. In the double touch state, the middle fore edge appears between the left and right enlargement pages. In this case, page data PD[LP(=13)] is displayed on the left enlargement page LWP, and page data PD[RP(=100)] is displayed on the right enlargement page RWP. Such enlargement display of discontinuous pages is the characteristic feature of the embodiment and is enabled in the double touch state. Details of the enlargement page display will be described later.

The page data PD[12], PD[11], PD[10], . . . are displayed sequentially from the right side as left fore edge pages on the left side of the left enlargement page LWP in FIG. 4B. Page data PD[101], PD[102], PD[103], . . . are displayed sequentially from the left side as right fore edge pages on the right side of the right enlargement page RWP. In addition, page data PD[14], PD[15], . . . , PD[98], and PD[99] are displayed sequentially from the left side as middle fore edge pages between the left enlargement page LWP and the right enlargement page RWP. The width of the fore edge page gradually decreases as the distance from the enlargement page increases. The left/middle/right fore edges can display a sufficiently large number of (for example, 100) fore edge pages. The contents are displayed on the enlargement pages PD[13] and PD[100]. However, nothing is displayed on the fore edge pages PD[0] to PD[12], PD[14] to PD[99], and PD[101] to PD[500], and the like.

Page Turning Processing (Overall)

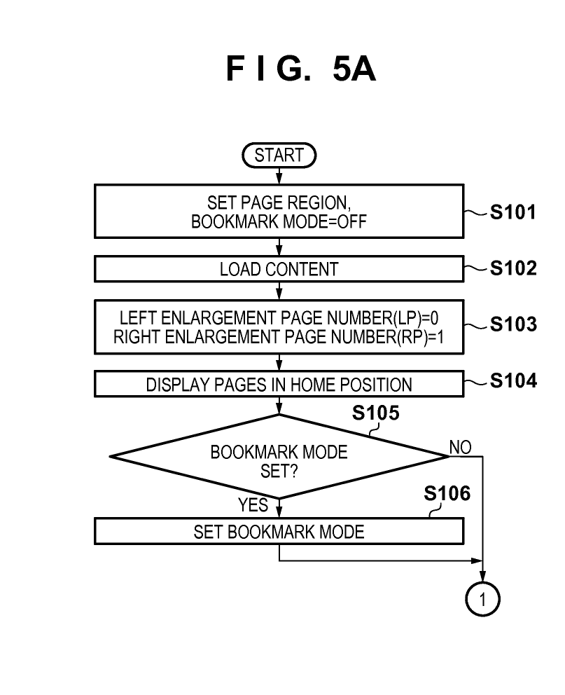

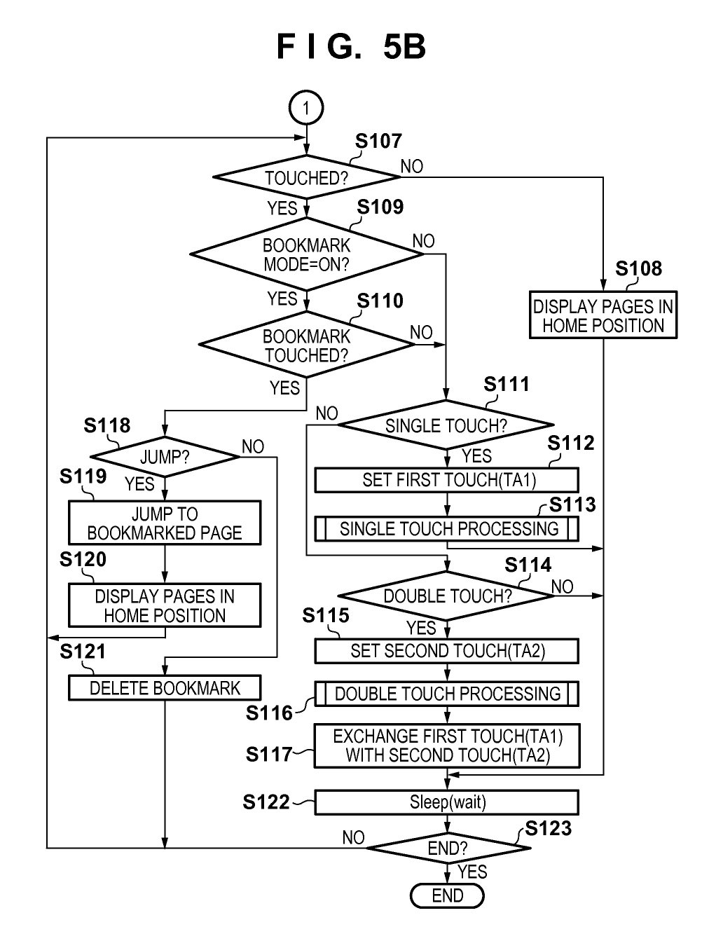

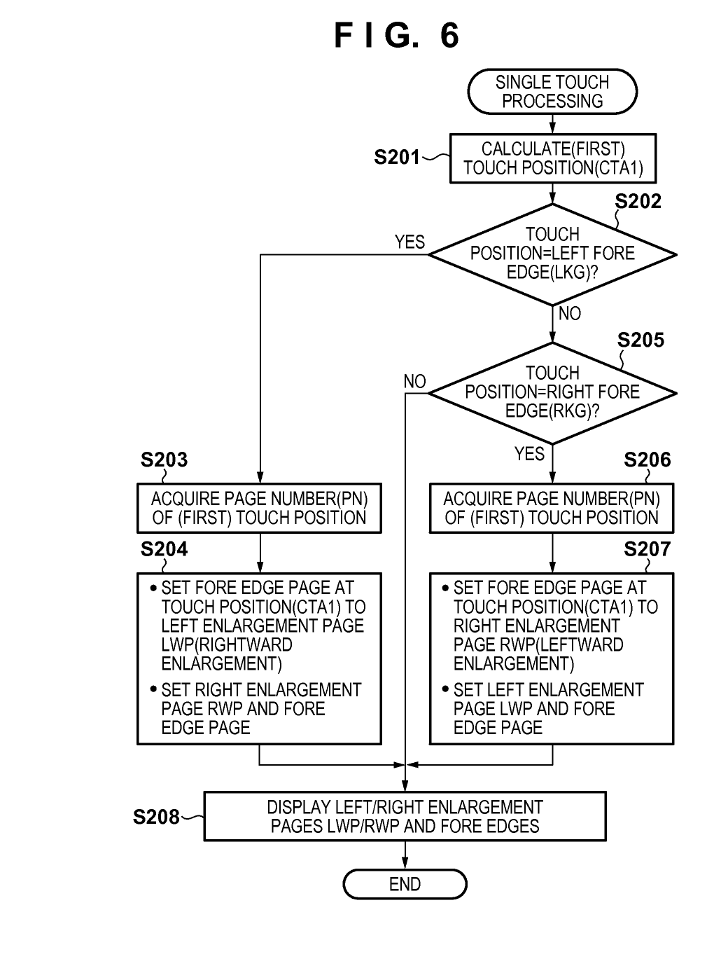

The page turning processing executed by the CPU 11 of the electronic document display apparatus 10 according to this embodiment will be described below with reference to the flowcharts of FIGS. 5A and 5B. This embodiment enables to perform operations of referring to another page (reference 1) while reading the origin page (origin), returning to the origin page (origin), jumping to the reference page (reference 1), and the like in the electronic book 10, as in the paper book described with reference to FIGS. 3A to 3H. The embodiment also enables to perform operations of referring to still another page (reference 2) while reading the reference page (reference 1) and jumping to the reference page (reference 1 or reference 2).

In step S101, the whole page region PA as shown in FIG. 4A or 4B is set in the display device 15. At this time, a bookmark mode is initialized to OFF. In step S102, book contents are loaded via a memory card or a network. The book contents are formed from texts and images and divided into pages. Assume that contents having 500P are loaded. The loaded contents of 1P to 500P are stored in page data PD[1] to PD[500], respectively. Page data PD[0] is empty and represents the blank page at the start of the book. In step S103, initialization is performed to set the left enlargement page number LP=0 and the right enlargement page number RP=1. The left enlargement page LWP=PD[LP(=0)] and the right enlargement page RWP=PD[RP(=1)] are thus set.

In step S104, the page data are displayed in the home position. The home position means a state in which the left enlargement page LWP and the right enlargement page RWP are displayed at the center of the display device 15 as the pages of a double-page spread having continuous page numbers, as shown in, for example, FIG. 4A.

In step S105, it is confirmed for the user whether to set the bookmark mode on. The bookmark mode is a processing mode to place a bookmark on a referred page. If YES in step S105, the process advances to step S106 to set the bookmark mode=ON so that a bookmark is automatically placed when the user touches the referred page for a predetermined time or more. On the other hand, if NO in step S105, the process skips step S106 and advances to step S107 to maintain bookmark mode=OFF so no bookmark is placed.

In step S107, it is determined whether the display device 15 is touched. If YES in step S107, the process advances to step S109. If NO in step S107, the process advances to step S108 to display each page data current set in the home position, and then advances to step S122.

In step S109, it is determined whether bookmark mode=ON. Upon determining that bookmark mode=ON, the process advances to step S110. Upon determining that bookmark mode=OFF, the process advances to step S111.

In step S110, it is determined whether the bookmark is touched. If YES in step S110, the process advances to step S118. If NO in step S110, the process advances to step S111.

In step S111, it is determined whether the touch on the screen is a single touch. If YES in step S111, the process advances to step S112. If NO in step S111, the process advances to step S114. Note that the single touch/double touch determination is done by the input event processing unit 16, as described above. In step S112, the touch detected in step S110 is set as a first touch TA1. In step S113, single touch processing is performed, and the process then advances to step S122. Details of the single touch processing will be described later.

In step S114, it is determined whether the touch on the screen is a double touch. If YES in step S114, the process advances to step S115. If NO in step S114, the process advances to step S122. In step S115, a touch different from the first touch TA1 set in step S112 is set as a second touch TA2. In step S116, double touch processing is performed, and the process then advances to step S117. Details of the double touch processing will be described later.

In step S117, the first touch TA1 and the second touch TA2 are exchanged, and the process advances to step S122. In this embodiment, the first touch TA1 and the second touch TA2 are always continuously exchanged in a short time. This allows to do page turning by each touch even if the two touches indicate a drag operation when the double touch processing is performed.

In step S122, the processing timing is adjusted, and the process then advances to step S123. All loop processes passing through step S122 are repetitively performed until the end of all processes is determined in step S123. In step S122, the interval of the repetitive loop is set to a predetermined very short time (for example, WAIT=100 msec). All loop processes synchronize by the WAIT time. This makes it possible to simultaneously execute a plurality of touch event processes and rendering processes in parallel.

In step S123, it is determined, based on, for example, press of an end button (not shown), whether to end the processing. Upon determining to continue the processing, the process returns to step S107.

On the other hand, in step S118, it is determined whether to jump to the bookmarked page in accordance with the degree of the touch on the bookmark in step S110. More specifically, if the upper half of the bookmark is touched, it is determined to jump to the bookmarked page. If the lower half of the bookmark is touched, it is determined to delete the bookmark. If YES in step S118, the process advances to step S119. If NO in step S118, the process advances to step S121 to delete the bookmark mode, and then returns to step S107.

After jumping to the bookmarked page in step S119, the bookmarked page is displayed in the home position as the left or right enlargement page of the double-page spread in step S120, and the process then returns to step S107. Note that in step S120, if the bookmarked page to be displayed is the left enlargement page at the time of bookmark placement, it is displayed as the left enlargement page. Similarly, if the bookmarked page is the right enlargement page at the time of bookmark placement, it is displayed as the right enlargement page.

Single Touch Processing

The single touch processing in step S113 will be described below in detail with reference to the flowchart of FIG. 6.

In step S201, a first touch position CTA1 is calculated. More specifically, when a finger contact on the display device 15 is detected as the first touch TA1, the center of gravity of the contact region is calculated as the first touch position CTA1. In step S202, it is determined whether the first touch position CTA1 is located on the left fore edge LKG. If YES in step S202, the process advances to step S203. If NO in step S202, the process advances to step S205.

In step S203, a page number PN of the fore edge page corresponding to the first touch position CTA1 is acquired. In this case, i of corresponding page data PD[i] is obtained from the first touch position CTA1 on the display device 15, and PN=i is set.

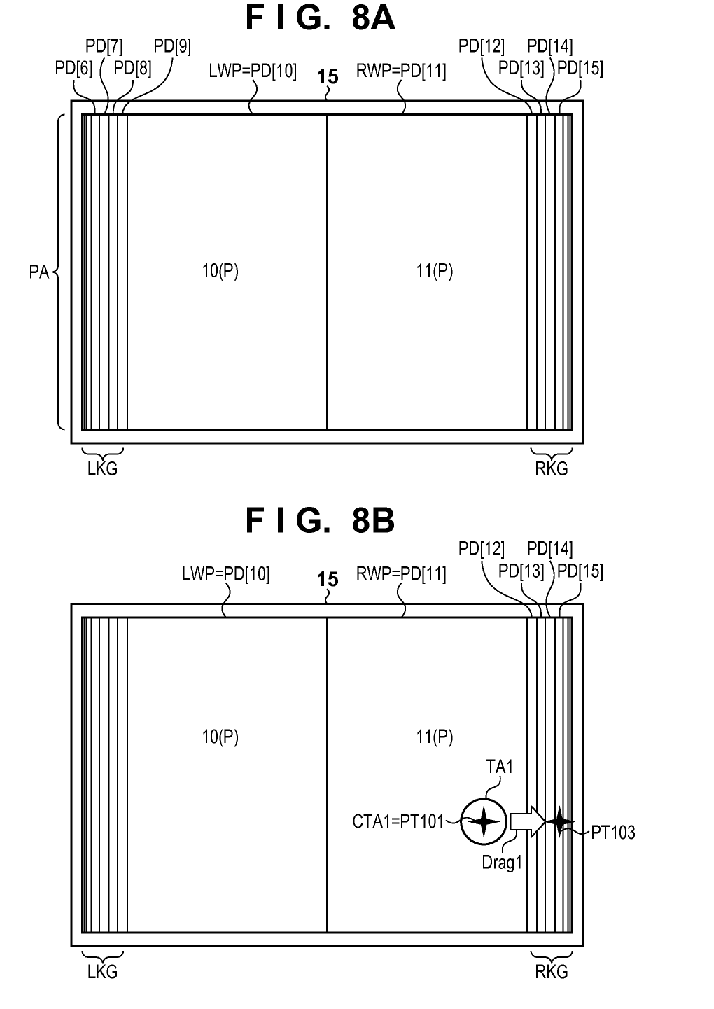

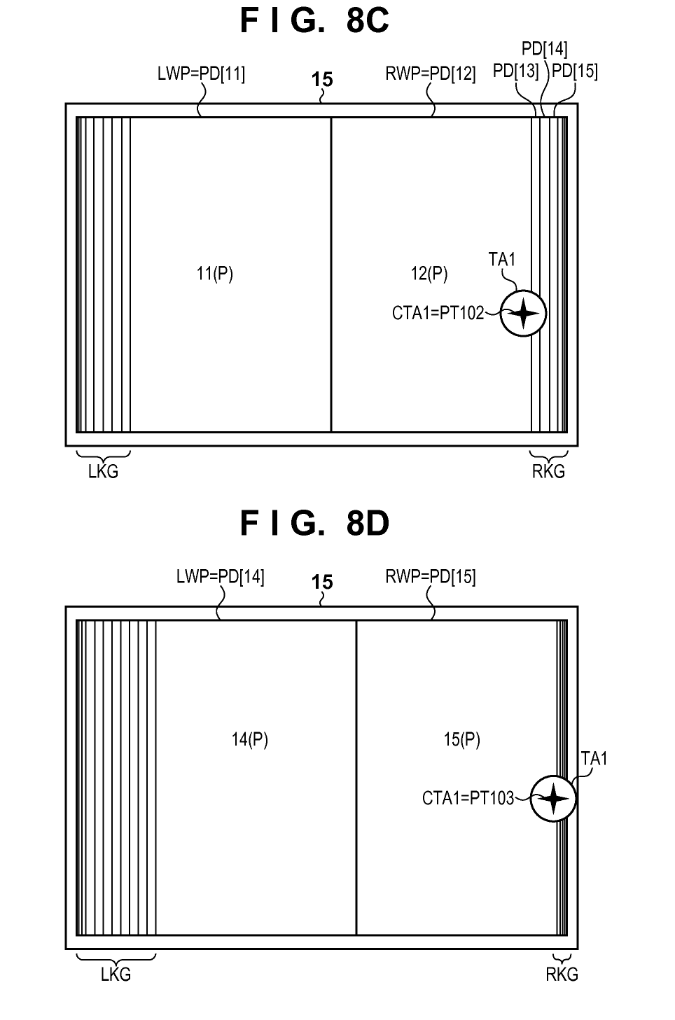

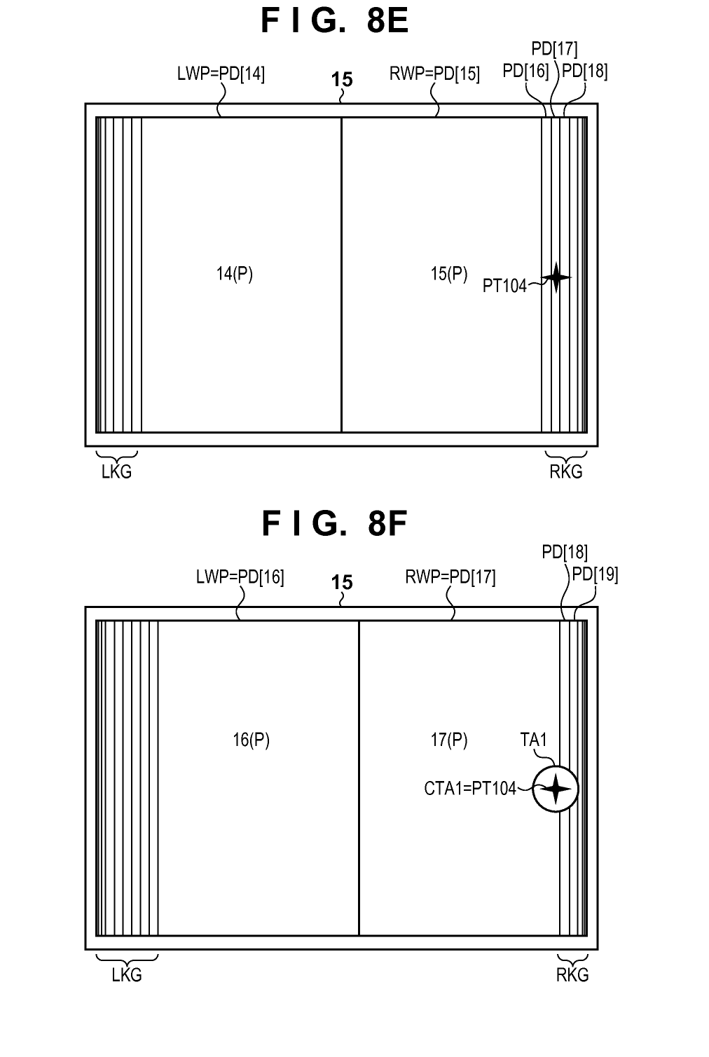

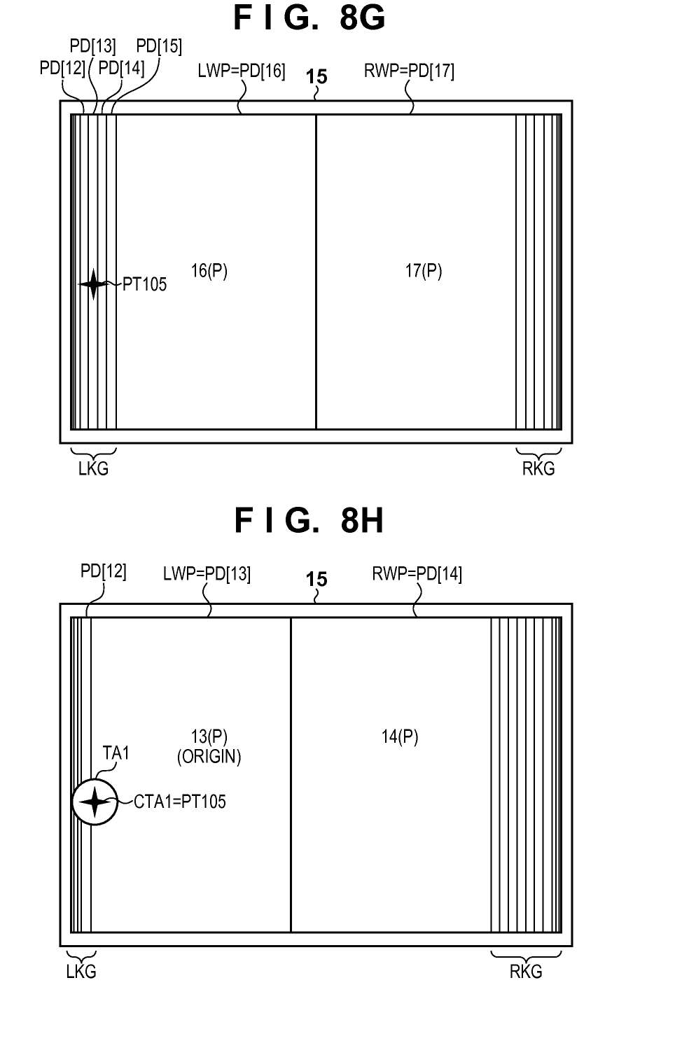

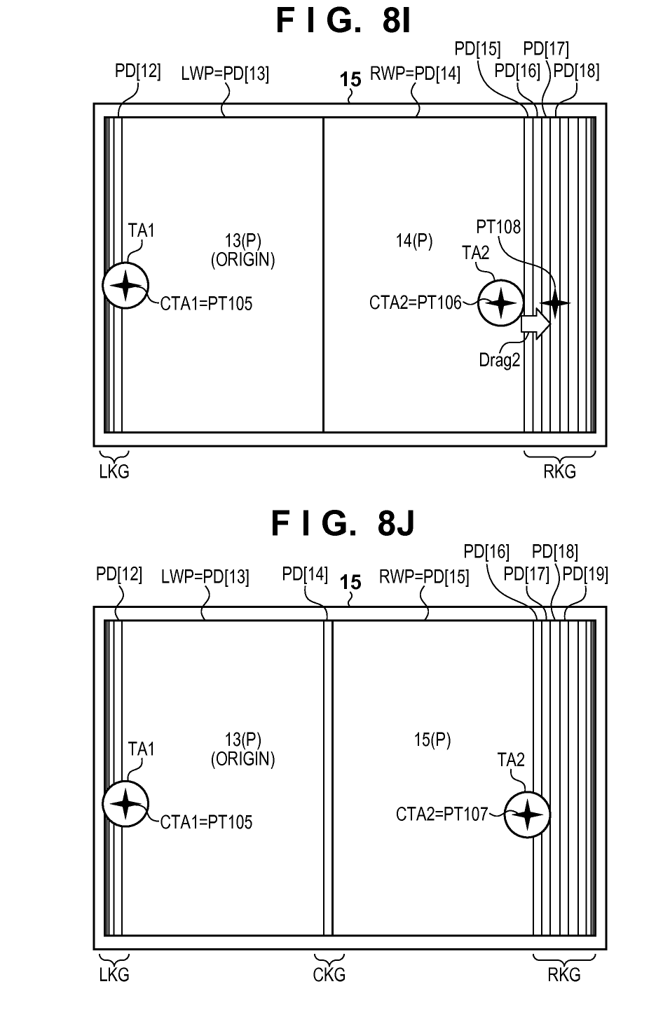

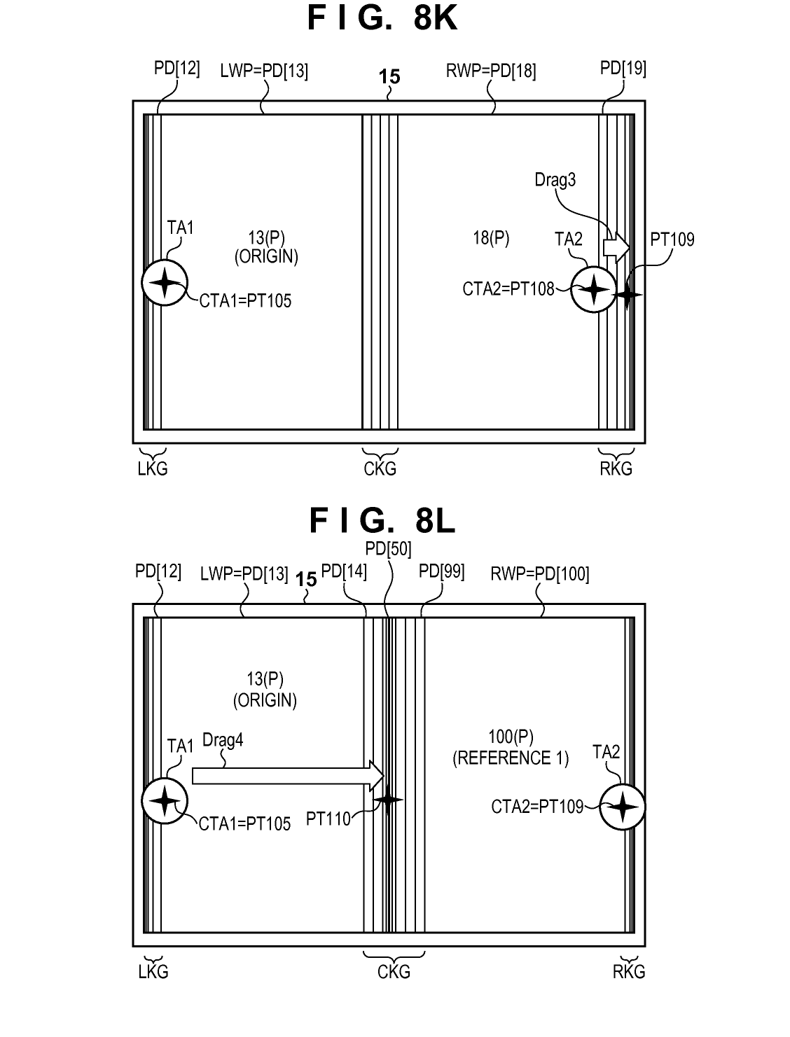

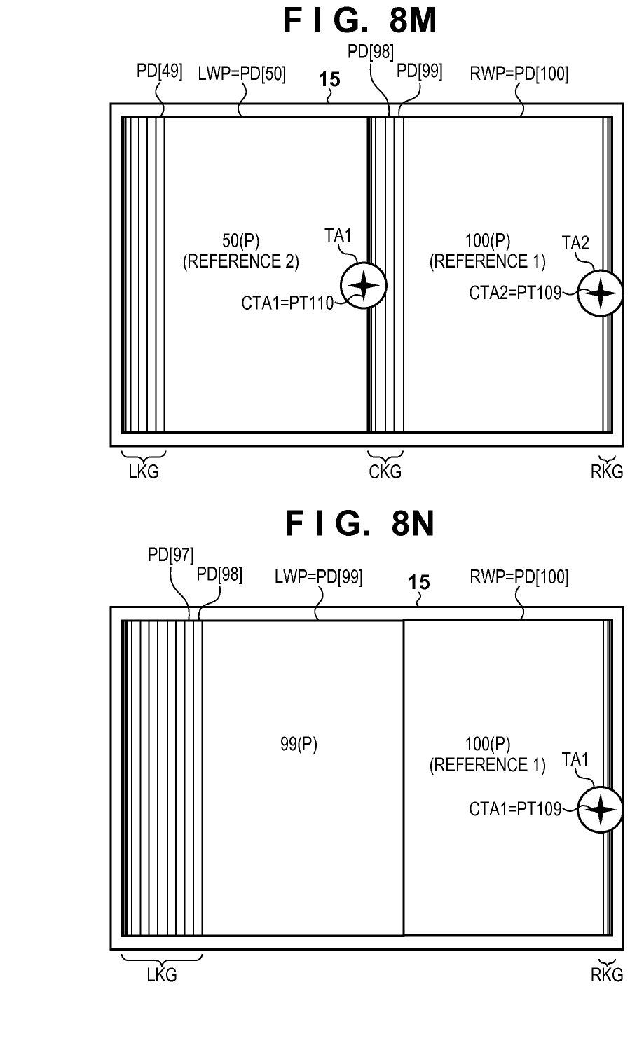

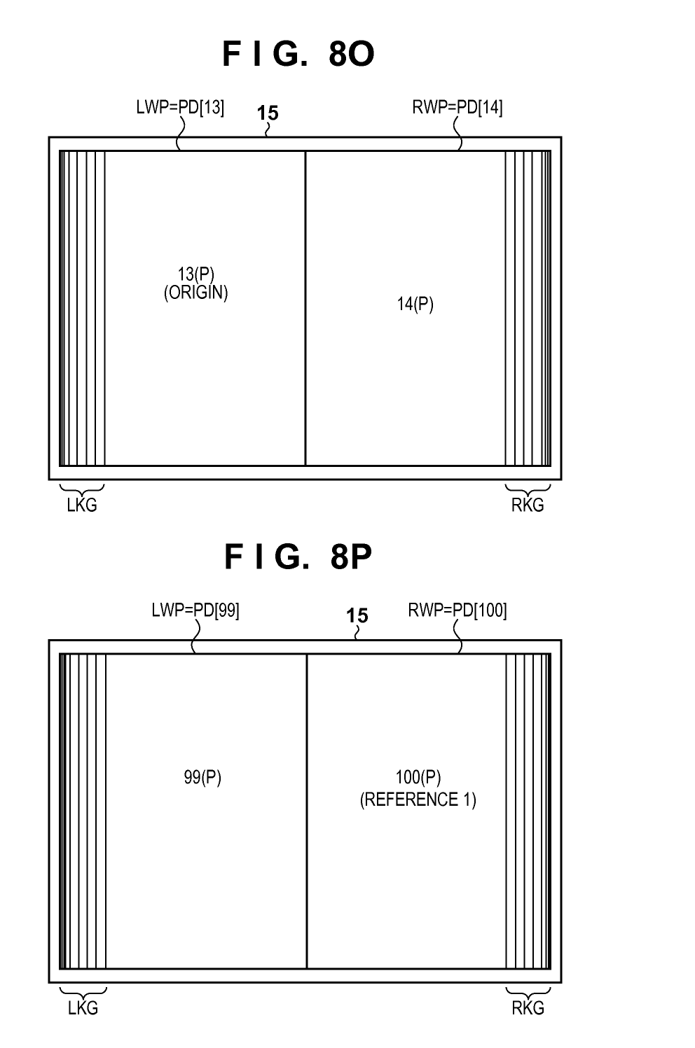

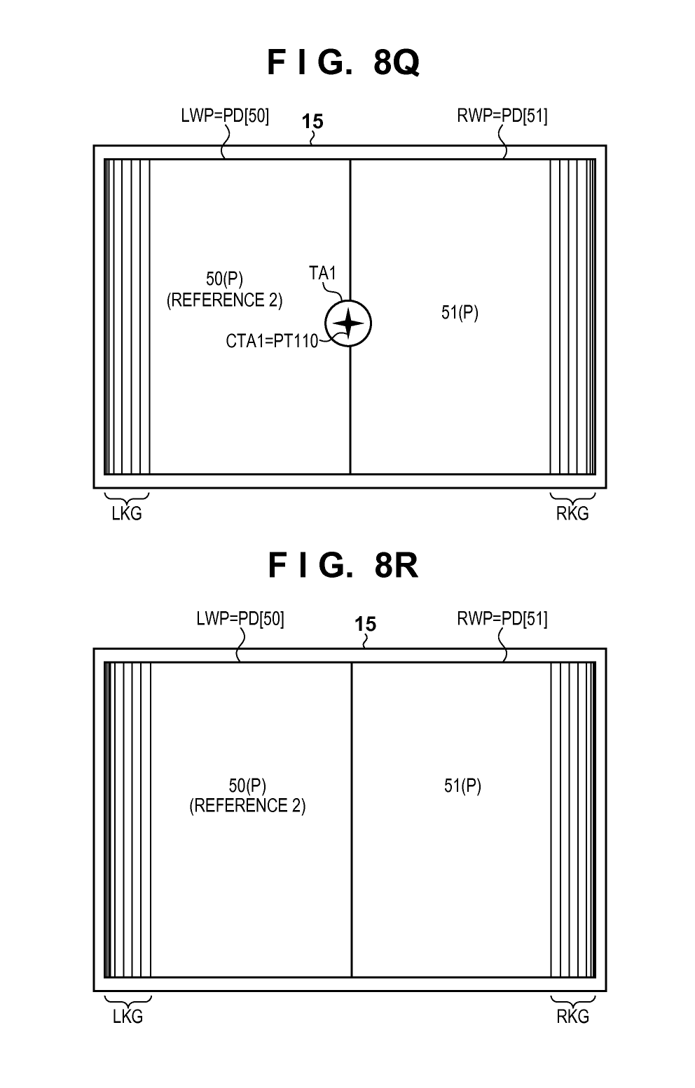

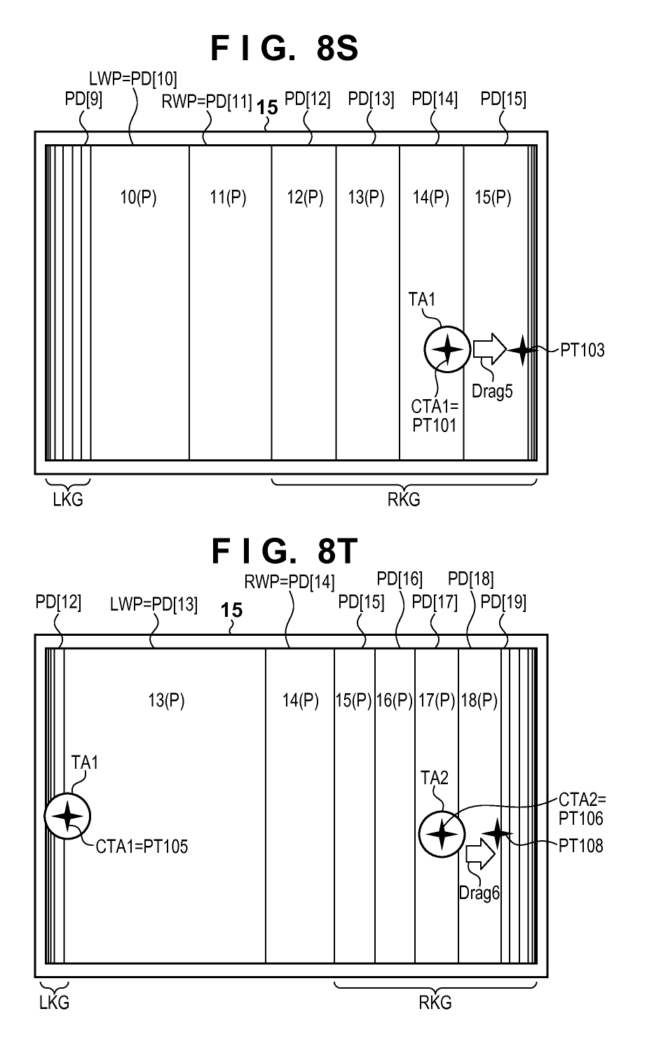

In step S204, setting (page setting) is done to display the page data PD[PN] of the fore edge page acquired in step S203 on the left enlargement page LWP. That is, the page data PD[PN] is enlarged rightward while fixing the left edge at the touched fore edge page position and set as the left enlargement page LWP. The page number PN acquired in step S203 is set to the left enlargement page number LP (LP=PN). In addition, the page data PD[PN+1] is set as the right enlargement page RWP. The page number PN+1 is set to the right enlargement page number RP (RP=PN+1). Pages before and after the left enlargement page LWP and the right enlargement page RWP are set as fore edge pages in the left fore edge LKG and the right fore edge RKG while maintaining the order of pages. With this page setting, the display transits, for example, from a screen example shown in FIG. 8G to a screen shown in FIG. 8H.

On the other hand, in step S205, it is determined whether the first touch position CTA1 is located on the right fore edge RKG. If YES in step S205, the process advances to step S206. If NO in step S205, the process advances to step S208. In step S206, the page number PN of the fore edge page corresponding to the first touch position CTA1 is acquired, as in step S203. In step S207, setting is done to display the page data PD[PN] of the fore edge page acquired in step S206 on right enlargement page RWP. That is, the page data PD[PN] is enlarged leftward while fixing the right edge at the touched fore edge page position and set as the right enlargement page RWP. The page number PN acquired in step S206 is set to the right enlargement page number RP (RP=PN). In addition, the page data PD[PN−1] is set as the left enlargement page LWP. The page number PN−1 is set to the left enlargement page number LP (LP=PN−1). Pages before and after the left enlargement page LWP and the right enlargement page RWP are set as fore edge pages in the left fore edge LKG and the right fore edge RKG while maintaining the order of pages.

In step S208, the contents and the page numbers PN of the currently set page data PD[PN] are displayed on the left/right enlargement pages LWP/RWP. On the left/right fore edges as well, the currently set fore edge pages are displayed. The single touch processing thus ends. Note that each enlargement page may be displayed together with, for example, a frame to improve the visibility.

Double Touch Processing

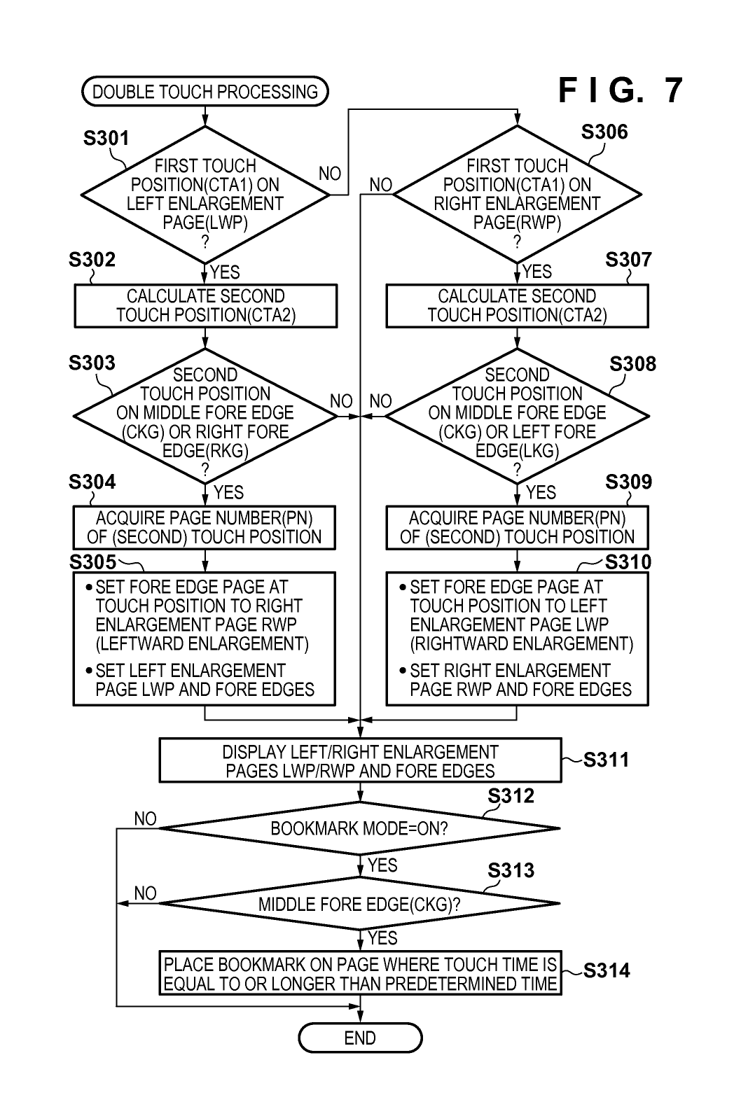

The double touch processing in step S116 will be described below in detail with reference to the flowchart of FIG. 7. Note that transition to the double touch state according to this embodiment always occurs via the single touch state, as described above. Hence, the double touch processing in step S116 is also executed after the single touch processing in step S113 of the previous loop processing. That is, when executing the double touch processing, the first touch position CTA1 has already been calculated, and the display of the left/right enlargement pages and the left/right fore edges has already been done in accordance with the first touch position CTA1.

In the double touch processing, first, in step S301, it is determined whether the already calculated first touch position CTA1 is located on the left enlargement page LWP. If YES in step S301, the process advances to step S302. If NO in step S301, the process advances to step S306.

In step S302, a second touch position CTA2 is calculated. More specifically, for the second touch TA2 that is a contact region different from the first touch TA1 on the display device 15, its center of gravity is detected as the second touch position CTA2. In step S303, it is determined whether the second touch position CTA2 is located on the middle fore edge CKG or the right fore edge RKG. If YES in step S303, the process advances to step S304. On the other hand, if NO in step S303, that is, the second touch position CTA2 is neither in the middle fore edge CKG nor in the right fore edge RKG, the process advances to step S311.

In step S304, the page number PN of the fore edge page in which the second touch position CTA2 is located is acquired. In this case, i of page data PD[i] of the fore edge page immediately under the second touch position CTA2 is obtained, and page number PN=i is set.

In step S305, setting is done to display the page data PD[PN] of the fore edge page acquired in step S302 on the right enlargement page RWP. That is, the page data PD[PN] is enlarged leftward while fixing the right edge at the touched fore edge page position and set as the right enlargement page RWP. The page number PN acquired in step S304 is set to the right enlargement page number RP (RP=PN). Pages before and after the left enlargement page LWP and the right enlargement page RWP are set as fore edge pages in the left fore edge LKG, the middle fore edge CKG, and the right fore edge RKG while maintaining the order of pages. After that, the process advances to step S311.

On the other hand, in step S306, it is determined whether the first touch position CTA1 is located on the right enlargement page RWP. If YES in step S306, the process advances to step S307. If NO in step S306, the process advances to step S311.

In step S307, the second touch position CTA2 is calculated, as in step S302. In step S308, it is determined whether the second touch position CTA2 is located on the middle fore edge CKG or the left fore edge LKG. If YES in step S308, the process advances to step S309. On the other hand, if NO in step S308, that is, the second touch position CTA2 is neither in the middle fore edge CKG nor in the left fore edge LKG, the process advances to step S311.

In step S309, the page number PN of the fore edge page in which the second touch position CTA2 is located is acquired, as in step S304.

In step S310, setting is done to display the page data PD[PN] of the fore edge page acquired in step S309 on the left enlargement page LWP. That is, the page data PD[PN] is enlarged rightward while fixing the left edge at the touched fore edge page position and set as the left enlargement page LWP. The page number PN acquired in step S309 is set to the left enlargement page number LP (LP=PN). Pages before and after the left enlargement page LWP and the right enlargement page RWP are set as fore edge pages in the left fore edge LKG, the middle fore edge CKG, and the right fore edge RKG while maintaining the order of pages. After that, the process advances to step S311.

In step S311, the contents and the page numbers PN of the currently set page data PD[PN] are displayed on the left/right enlargement pages LWP/RWP. On the left/middle/right fore edges as well, the currently set fore edge pages are displayed. Note that each enlargement page may be displayed together with, for example, a frame to improve the visibility.

In step S312, it is determined whether bookmark mode=ON. If YES in step S312, the process advances to step S313 to perform bookmark placement processing. If NO in step S312, the double touch processing ends. In step S313, it is determined whether the middle fore edge exists. If YES in step S313, the process advances to step S314 to perform bookmark placement processing. If NO in step S313, the double touch processing ends. As described above, in this embodiment, only when the middle fore edge has appeared, it is determined that the user is performing reference while thumbing through the other pages by a double touch, that is, the mode is the reference mode, and control is performed to place a bookmark. This allows to prevent a bookmark mode from being placed on the double-page spread during normal browsing. In step S314, a bookmark is placed on a page where the touch time is equal to or longer than a predetermined time (for example, 10 sec), and the double touch processing ends.

Page Turning Operation

The user's page turning operation of the electronic book 10 and the response of the apparatus according to this embodiment will be described below in detail with reference to the display screen transition shown in FIGS. 8A to 8T. Note that in FIGS. 8A to 8T, FIGS. 8A and 8B show a transition relationship pair. FIGS. 8C and 8D show a transition pair, . . . , FIGS. 8S and 8T show a transition pair. Assume that bookmark mode=OFF is set in steps S105 and S106 of FIGS. 5A and 5B. Corresponding step numbers in FIGS. 5A to 7 will be mentioned for the operations to be described below.

The screen shown in FIG. 8A indicates that several pages are turned over, and 10P and 11P are displayed as the left/right enlargement pages of the double-page spread in the home position (S108). At this time, the user is not touching the screen by a finger, that is, the release state is set. FIG. 8B shows a state in which the user has done a single touch on the screen in this state. The initial center of gravity of the single touch TA1 is CTA1=PT101. The user drags on the shortest path to move the center CTA1 of gravity from PT101 on the right enlargement page to a position PT103 on a right fore edge page PD[15] (Drag1).

The procedure of processing during the Drag1 operation includes YES in step S107, NO in step S109, YES in step S111, and NO in step S123 of FIGS. 5A and 5B. The procedure loops through S107-S109-S111-S112-S113-S122-S123-S107. At this time, in the single touch processing (S113), it is determined that the first touch position CTA1 is located on the right fore edge RKG (S201-S202-S205). Along with the movement of the touch position, the page numbers PN=12, 13, 14, and 15 of the fore edge pages PD[12], PD[13], PD[14], and PD[15] are acquired (S206). The fore edge pages PD(PN) [PN=12, 13, 14, 15] under the touch position CTA1 are sequentially set to the right enlargement page RWP as the touch position CTA1 moves (S207). Hence, in the Drag1 operation, the page display transits as shown in FIGS. 8B, 8C, and 8D.

When the user moves the finger off the screen in the screen state shown in FIG. 8D, 14P and 15P are displayed as the left/right enlargement pages of the double-page spread in the home position, as shown in the screen of FIG. 8E (release state, S108). Consider a case in which the user touches a position PT104 on a right fore edge page PD[17] in the screen state shown in FIG. 8E (S201-S202-S205-S206). In this case, PD[17] is displayed as the right enlargement page RWP, as shown in the screen of FIG. 8F (S207-S208). When the user moves the finger off in this state, 16P and 17P are displayed as the left/right enlargement pages of the double-page spread in the home position, as shown in the screen of FIG. 8G (release state, S107-S108). When the user touches a position PT105 on a left fore edge page PD[13] in the screen state shown in FIG. 8G (S201-S202-S203), PD[13] is displayed as the left enlargement page LWP, as shown in the screen of FIG. 8H (S204-S208). The subsequent screen transition will be explained below assuming that 13P displayed as the left enlargement page LWP is the origin page.

An example will be described next, in which a double touch is done on the screen. Consider a state (double touch state) in which the user gives the second touch TA2 to a position PT106 on the right enlargement page while giving the first touch TA1 to the position PT105 on the left enlargement page LWP, as shown in the screen of FIG. 8I. The user then drags on the shortest path to move the second touch TA2 from the position PT106 to a position PT108 on a right fore edge page PD[18] (Drag2).

The procedure of processing during the Drag2 operation includes YES in step S107, NO in step S109, NO in step S111, YES in step S114, and NO in step S123 of FIGS. 5A and 5B. That is, the procedure loops through S107-S109-S111-S114-S115-S116-S117-S122-S123-S107. At this time, in the double touch processing (S116), it is determined that the first touch position CTA1 is located on the left enlargement page LWP, and the second touch position CTA2 is located on the right fore edge RKG (S301-S302-S303). Along with the movement of the second touch position CTA2, the page numbers PN=15, 16, 17, and 18 of the fore edge pages PD[15], PD[16], PD[17], and PD[18] are acquired (S304). The fore edge pages PD(PN) [PN=15, 16, 17, 18] under the second touch position CTA2 are sequentially set to the right enlargement page RWP as the second touch position CTA2 moves (S305). Hence, in the Drag2 operation, 14P, 15P, and 18P are sequentially displayed as the right enlargement page RWP while keeping the left enlargement page LWP=13P (origin) fixed, as in the screens of FIGS. 8I, 8J, and 8K.

Consider a case in which the user drags the second touch position CTA2 from the position PT108 to a position PT109 while keeping the first touch position CTA1 fixed at the position PT105 by a double touch (Drag3) as shown in the screen of FIG. 8K. In this case, 100P (reference 1) is displayed as a reference page, as shown in the screen of FIG. 8L. Then, the user drags the first touch position CTA1 from the position PT105 on the left enlargement page to a position PT110 on the middle fore edge while keeping the second touch position CTA2 fixed at the position PT109 on the screen shown in FIG. 8L (Drag4). In this embodiment, the first touch TA1 and the second touch TA2 are exchanged at a predetermined time interval and processed (S117). Hence, in the double touch processing (S116) as well, the left enlargement page LWP=50P (reference 2) is displayed while keeping the right enlargement page RWP=100P (reference 1) fixed, as shown in the screen of FIG. 8M.

Consider a case in which the user moves the finger holding 50P (reference 2) off from the double touch state shown in the screen of FIG. 8M. In this case, after S107-S109-S111, in step S112, the position PT109 on the screen shown in FIG. 8M is set as the first touch position CTA1. In the single touch processing (S113), after S201-S202, step S205 results in NO. With this processing, 99P adjacent to the right enlargement page RWP=100P is displayed as the left enlargement page LWP (single touch state) in step S208, as shown in the screen of FIG. 8N.

When the user moves the finger holding 100P (reference 1) off from the single touch state shown in the screen of FIG. 8N, 99P and 100P are displayed as the left/right enlargement pages of the double-page spread in the home position (release state), as shown in the screen of FIG. 8P.

On the other hand, consider a case in which the user moves the finger holding 100P (reference 1) off from the double touch state shown in the screen of FIG. 8M. In this case, 51P adjacent to the left enlargement page LWP=50P is displayed as the right enlargement page RWP (single touch state), as shown in the screen of FIG. 8Q. In addition, when the user moves the finger holding the page off from the screen state shown in FIG. 8Q, 50P and 51P are displayed as the left/right enlargement pages of the double-page spread in the home position (release state), as shown in the screen of FIG. 8R.

In a similar manner, when the user cancels the right-side touch TA2 from the double touch state shown in FIGS. 8I, 8J, 8K, and 8L, the screen shown in FIG. 8H is displayed (single touch state). When the user moves the finger off from the screen state shown in FIG. 8H, the screen shown in FIG. 8O is displayed (release state).

Note that the fore edge pages at the drag position may be thumbed through. To do this, each fore edge page is preferably displayed while gradually increasing its width during the touch. For example, when the user drags from the position CTA1=PT101 in the screen shown in FIG. 8B to CTA1=PT103 in the screen shown in FIG. 8D in the single touch state, the pages are displayed as if the user were thumbing through them, as shown in the screen of FIG. 8S. In this case, as the touch position CTA1 moves, like Drag5 in the screen of FIG. 8S, the fore edge pages at the position CTA1 are sequentially enlarged and displayed. In the double touch state as well, when the user drags from the position CTA2=PT106 in the screen shown in FIG. 8I to CTA2=PT108 in the screen shown in FIG. 8K, the pages are displayed as if the user were thumbing through them, as shown in the screen of FIG. 8T. In this case, as the touch position CTA2 moves, like Drag6 in the screen of FIG. 8T, the fore edge pages at the position CTA2 are sequentially enlarged and displayed. Note that when the user touches a desired one of the pages that are being thumbed through, jump to the touched page may take place. In addition, the speed of turning over the fore edge pages (turning unit) may be changed in accordance with the speed or pressure of drag.

Effects Obtained by First Embodiment

As described above, according to this embodiment, the following effects can be obtained. As shown in FIGS. 8I, 8J, 8K, and 8L, the user can refer to an arbitrary subsequent page (in this case, 14P, 15P, 18P, . . . , reference 1=100P, or the like) while reading an arbitrary origin page (origin=13P). At this time, the page of the reference destination can be displayed in the same size as the origin page. Hence, the page can be read in the same way as the origin page, that is, the pages can be read in comparison. In addition, as shown in the screens of FIGS. 8L and 8M, setting a page (reference 1=100P) referred to once as a new origin page, the user can refer to an arbitrary preceding page (for example, reference 2=50P).

As described above, according to the electronic book 10 of this embodiment, it is possible to not only read while turning over the pages one by one but also refer to another page by thumbing through the pages while reading the origin page. At this time, the origin page and the reference page can replace each other. It is possible to refer to one page while reading the other page, and jump or return to either of the origin page and the reference page. More specifically, it is possible to select whether to return to the origin page or jump to the reference page while simultaneously reading the origin page and the reference page and comparing the contents. That is, since page settings corresponding to a plurality of touch operations are done in a plurality of page display regions, a flexible page display operation can easily be performed.

As described above, operability as in a paper book can be implemented, and reading can be done while referring another page that does not continue from the origin page. For these reasons, the user can find the other associated pages using the information of the origin page as a key. The user can then efficiently access interesting associated information while following other associated pages one after another.

### Second Embodiment

The second embodiment of the present invention will be described below.

As described above with reference to FIGS. 3A to 3H, in a paper book, the operations of referring to another page (reference 1) while reading the origin page (origin), returning to the origin page (origin), jumping to the reference page (reference 1), and the like are possible. In addition, operations of referring to still another page (reference 2) while reading the reference page (reference 1) and jumping to the reference page (reference 1 or reference 2) are possible. In the paper book, referring from the origin page (origin) to the reference page (reference 1) or reading discontinuous pages from (reference 1) to (reference 2), from (reference 2) to (reference 3), from (reference 3) to (reference 4), . . . is possible.

The second embodiment allows to jump to the discontinuous pages when performing the reference by turning over the pages in the order of (origin), (reference 1), (reference 2), (reference 3), (reference 4), . . . . To do this, in the second embodiment, when a double touch state is set, it is determined that a reference mode is set, that is, the user is referring to the other pages while thumbing through them. As a characteristic feature, a bookmark is automatically placed on a page where the touch has been continued beyond a predetermined time in the double touch state. The bookmarks are automatically assigned the reference orders of the referred pages, like (origin), (reference 1), (reference 2), (reference 3), (reference 4), . . . . When the user touches a bookmark, the display can jump to the corresponding page. The user can delete the bookmark placed once, as a matter of course.

An electronic document display apparatus according to the second embodiment has the same arrangement as that of the above-described first embodiment, and a description thereof will be omitted.

Page Turning Operation

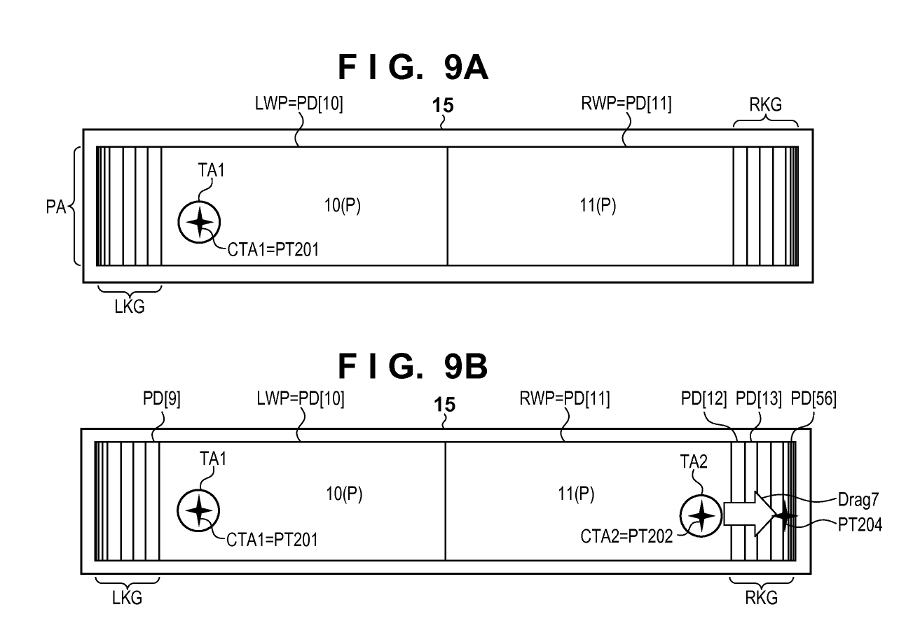

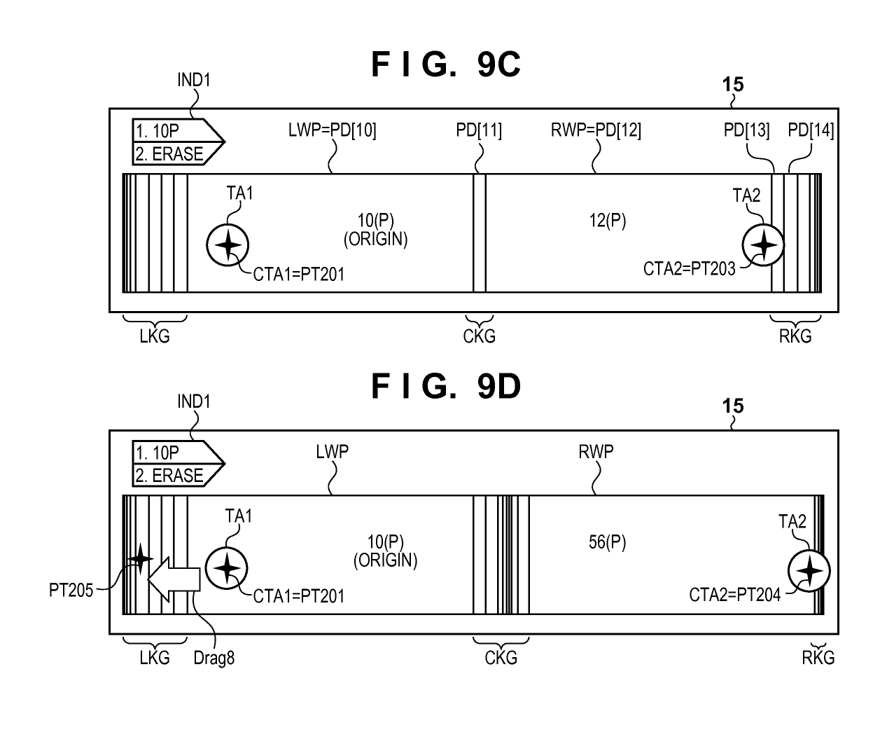

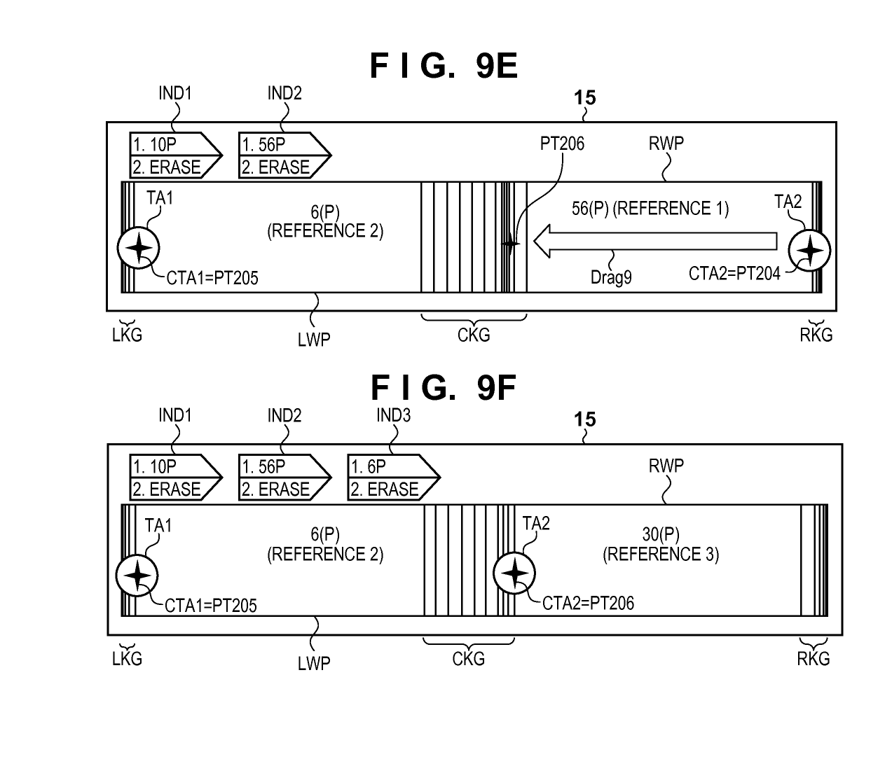

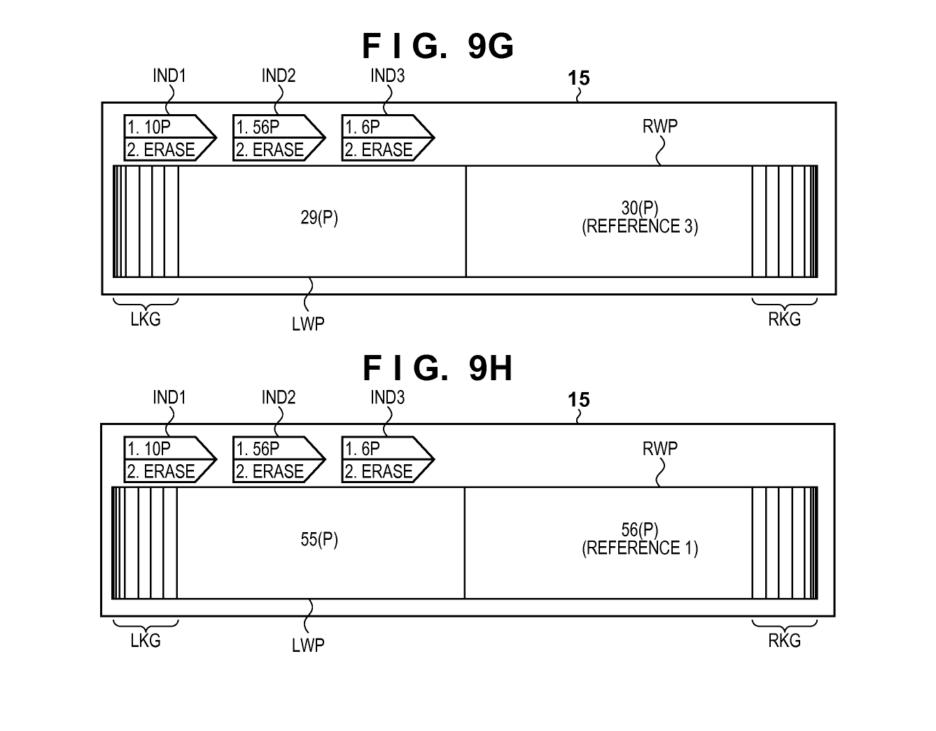

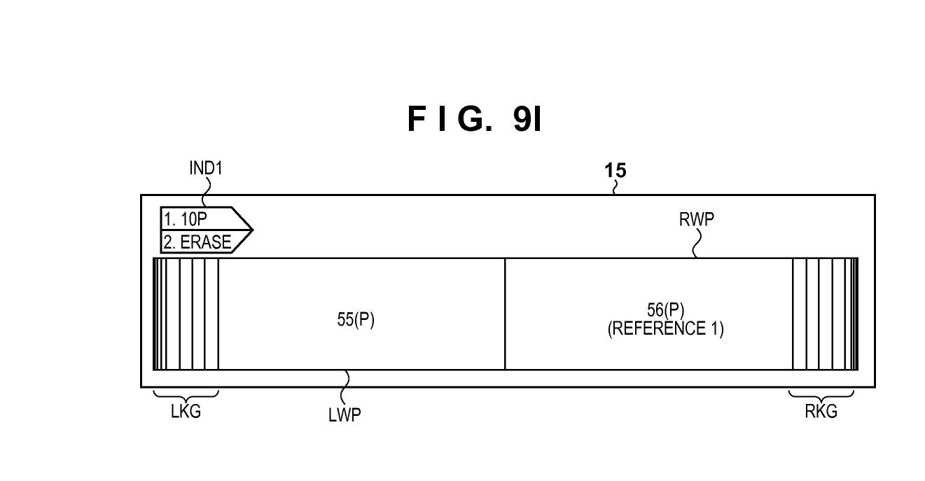

As for the user's page turning operation of an electronic book and the response of the apparatus according to the second embodiment, details of the transition will be described below with reference to the display screens shown in FIGS. 9A to 9I. Note that FIGS. 9A to 9I show the screens shorter in the vertical direction of the pages as compared to the screen shown in, for example, FIG. 8A and the like. This is because the page contents have no technical significance. In actual display, the page contents are displayed at the same aspect ratio as that of the screen shown in FIG. 8A. Note that FIGS. 9A to 9I merely illustrate the relationship of the pages.

The procedures of overall page turning processing and details thereof, that is, single touch processing and double touch processing according to the second embodiment are the same as those of the flowcharts shown in FIGS. 5A to 7 of the above-described first embodiment. Hence, in the second embodiment as well, corresponding step numbers in FIGS. 5A to 7 will be mentioned for the operations to be described below. Note that in the second embodiment, assume that bookmark mode=ON is set in step S106 of FIGS. 5A and 5B.

The screen shown in FIG. 9A indicates a state in which several pages are turned over, and 10P and 11P are displayed as the left/right enlargement pages. At this time, a the user is not touching the screen by a single touch TA1 is done at a first touch position CTA1=PT201 on a left enlargement page LWP (YES in step S111, S112-S113). In this case, 10P and 11P are directly displayed as the left/right enlargement pages (S208).

The user gives a second touch TA2 to a position PT202 while keeping the first touch TA1 at the position PT201 (double touch state), as shown in the screen of FIG. 9B. The user drags on the shortest path to move a center CTA2 of gravity of the second touch TA2 from the position PT202 on a right enlargement page RWP to a position PT204 on the right fore edge (Drag7). For example, assume that the user drags from 11P to 56P by a right finger while holding 10P by a left finger. The procedure of processing during the Drag7 operation includes YES in step S107, YES in step S109, NO in step S110, NO in step S111, YES in step S114, and NO in step S123 of FIGS. 5A and 5B. That is, the procedure loops through S107-S109-S110-S111-S114-S115-S116-S117-S122-S123-S107. At this time, in the double touch processing (S116), it is determined that the first touch position CTA1 is located on the left enlargement page LWP, and the second touch position CTA2 is located on a right fore edge RKG (S301-S302-S303). Along with the movement of the second touch position CTA2, page numbers PN=12, 13, . . . , 56 of fore edge pages PD[12], PD[13], . . . , PD[56] are acquired (S304). The fore edge pages PD(PN) [PN=12, 13, . . . , 56] under the second touch position CTA2 are sequentially set to the right enlargement page RWP as the second touch position CTA2 moves (S305). Hence, in the Drag7 operation, 12P, 13P, . . . , 56P are sequentially displayed as the right enlargement page RWP while keeping the left enlargement page LWP=10P (origin) fixed, as in the screens of FIGS. 9C and 9D.

During the Drag7 operation, step S312 results in YES. When a middle fore edge CKG appears as shown in the screen of FIG. 9C, step S313 results in YES. In step S314, a bookmark is placed on a page where the touch time is equal to or longer than a predetermined time (for example, 10 sec) in the double touch state. For example, a bookmark IND1 is placed on 10P when the touch time on 10P (origin) has exceeded 10 sec, as shown in the screen of FIG. 9C. The bookmark IND1 can have an arbitrary shape. In this case, the page number and “erase” to be selected to erase the bookmark are displayed in the bookmark.

The user then drags the first touch TA1 from the position PT201 to a position PT205 while keeping the second touch TA2 given to the position PT204, as shown in the screen of FIG. 9D (Drag8). For example, assume that the user drags from 10P to 6P by the left finger while holding 56P by the right finger. At this time, in the second embodiment as well, the first touch TA1 and the second touch TA2 are exchanged at a predetermined time interval and processed (S117). Hence, in the double touch processing (S116), regarding the touch on the left fore edge as the second touch TA2, the left enlargement page LWP=6P (reference 2) is displayed while keeping the right enlargement page RWP=56P (reference 1) fixed, as shown in the screen of FIG. 9E. In the double touch state during the Drag8 operation, a bookmark is placed on a page where the touch time has exceeded a predetermined time (for example, 10 sec). For example, a bookmark IND2 is placed on 56P when the touch time on 56P (reference 1) has exceeded 10 sec, as shown in the screen of FIG. 9E.

The user then drags the second touch TA2 from the position PT204 to a position PT206 while keeping the first touch TA1 given to the position PT205, as shown in the screen of FIG. 9E (Drag9). For example, assume that the user drags from 56P to 30P by the right finger while holding 6P by the left finger. In the double touch state during the Drag9 operation, a bookmark is placed on a page where the touch time has exceeded a predetermined time (for example, 10 sec). For example, a bookmark IND3 is placed on 6P when the touch time on 6P (reference 2) has exceeded 10 sec, as in the image of FIG. 9F.

The user cancels the first touch TA1 from the screen state shown in FIG. 9F and then cancels the second touch TA2. Then, 29P and 30P are displayed as the left/right enlargement pages of the double-page spread in the home position (release state), as shown in the screen of FIG. 9G. In this state, the user touches the upper half position of the bookmark IND2 displayed on the screen of FIG. 9G. The jump destination page is displayed at the upper half position of the bookmark. When the user touches this position, jump to the display page takes place. The procedure of processing at this time includes YES in step S107, YES in step S109, YES in step S110, and YES in step S118. In step S119, the page indicated by the bookmark is called. In step S120, the called page (56P in this case) is displayed as an enlargement page of the double-page spread in the home position (screen of FIG. 9H).

When the user touches the lower half position of each of the bookmarks IND2 and IND3 in the screen state shown in FIG. 9H, the bookmarks are deleted. The procedure of processing at this time includes YES in step S107, YES in step S109, YES in step S110, and NO in step S118. In step S121, the bookmarks (IND2 and IND3 in this case) are deleted (screen of FIG. 9I).

Effects Obtained by Second Embodiment

As described above, according to the second embodiment, a page on which the touch continuation time has exceeded a predetermined time in the double touch state is determined as a reference page referred to by the user. A bookmark according to the reference order is automatically placed on the page determined to be the reference page. It is therefore possible to return to a reference source far apart or jump to a reference destination far apart even when the reference layer becomes large. This enables to efficiently access interesting information while following the associated information of the reference source and the reference destination by thumbing through the pages.

### Third Embodiment

The third embodiment of the present invention will be described below.

The third embodiment enables to turn over pages by twos to display a unit (0P, 1P), (2P, 3P), and (4P, 5P) as a double-page spread in a single touch state, like a normal paper book. In a double touch state, the pages are turned over one by one by each touch. To smoothly connect the page turning by twos and the page turning one by one, three different display modes (first fore edge mode, second fore edge mode, and third fore edge mode) are prepared.

Note that an electronic document display apparatus according to the third embodiment has the same arrangement as that of the above-described first embodiment, and a description thereof will be omitted.

Page Data Structure and Page Display Format

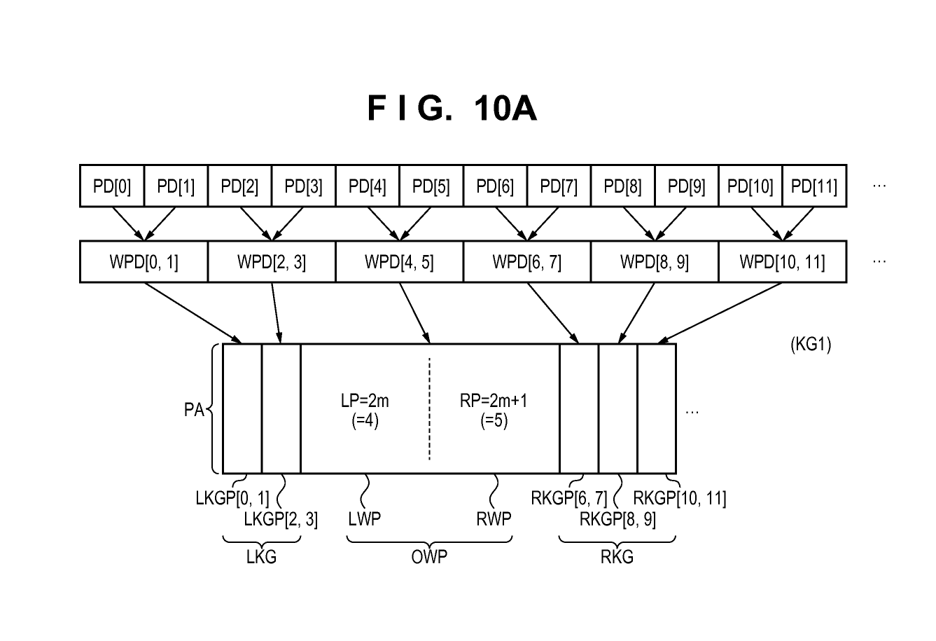

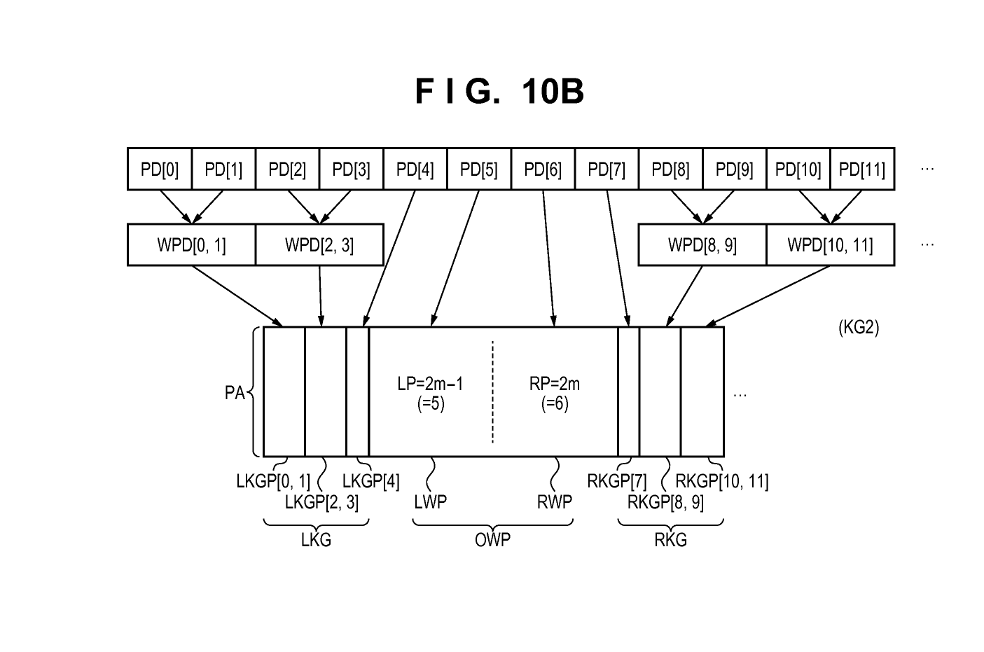

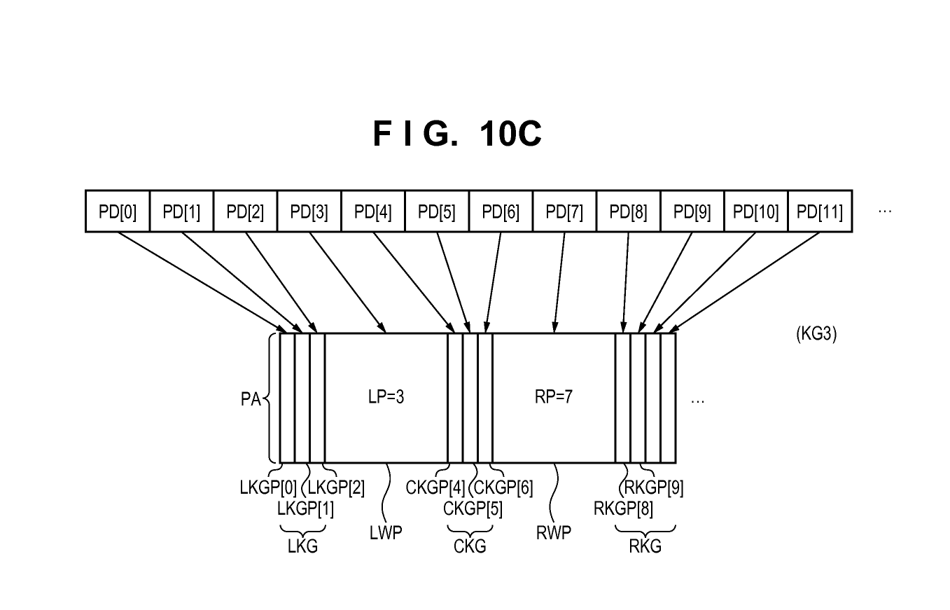

FIGS. 10A to 10C are views showing a page data structure and a page display format of an electronic book 10 according to the third embodiment. Book contents are loaded to page data PD[i] (i=0, 1, 2, . . . . ) Page data PD[2m] and PD[2m+1] are set in expanded page data WPD[2m, 2m+1] (m=0, 1, 2, . . . . ) Two pages by the expanded page data WPD[2m, 2m+1] are displayed in the left/right enlargement pages according to the third embodiment, respectively. Two pages by the expanded page data WPD[2m, 2m+1] correspond to one fore edge page of the left/right fore edges.

In the third embodiment, three different display modes (first fore edge mode, second fore edge mode, and third fore edge mode) are prepared. FIG. 10A shows a display example in a first fore edge mode KG1. FIG. 10B shows a display example in a second fore edge mode KG2. FIG. 10C shows a display example in a third fore edge mode KG3. Each display mode will be described below.

According to FIG. 10A showing the first fore edge mode KG1, a double-page spread OWP (=WPD[4, 5]) including a left enlargement page LWP (=PD[4]) and a right enlargement page RWP (=PD[5]) is displayed in the middle of the screen. A left fore edge LKG displays left fore edge pages LKGP[0, 1] (=WPD[0, 1]) and LKGP[2, 3] (=WPD[2, 3]). A right fore edge RKG displays right fore edge pages RKGP[6, 7] (=WPD[6, 7]) and RKGP[8, 9] (=WPD[8, 9]). That is, in the first fore edge mode, page data corresponding to two pages is assigned to each of the fore edge pages.

According to FIG. 10B showing the second fore edge mode KG2, a double-page spread OWP (=PD[5]+PD[6]) including a left enlargement page LWP (=PD[5]) and a right enlargement page RWP (=PD[6]) is displayed in the middle of the screen. The left fore edge LKG displays the left fore edge pages LKGP[0, 1] (=WPD[0, 1]), LKGP[2, 3] (=WPD[2, 3]), and LKGP[4] (=PD[4]). The right fore edge RKG displays right fore edge pages RKGP[7] (=PD[7]) and RKGP[8, 9] (=WPD[8, 9]). That is, in the second fore edge mode, page data corresponding to one page is assigned to the fore edge page adjacent to each enlargement page, and page data corresponding to two pages is assigned to each of the remaining fore edge pages.

According to FIG. 10C showing the third fore edge mode KG3, a left enlargement page LWP (=PD[3]) and the right enlargement page RWP (=PD[7]) are displayed. The left fore edge LKG displays the left fore edge pages LKGP[0] (=PD[0]), LKGP[1] (=PD[1]), and LKGP[2] (=PD[2]). A middle fore edge CKG displays middle fore edge pages CKGP[4] (=PD[4]), CKGP[5] (=PD[5]), and CKGP[6] (=PD[6]). The right fore edge RKG displays right fore edge pages RKGP[8] (=PD[8]), RKGP[9] (=PD[9]), and RKGP[10] (=PD[10]). That is, in the third fore edge mode, page data corresponding to one page is assigned to each fore edge page so that the display control is done on the page basis, as in the first embodiment. In addition, the middle fore edge appears.

In LKGP[0, 1], LKGP[2, 3], RKGP[6, 7], RKGP[8, 9], and the like in FIGS. 10A and 10B, page data of 2P corresponds to one fore edge page. These pages will be referred to as double fore edge pages hereinafter. Note that the expanded page data WPD[2m, 2m+1] displayed at the position of the left fore edge page LKGP[2m, 2m+1] will also be referred to as a double fore edge page. Two continuous page numbers are set in each double fore edge page, like an even number (2m) and an odd number (2m+1).

In LKGP[4] and RKGP[7] in FIG. 10B and LKGp[2], CKGP[4], and RKGP[8], and the like in FIG. 10C, page data of 1P corresponds to one fore edge page. These pages will be referred to as single fore edge pages hereinafter. Note that the page data PD[i] displayed at any position of the left/middle/right fore edge pages LKGP[i], CKGP[i], and RKGP[i] will also be referred to as a single fore edge page. Note that the left/middle/right fore edges can display a sufficiently large number of left/middle/right fore edge pages. The width of the left/middle/right fore edge page gradually decreases as the distance from the left/right enlargement page increases.

Page Turning Processing (Overall)

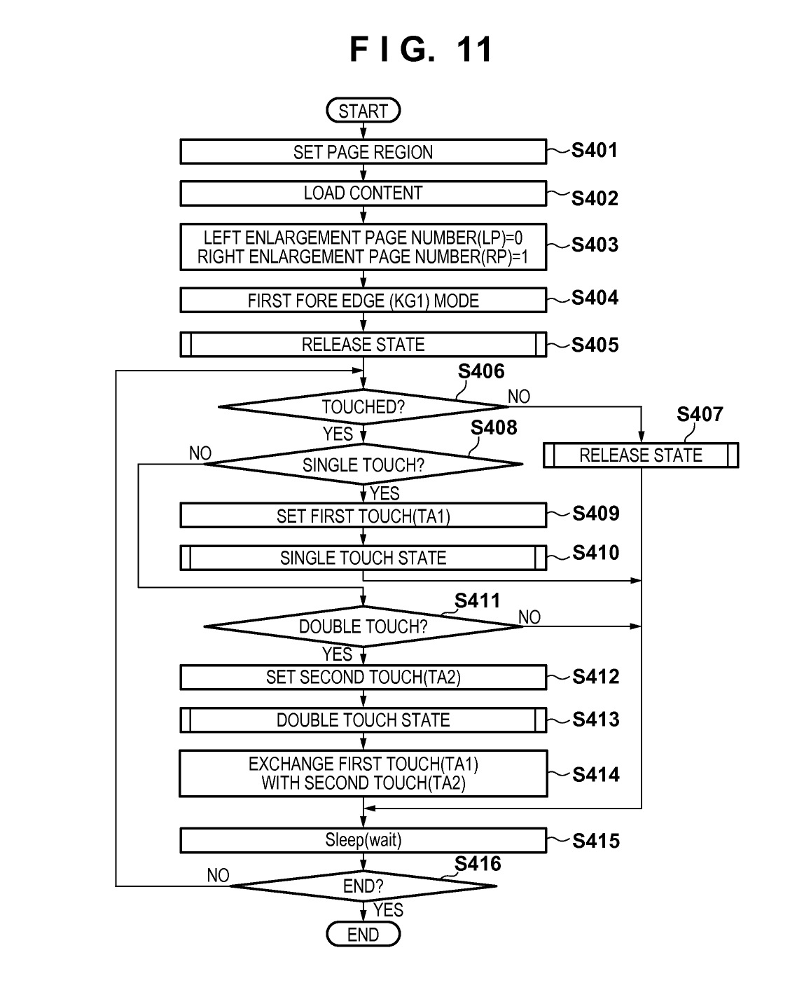

The page turning processing according to the third embodiment will be described below with reference to the flowchart of FIG. 11.

In step S401, a whole page region PA as shown in FIG. 10A to 10C is set in a display device 15. In step S402, book contents are loaded via a memory card or a network. The loaded contents are stored in the page data PD[i] (i=1, 2, . . . . ) Page data PD[0] is empty and represents the blank page at the start of the book. In step S403, initialization is performed to set the left enlargement page number LP=0 and the right enlargement page number RP=1. The left enlargement page LWP=PD[LP(=0)] and the right enlargement page RWP=PD[RP(=1)] are thus set. In step S404, the display format is initialized to the first fore edge mode KG1. In step S405, release state processing is performed. Details of the release state processing will be described later.

In step S406, it is determined whether the display device 15 is touched. If YES in step S406, the process advances to step S408. If NO in step S406, the process advances to step S407 to perform the same release state processing as in step S405, and the process advances to step S415.

In step S408, it is determined whether the touch on the screen is a single touch. If YES in step S408, the process advances to step S409. If NO in step S408, the process advances to step S411. In step S409, the touch detected in step S406 is set as a first touch TA1. In step S410, single touch processing is performed, and the process then advances to step S415. Details of the single touch processing will be described later.

In step S411, it is determined whether the touch on the screen is a double touch. If YES in step S411, the process advances to step S412. If NO in step S411, the process advances to step S415. In step S412, a touch different from the first touch TA1 set in step S409 is set as a second touch TA2. In step S413, double touch processing is performed, and the process then advances to step S414. Details of the double touch processing will be described later.

In step S414, the first touch TA1 and the second touch TA2 are exchanged, and the process advances to step S415. In the third embodiment, the first touch TA1 and the second touch TA2 are always continuously exchanged in a short time, as in the above-described first embodiment.

In step S415, the processing timing is adjusted, and the process then advances to step S416. All loop processes passing through step S415 are repetitively performed until the end of all processes is determined in step S416. In step S415, the interval of the repetitive loop is set to a predetermined very short time (for example, WAIT=100 msec). All loop processes synchronize by the WAIT time. This makes it possible to simultaneously execute a plurality of touch event processes and rendering processes in parallel.

In step S416, it is determined, based on, for example, press of an end button (not shown), whether to end the processing. Upon determining to continue the processing, the process returns to step S406.

Release State Processing

The release state processing in steps S405 and S407 will be described below in detail with reference to the flowchart of FIG. 12.

In step S501, the left enlargement page number LP and the right enlargement page number RP in the state (release state or single touch state) immediately before execution of the release state processing are acquired. In step S502, it is determined whether the immediately preceding state is the single touch state. If YES in step S502, the process advances to step S503. If NO in step S502, the process advances to step S508.

In step S503, it is determined whether the left enlargement page LWP has been touched in the immediately preceding single touch state. If YES in step S503, the process advances to step S504. If NO in step S503, the process advances to step S506.

In step S504, it is determined whether the left enlargement page number LP in the immediately preceding single touch state is an even number. If YES in step S504, it is determined that display in the first fore edge mode is possible, and the process advances to step S508. On the other hand, if NO in step S504, both the left enlargement page number LP and the right enlargement page number RP are decremented in step S505 (LP=LP−1, RP=RP−1) to enable display in the first fore edge mode, and the process advances to step S508.

In step S506, it is determined whether the right enlargement page number RP in the immediately preceding single touch state is an odd number. If YES in step S506, it is determined that display in the first fore edge mode is possible, and the process advances to step S508. On the other hand, if NO in step S506, both the left enlargement page number LP and the right enlargement page number RP are incremented in step S507 (LP=LP+1, RP=RP+1) to enable display in the first fore edge mode, and the process advances to step S508.

In step S508, the display mode is set to the first fore edge mode KG1. In step S509, fore edge page display in the first fore edge mode is done. In addition, the content of the LP page is displayed on the left enlargement page LWP (=PD[LP]), and the content of the RP (=LP+1) page is displayed on the right enlargement page RWP (=PD[RP]). Note that the left enlargement page LWP and the right enlargement page RWP are displayed as the double-page spread OWP in the middle of the display device. The display in the first fore edge mode is thus performed, thereby ending the release state processing.

Single Touch Processing

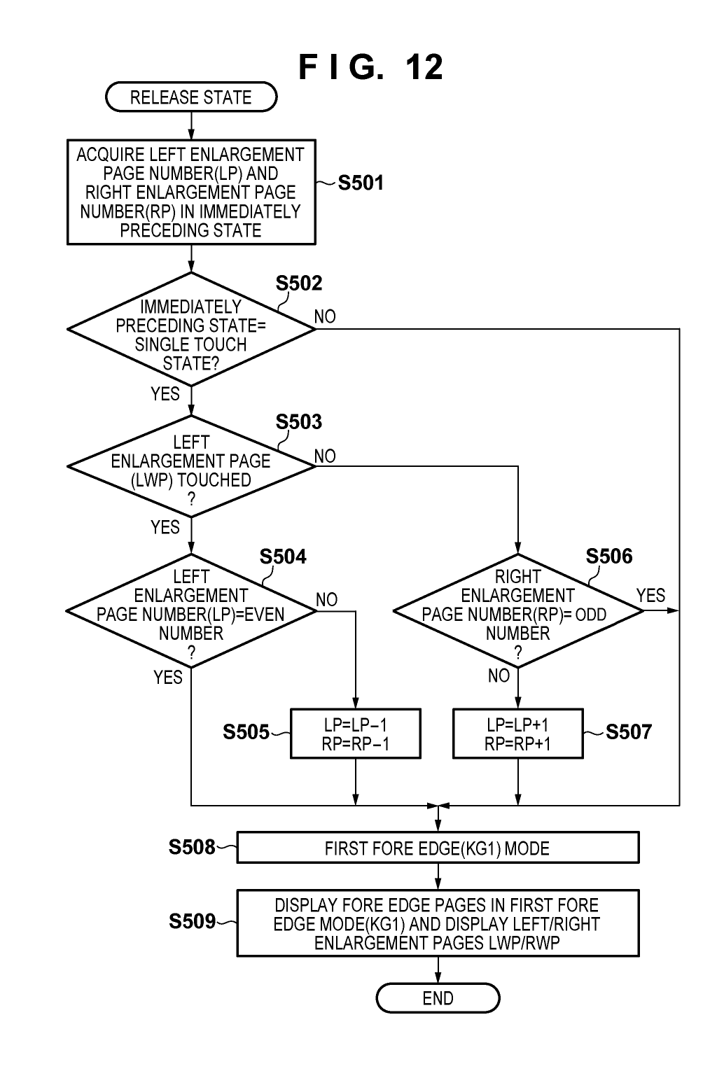

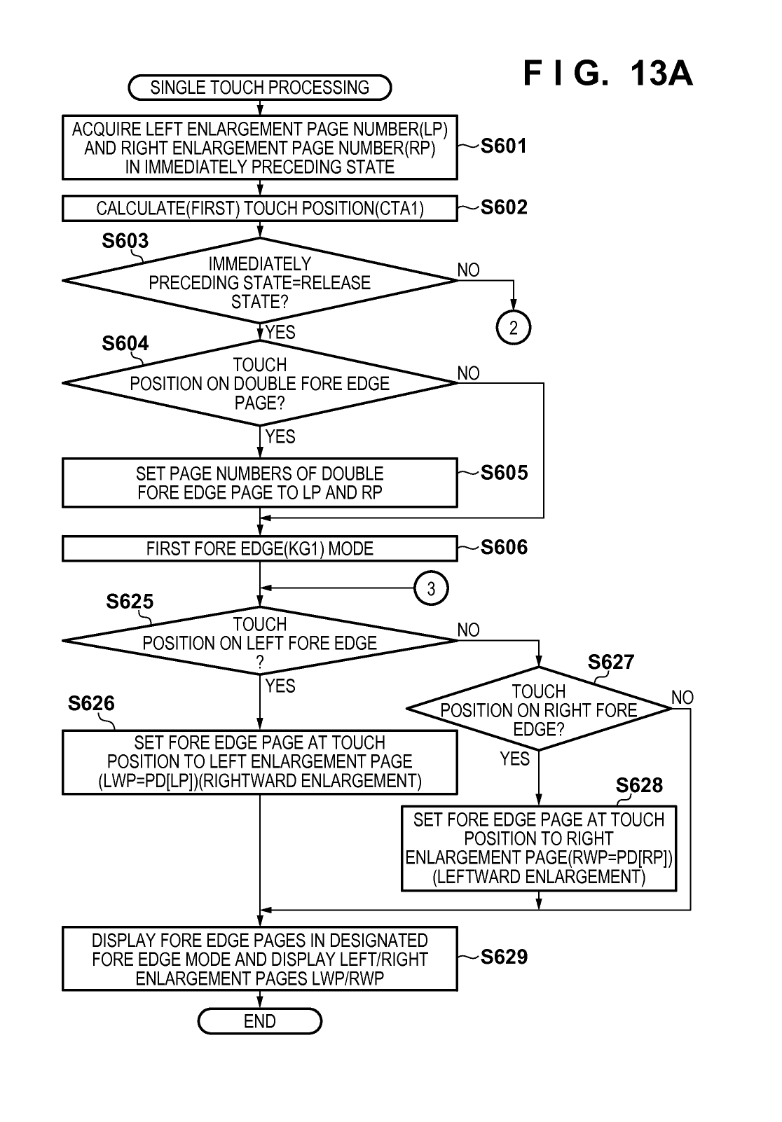

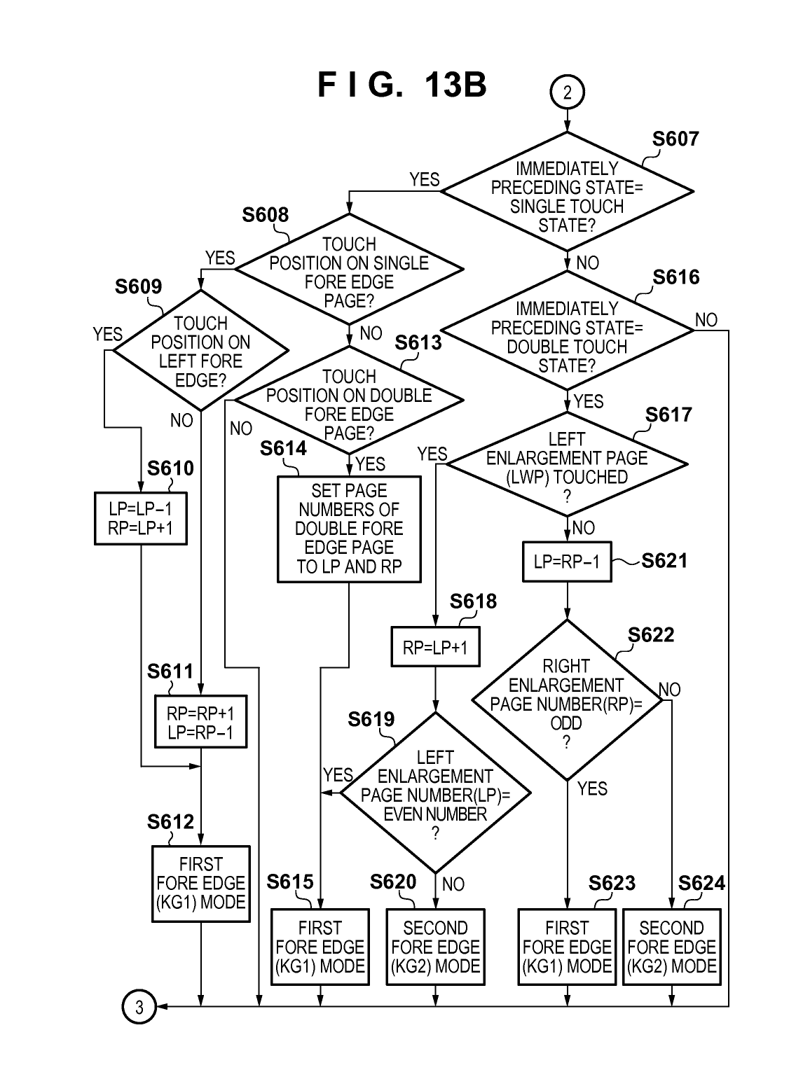

The single touch processing in step S410 will be described below in detail with reference to the flowcharts of FIGS. 13A and 13B.

In step S601, the left enlargement page number LP and the right enlargement page number RP in the state (one of the release state, the single touch state, and the double touch state) immediately before execution of the single touch processing are acquired. In step S602, a first touch position CTA1 is calculated as the center of gravity of the contact region of the first touch TA1. In step S603, it is determined whether the state immediately before execution of the single touch processing is the release state. If YES in step S603, the process advances to step S604. If NO in step S603, the process advances to step S607.

In steps S604 to S606, processing after the release state is performed. In step S604, it is determined whether the touch position is located on a double fore edge page. If YES in step S604, the process advances to step S605. If NO in step S604, the process advances to step S606. In step S605, the two continuous page numbers of the touched double fore edge page are set to the left enlargement page number LP and the right enlargement page number RP, respectively. In step S606, the display mode is set to the first fore edge mode KG1, and the process advances to step S625.

In step S607, it is determined whether the state immediately before execution of the single touch processing is the single touch state. If YES in step S607, the process advances to step S608. If NO in step S607, the process advances to step S616.

In steps S608 to S615, processing after the single touch state is performed. In step S608, it is determined whether the touch position is located on a single fore edge page. If YES in step S608, the process advances to step S609. If NO in step S608, the process advances to step S613. In step S609, it is determined whether the touch position is located on the left fore edge. If YES in step S609, the process advances to step S610. If NO in step S609, it is determined that the touch position is located on the right fore edge, and the process advances to step S611. In step S610, the left enlargement page number LP is decremented (LP=LP−1), and after that, the right enlargement page number RP is set (RP=LP+1). On the other hand, in step S611, the right enlargement page number RP is incremented (RP=RP+1), and after that, the left enlargement page number LP is set (LP=RP−1). In step S612, the display mode is set to the first fore edge mode KG1, and the process advances to step S625.

In step S613, it is determined whether the touch position is located on a double fore edge page. If YES in step S613, the process advances to step S614. If NO in step S613, the process advances to step S625. In step S614, the two continuous page numbers of the touched double fore edge page are set to the left enlargement page number LP and the right enlargement page number RP, respectively. In step S615, the display mode is set to the first fore edge mode KG1, and the process advances to step S625.

In step S616, it is determined whether the state immediately before execution of the single touch processing is the double touch state. If YES in step S616, the process advances to step S617. If NO in step S616, the process advances to step S625. In step S617, it is determined whether the left enlargement page LWP is touched. If YES in step S617, the process advances to step S618. If NO in step S617, it is determined that the right enlargement page RWP is touched, and the process advances to step S621. In step S618, the right enlargement page number RP is set (RP=LP+1). After that, in step S619, it is determined whether the current left enlargement page number LP is an even number. If YES in step S619, the display mode is set to the first fore edge mode KG1 in step S615. If NO in step S619, it is determined that the current left enlargement page number LP is an odd number. In step S620, the display mode is set to the second fore edge mode KG2. The process then advances to step S625. On the other hand, in step S621, the left enlargement page number LP is set (LP=RP−1). After that, in step S622, it is determined whether the current right enlargement page number RP is an odd number. If YES in step S622, the display mode is set to the first fore edge mode KG1 in step S623. If NO in step S622, it is determined that the current right enlargement page number RP is an even number. In step S624, the display mode is set to the second fore edge mode KG2. The process then advances to step S625.

In step S625, it is determined whether the touch position is located on the left fore edge LKG. If YES in step S625, the process advances to step S626. If NO in step S625, the process advances to step S627. In step S626, the page data is enlarged rightward while fixing the left edge of the fore edge page at the touch position and set as the left enlargement page (LWP=PD[LP]). On the other hand, in step S627, it is determined whether the touch position is located on the right fore edge RKG. If YES in step S627, the process advances to step S628. If NO in step S627, the process advances to step S629. In step S628, the page data is enlarged leftward while fixing the right edge of the fore edge page at the touch position and set as the right enlargement page (RWP=PD[RP]). In step S629, the left/right enlargement pages and the fore edge pages are displayed in the designated display mode (first fore edge mode or second fore edge mode). The display in the first fore edge mode or the second fore edge mode is thus performed, thereby ending the single touch processing.

Double Touch Processing

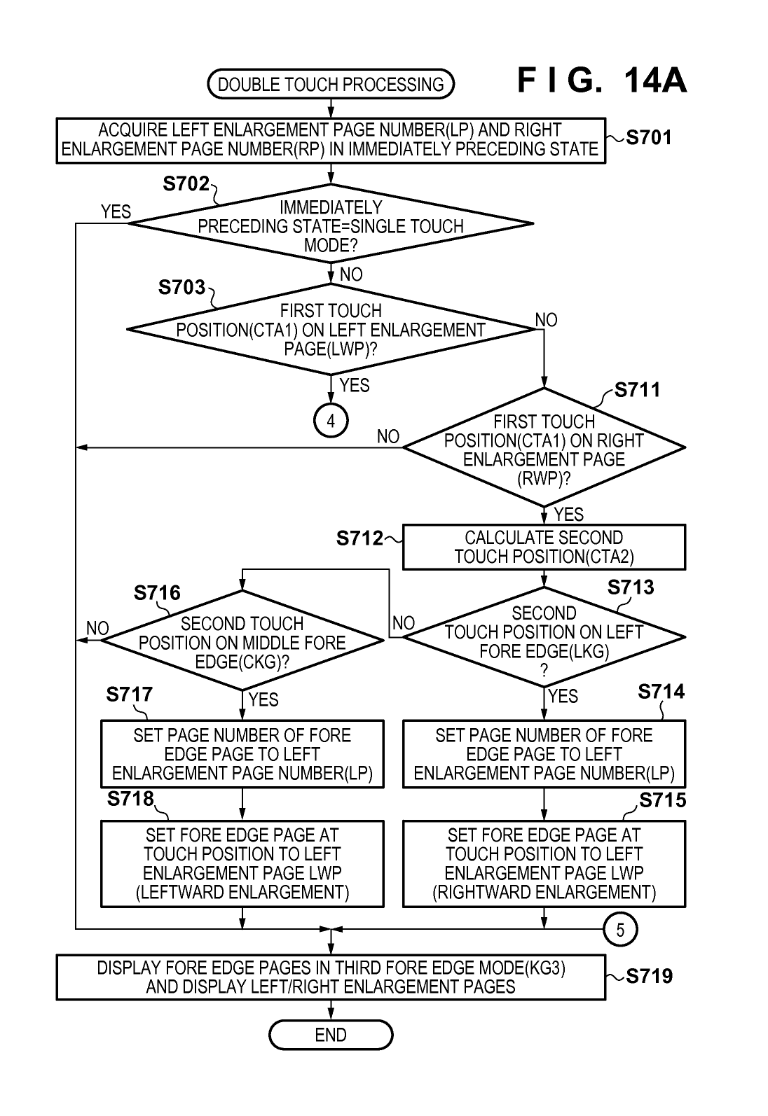

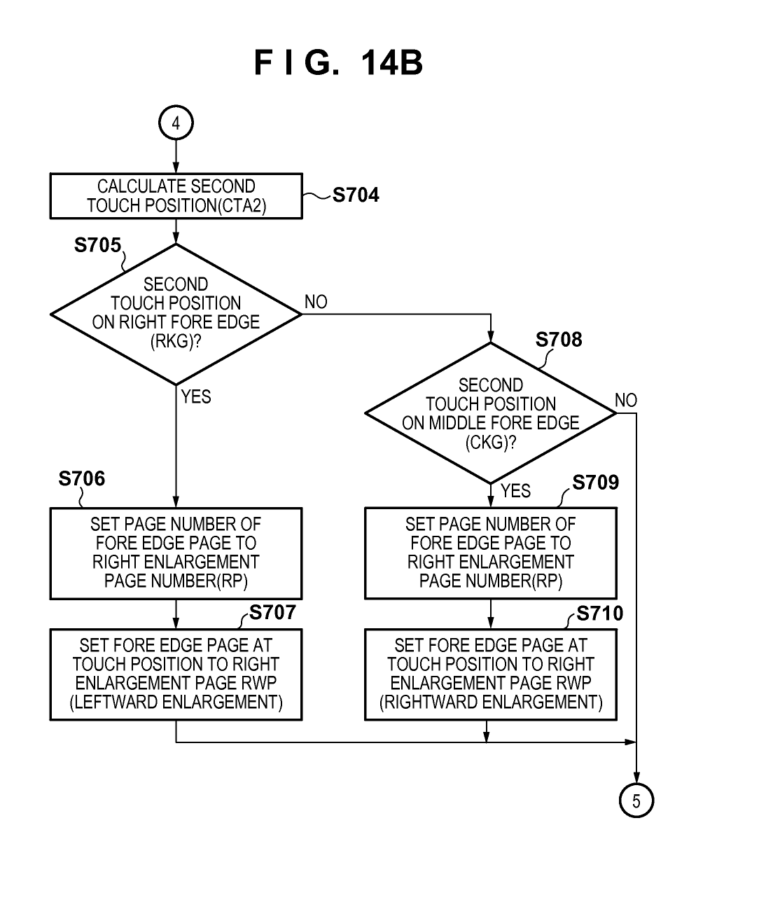

The double touch processing in step S413 will be described below in detail with reference to the flowcharts of FIGS. 14A and 14B. Note that transition to the double touch state in the third embodiment always occurs via the single touch state, as in the above-described first embodiment. Hence, the double touch processing in step S413 is also executed after the single touch processing in step S410 of the previous loop processing. That is, when executing the double touch processing, the first touch position CTA1 has already been calculated, and the display of the left/right enlargement pages and the left/right fore edges has already been done in accordance with the first touch position CTA1.

In step S701, the left enlargement page number LP and the right enlargement page number RP in the state (single touch state or double touch state) immediately before execution of the double touch processing are acquired. In step S702, it is determined whether the state immediately before execution of the double touch processing is the single touch state. If YES in step S702, the process advances to step S719 for the first loop after the double touch state is set. If NO in step S702, the process advances to step S703 because the double touch state continues.

In step S703, it is determined whether the already calculated first touch position CTA1 is located on the left enlargement page LWP. If YES in step S703, the process advances to step S704. If NO in step S703, the process advances to step S711. In step S704, a second touch position CTA2 is calculated as the center of gravity of the contact region of the second touch TA2. In step S705, it is determined whether the second touch position CTA2 is located on the right fore edge RKG. If YES in step S705, the process advances to step S706. If NO in step S705, the process advances to step S708. In step S706, a page number i of the fore edge page PD[i] under the second touch position CTA2 is obtained and set to the right enlargement page number (RP=i). In step S707, the page data is enlarged leftward while fixing the right edge of the fore edge page obtained in step S706 and set as the right enlargement page (RWP=PD[RP(=i)]. The process then advances to step S719.

In step S708, it is determined whether the second touch position CTA2 is located on the middle fore edge CKG. If YES in step S708, the process advances to step S709. If NO in step S708, the process advances to step S719. In step S709, the page number i of the fore edge page PD[i] under the second touch position CTA2 is obtained and set to the right enlargement page number (RP=i). In step S710, the page data is enlarged rightward while fixing the left edge of the fore edge page obtained in step S709 and set as the right enlargement page (RWP=PD[RP(=i)]. The process then advances to step S719.

On the other hand, in step S711, it is determined whether the first touch position CTA1 is located on the left enlargement page LWP. If YES in step S711, the process advances to step S712. If NO in step S711, the process advances to step S719. In step S712, the second touch position CTA2 is calculated, as in step S704. In step S713, it is determined whether the second touch position CTA2 is located on the left fore edge LKG. If YES in step S713, the process advances to step S714. If NO in step S713, the process advances to step S716. In step S714, the page number i of the fore edge page PD[i] under the second touch position CTA2 is obtained and set to the left enlargement page number (LP=i). In step S715, the page data is enlarged rightward while fixing the left edge of the fore edge page obtained in step S714 and set as the left enlargement page (LWP=PD[RP(=i)]. The process then advances to step S719.

In step S716, it is determined whether the second touch position CTA2 is located on the middle fore edge CKG. If YES in step S716, the process advances to step S717. If NO in step S716, the process advances to step S719. In step S717, the page number i of the fore edge page PD[i] under the second touch position CTA2 is obtained and set to the left enlargement page number (LP=i). In step S718, the page data is enlarged leftward while fixing the right edge of the fore edge page obtained in step S717 and set as the left enlargement page (LWP=PD[RP(=i)]. The process then advances to step S719.

In step S719, the left/right enlargement pages and the fore edge pages are displayed in the third fore edge mode KG3 as shown in FIG. 10C. In this case, the contents are displayed in the enlargement pages but not in the fore edge pages, as in the first embodiment. The display in the third fore edge mode is thus performed, thereby ending the double touch processing.

Page Turning Operation

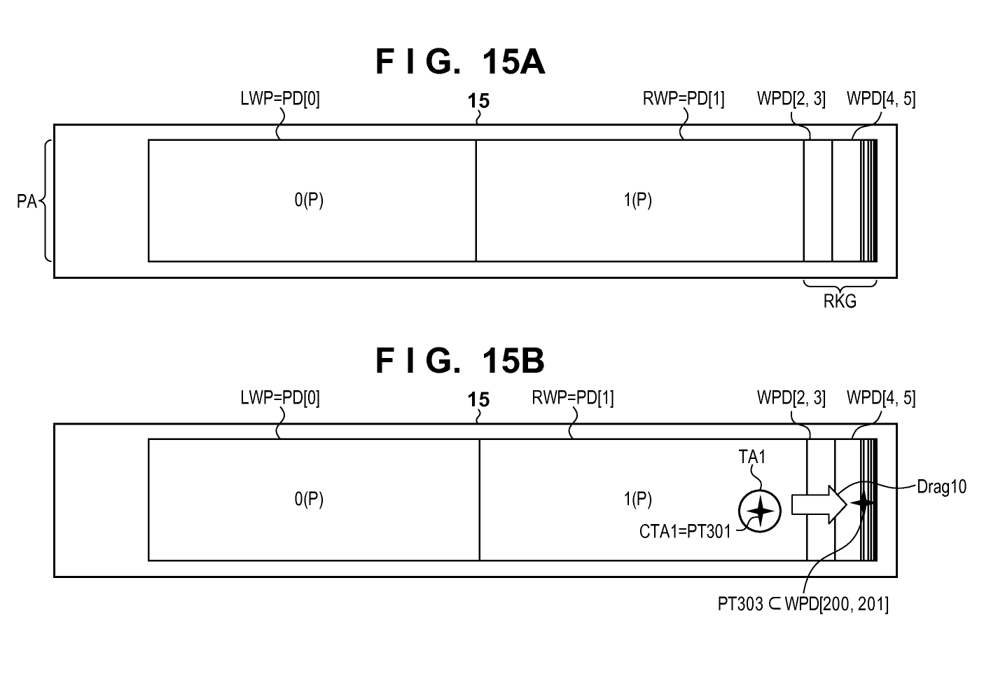

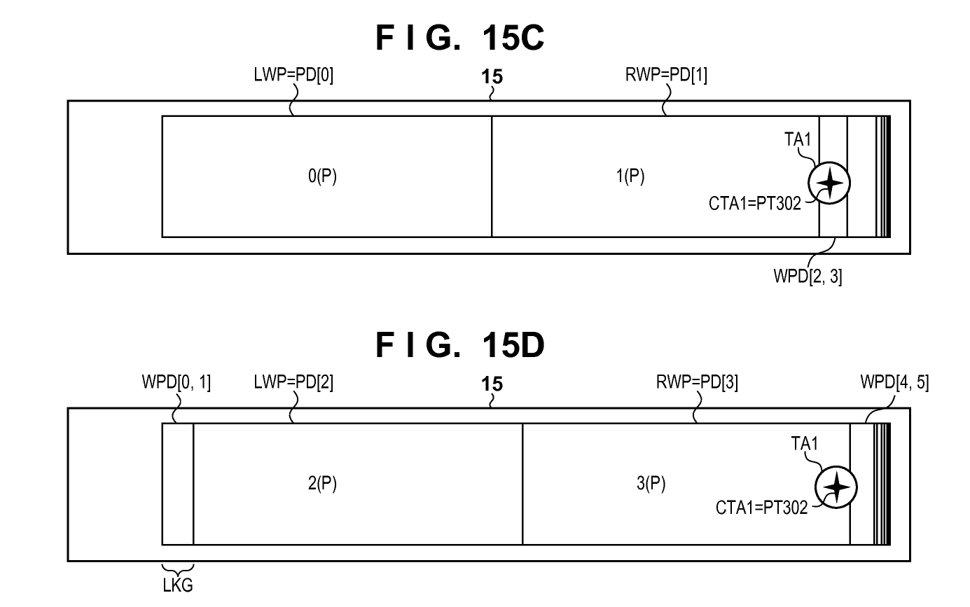

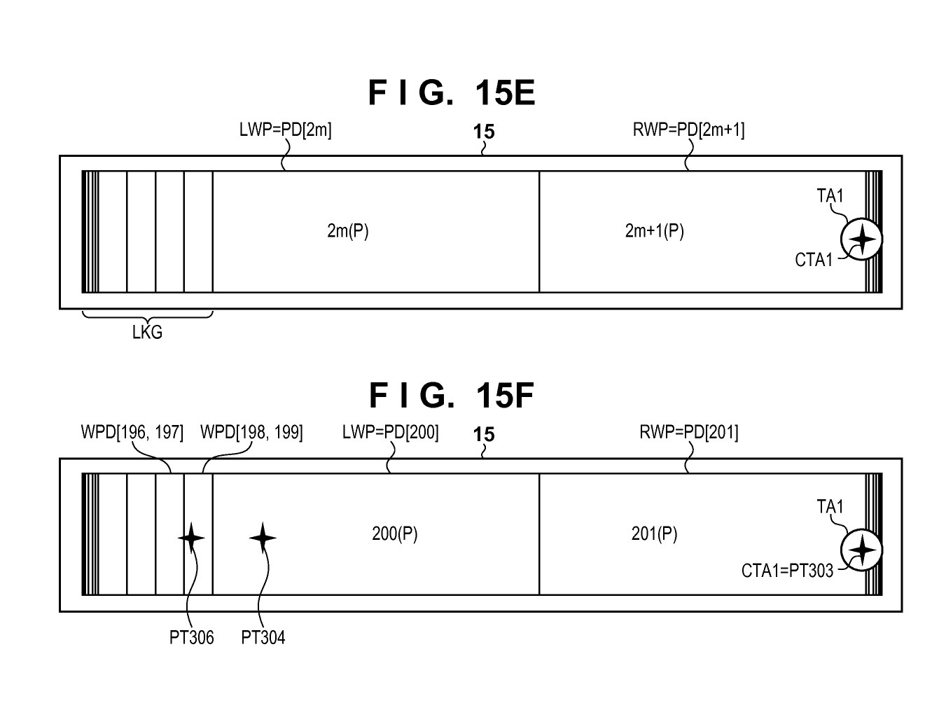

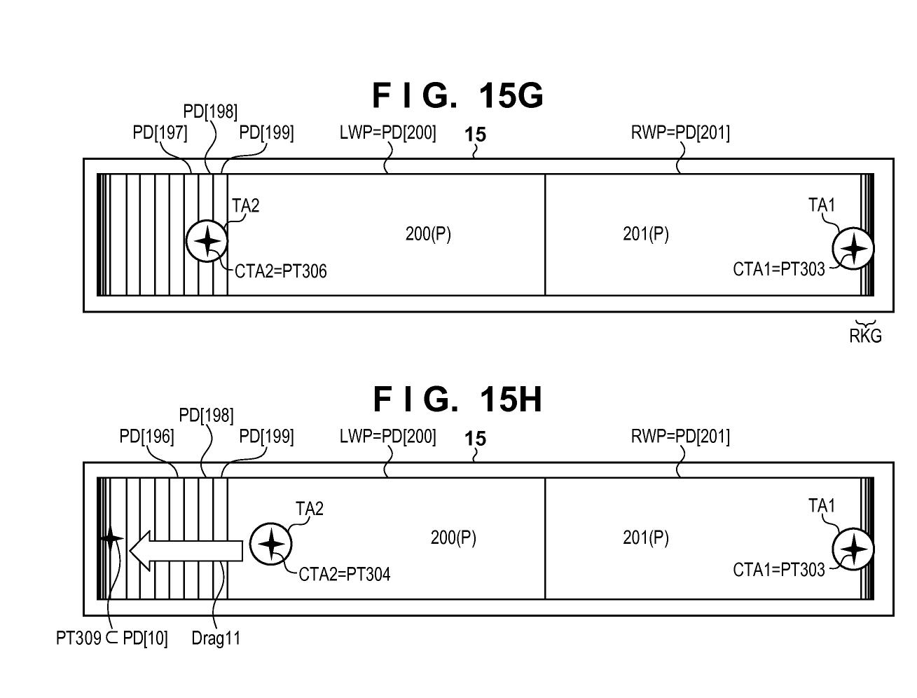

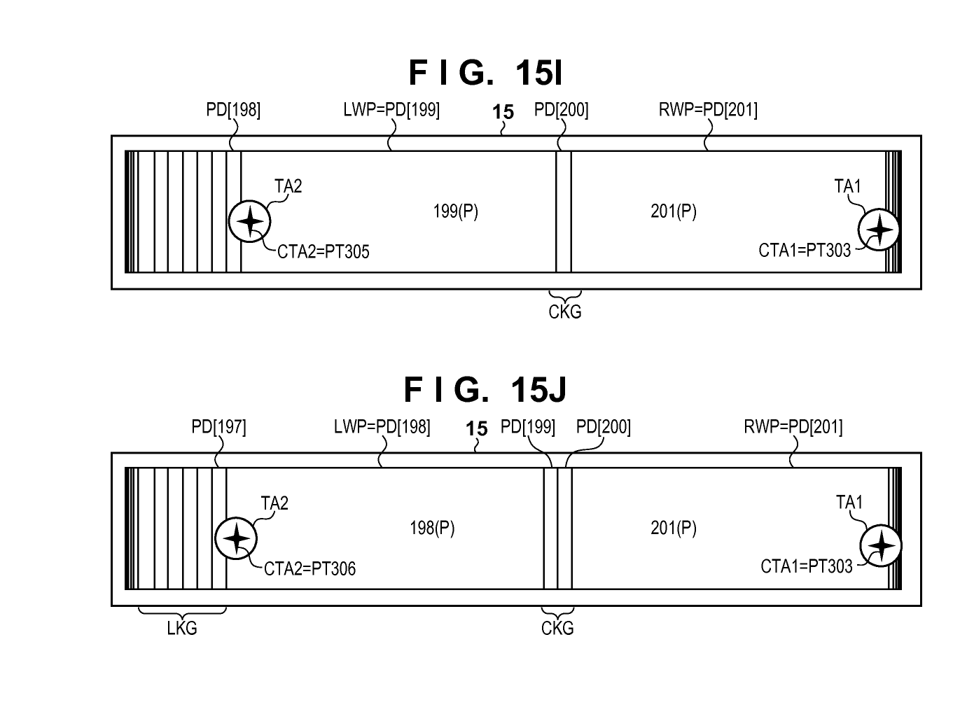

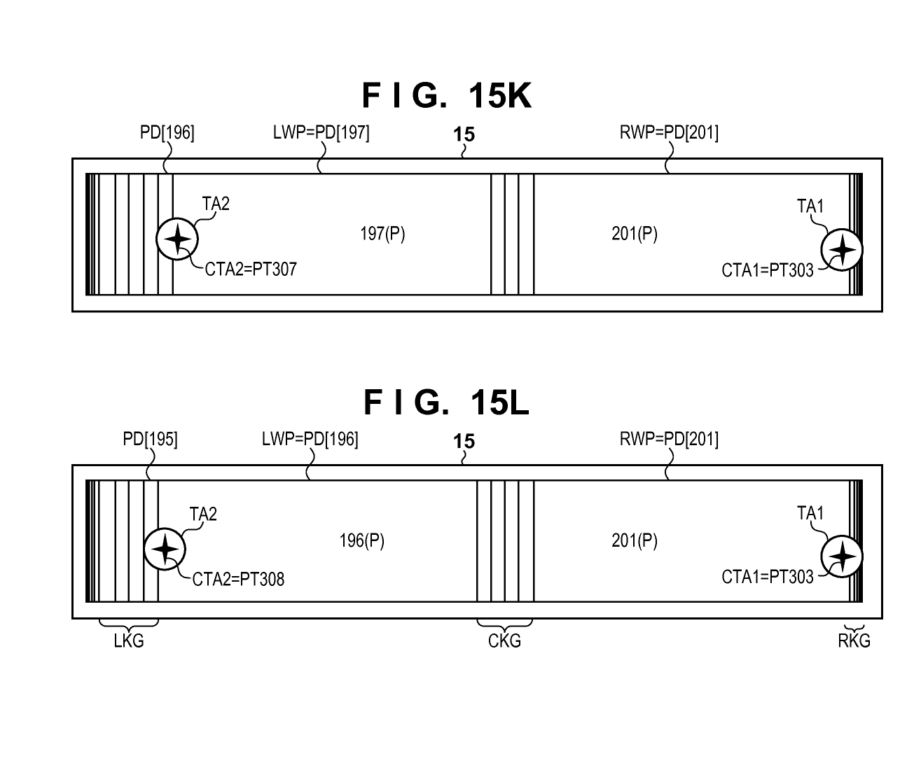

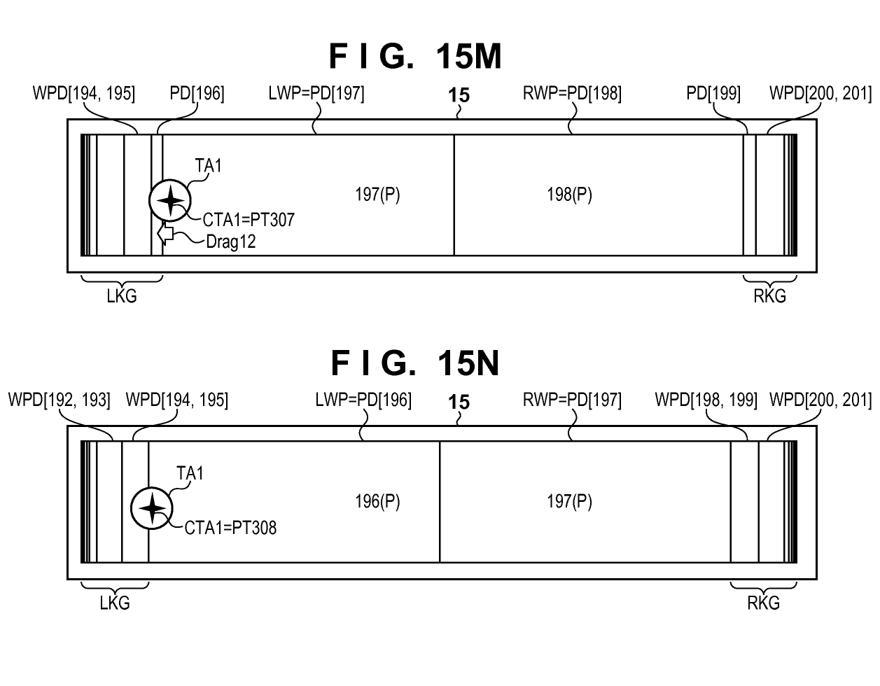

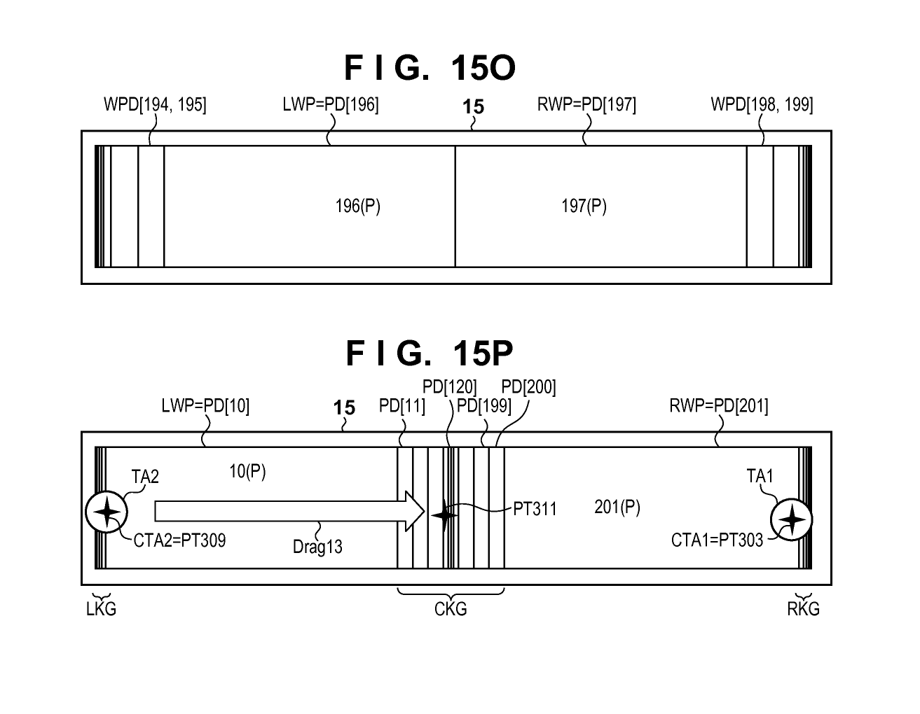

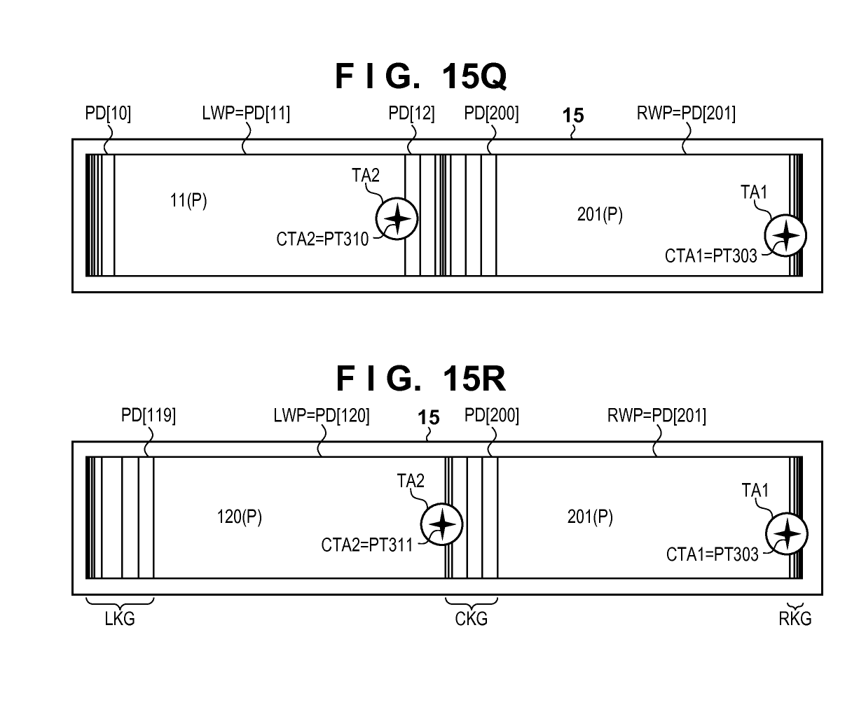

The user's page turning operation and the response of the apparatus according to the third embodiment will be described below in detail with reference to the display screens shown in FIGS. 15A to 15R. Note that FIGS. 15A to 15R do not illustrate the page contents, like FIGS. 9A to 9I of the above-described second embodiment, and actually, the page contents are displayed in a display region having the same aspect ratio as in the first embodiment. In addition, corresponding step numbers in FIGS. 11 to 14 will be mentioned for the operations to be described below.

The screen shown in FIG. 15A indicates a state in which pages are displayed in the first fore edge mode KG1 in the release state after the contents have been loaded (S509). Referring to FIG. 15A, the double-page spread OWP (=WPD[0, 1])=left enlargement page LWP (=PD[0])+right enlargement page RWP (=PD[1]) is displayed. At this time, the left fore edge LKG does not exist yet, and only the right fore edge RKG exists. The right fore edge RKG displays the right fore edge pages WPD[2, 3], WPD[4, 5], and WPD[6, 7], . . . . The right fore edge page becomes narrow rightward.

When the single touch TA1 is performs in this release state, the screen shown in FIG. 15B is displayed. In this case, the processing in step S629 is performed after S406-S408-S409-S410-S601-S602-S603-S604-S606-S625-S627. That is, the page display is not updated. In this case, the initial center of gravity of the single touch TA1 is CTA1=PT301. The user drags on the shortest path to move the center CTA1 of gravity from PT301 on the right enlargement page to a position PT303 on the right fore edge page WPD[4, 5] (Drag10). The procedure of processing during the Drag10 operation includes YES in step S406, YES in step S408, and NO in step S416 of FIG. 11. That is, the procedure loops through S406-S408-S409-S410-S415-S416-S406. At this time, in the single touch processing (S410), the processing is performed on the path S601-S602-S603-S607-S608-S613-S614-S615-S625-S627-S628-S629. Hence, during the Drag10 operation, the page numbers of the double fore edge page at the touched position are set to the left/right enlargement page numbers (LP/RP) in step S614. In step S629, the double-page spread OWP=WPD[LP, RP] is displayed. For example, when the touch position CTA1 moves to a position PT302 (⊂WPD[2, 3]) during the Drag10 operation, LP=2 and RP=3 are set in step S614, as shown in the screen of FIG. 15C. Then, in step S629, the double-page spread OWP (=WPD[2, 3]) and the left/right fore edge pages are displayed in the first fore edge mode KG1, as shown in the screen of FIG. 15D.

Along with the movement of the touch position CTA1 on the double fore edge page WPD[2m, 2m+1] (m=1, 2, . . . , 100), the double-page spread OWP (=WPD[2m, 2m+1]) is displayed in the first fore edge mode KG1, as shown in the screen of FIG. 15E. When the touch position has reached CTA1=PT303 (m=100), the double-page spread OWP (=WPD[200, 201]) is displayed, as shown in the screen of FIG. 15F.

Assume that the second touch TA2 is given to a position PT304 while keeping the first touch TA1 given to the position PT303 in the screen state shown in FIG. 15F (double touch state). In this case, step S702 results in YES, and the third fore edge mode KG3 is set in step S719 so that the display thus switches to the screen shown in FIG. 15H. For example, the double fore edge page WPD[198, 199] in the screen shown in FIG. 15F, which is displayed in the first fore edge mode KG1, is divisionally displayed as two single fore edge pages PD[198] and PD[199] in the screen shown in FIG. 15H.

Assume that the user drags the second touch TA2 from the position PT304 (⊂PD[200]) to a position PT309 (⊂PD[10]) in the double touch state shown in the screen of FIG. 15H (Drag11). The procedure of processing during the Drag11 operation includes YES in step S406, NO in step S408, YES in step S411, and NO in step S416 of FIG. 11. That is, the procedure loops through S406-S408-S411-S412-S413-S414-S415-S416-S406. At this time, in the double touch processing (S413), the processing is performed on the path S701-S702-S703-S711-S712-S713-S714-S715-S719. Hence, during the Drag11 operation, the page number of the single fore edge page at the touched position is set to the left enlargement page number LP in step S714. In step S715, the left enlargement page LWP=PD[LP] is set. In step S719, the left/right enlargement pages and the left/middle/right fore edge pages are displayed in the third fore edge mode KG3. For example, when the touch position CTA2 moves to a position PT305 during the Drag11 operation, LP=199 is set in step S714, and the left enlargement page LWP=PD[199] is set and displayed in the third fore edge mode KG3 in step S715, as shown in the screen of FIG. 15I. Hence, in the Drag11 operation, when the touch position TA2 is dragged further leftward, the page display transits shown in the screen examples of FIGS. 15J, 15K, 15L, and 15P. According to this display transition, the left enlargement page LWP is turned in the direction of the previous page while maintaining the right enlargement page RWP. Hence, the left fore edge LKG decreases, and the middle fore edge CKG increases.

Assume that the second touch TA2 is given to a position PT306 while keeping the first touch TA1 given to the position PT303 in the screen state shown in FIG. 15F (double touch state). In this case, step S702 results in YES, and the third fore edge mode KG3 is set in step S719 so that the display thus switches to the screen shown in FIG. 15G. After the double touch processing (step S413) is executed again, step S702 results in NO, and the processing is performed on the path S703-S711-S712-S713-S714-S715-S719. At this time, in step S714, LP=198 is set. In step S715, the left enlargement page LWP=PD[198] is set. In step S719, the display is done as shown in the screen of FIG. 15J.

When the user cancels the right-side touch CTA1 from the double touch state shown in the screen of FIG. 15K, single touch processing is performed on the path S406-S408-S409-S410. At this time, in step S409, the touch at the position CTA2=PT307 on the screen of FIG. 15K is newly set as the first touch TA1. Then, in the single touch processing (S410), the processing is performed on the path S601-S602-S603-S607-S616-S617-S618-S619-S620-S625-S627-S629. At this time, in step S601, LP=197 and RP=201 are acquired. In step S618, they are changed to LP=197 and RP=LP+1=198. In step S620, the display mode is set to the second fore edge mode KG2. In step S629, the double-page spread OWP=WPD[197, 198]=PD[LP (=197)]+PD[RP (=198)] is displayed like a screen of FIG. 15M.

When the user cancels the right-side touch CTA1 from the double touch state shown in the screen of FIG. 15L, single touch processing is performed on the path S406-S408-S409-S410. At this time, in step S409, the touch at the position CTA2=PT308 on the screen of FIG. 15L is newly set as the first touch TA1. Then, in the single touch processing (S410), the processing is performed on the path S601-S602-S603-S607-S616-S617-S618-S619-S615-S625-S627-S629. At this time, in step S601, LP=196 and RP=201 are acquired. In step S618, they are changed to LP=196 and RP=LP+1=197. In step S615, the display mode is set to the first fore edge mode KG1. In step S629, the double-page spread OWP=WPD[196, 197]=PD[LP (=196)]+PD[RP (=197)] is displayed like a screen of FIG. 15N.

Assume that the user drags the touch position CTA1 onto the single fore edge page PD[196] in the single touch state shown in the screen of FIG. 15M (Drag12). Then, processing is performed on the path S601-S602-S603-S607-S608-S609-S610-S612-S625-S626-S629. At this time, in step S601, LP=197 and RP=198 in the immediately preceding state are set. When the touch position CTA1 has moved to the single fore edge page PD[196], step S609 results in YES. In step S610, the page numbers are changed to LP=LP−1=196 and RP=LP+1=197. In step S612, the display mode is set to the first fore edge mode KG1. In step S629, the double-page spread OWP=WPD[196, 197] is displayed like the screen shown in FIG. 15N.

When the user cancels the touch TA1 from the single touch state shown in the screen of FIG. 15M, step S406 results in NO, and the release state processing in step S407 is performed. In the release state processing, the processing is performed on the path S501 (LP=197, RP=198)-S502 (YES)-S503 (YES)-S504 (NO)-S505 (LP=196, RP=197)-S508 (KG1). In step S509, the double-page spread OWP=WPD[196, 197] is displayed in the home position, like the screen shown in FIG. 15O. Similarly, when the user cancels the touch TA1 from the single touch state shown in the screen of FIG. 15N, the double-page spread OWP=WPD[196, 197] is displayed in the home position, like the screen shown in FIG. 15O.

Assume that the user drags the left-side touch TA2 from the position PT309 to a position PT311 (⊂PD[120]) in the double touch state indicated by a screen of FIG. 15P (Drag13). At this time, in the double touch processing (S413), the processing is performed on the path S701-S702-S703-S711-S712-S713-S716-S717-S718-S719. The middle fore edge page at the touch position is sequentially displayed as the left enlargement page, as shown in the screens of FIGS. 15Q and 15R (S716-S717-S718).

Effects Obtained by Third Embodiment

As described above, according to the third embodiment, when performing a drag operation to a fore edge, page turning on the basis of two continuous pages can be performed. This allows to implement an operability closer to a paper book.

### Fourth Embodiment

The fourth embodiment of the present invention will be described below.

In the fourth embodiment, a page region PA is divided into two, first page region APA and a second page region BPA. There are provided a mode (synchronization mode) in which the page regions operate in synchronism, and a mode (independent mode) in which the page regions operate independently. For example, in the synchronization mode, a page number AP displays in a first enlargement page AWP and a page number BP displayed in the second enlargement page BWP are displayed such that they continue. On the other hand, in the independent mode, the first enlargement page AWP and the second enlargement page BWP can be turned over independently, and the first enlargement page number AP and the second enlargement page number BP do not synchronize. In the fourth embodiment, the synchronization mode and the independent mode can be switched seamlessly during display of an electronic document.

Note that an electronic document display apparatus according to the fourth embodiment has the same arrangement as that of the above-described first embodiment, and a description thereof will be omitted.

Page Data Structure and Page Display Format

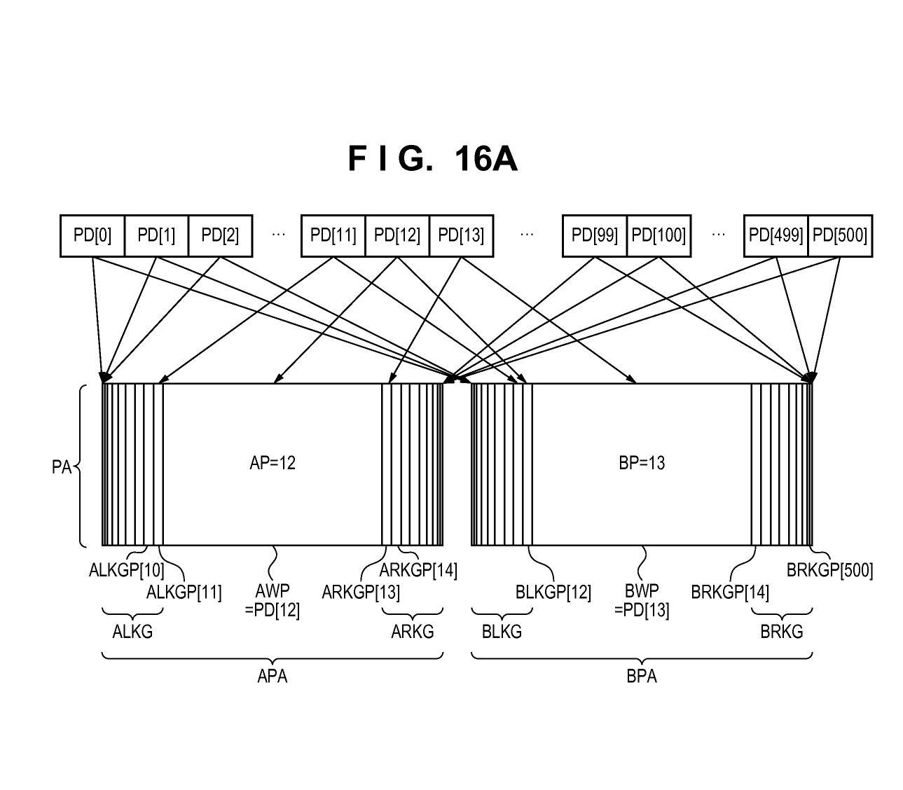

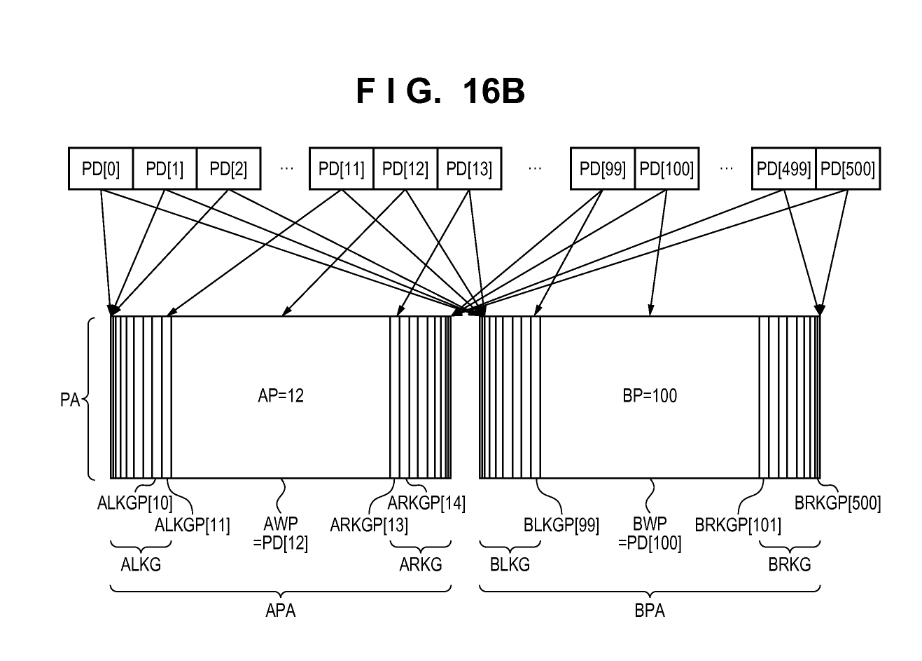

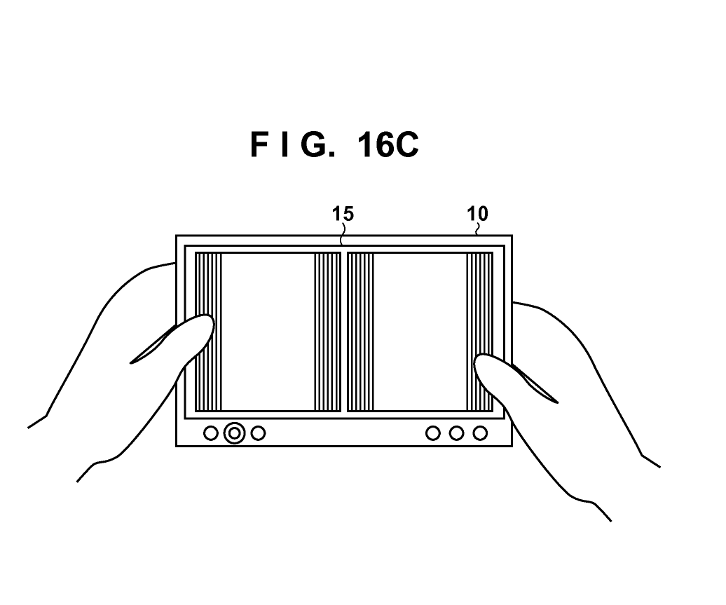

FIGS. 16A and 16B are views showing a page data structure and a page display format of an electronic book 10 according to the fourth embodiment. Book contents are loaded to page data PD[i] (i=0, 1, 2, . . . . )

In the fourth embodiment, enlargement pages include the first enlargement page AWP (first double-page spread) and the second enlargement page BWP (second double-page spread). The fore edges include a first left fore edge ALKG, a first right fore edge ARKG, a second left fore edge BLKG, and a second right fore edge BRKG. Each fore edge includes a plurality of pages. The fore edge pages include a first left fore edge page ALKGP[i], a first right fore edge page ARKGP[i], a second left fore edge page BLKGP[i], and a second right fore edge page BRKGP[i]. The page data PD[i] is associated with each of the fore edge pages ALKGP[i], ARKGP[i], BLKGP[i], and BRKGP[i] shown in FIGS. 16A and 16B. In the fourth embodiment, the page data PD[i] associated with the fore edge page such as ALKGP[i] will also be referred to as a fore edge page. For example, a fore edge page PD[12] associated with the first enlargement page AWP as AWP=PD[12] is displayed in the position and size designated by the first enlargement page AWP. In addition, for example, a fore edge page PD[11] associated with the first left fore edge page ALKGP as ALKGP[11]=PD[11] is displayed in the position and size designated by the first left fore edge page ALKGP[11].

FIG. 16A is a view for explaining the synchronization mode according to the fourth embodiment. When setting the synchronization mode, the first enlargement page AWP, the first left fore edge ALKG (first fore edge region), and the first right fore edge ALRG (second fore edge region) are set in the first page region APA, as shown in FIG. 16A. When first enlargement page AWP=PD[BP (=12)], the first left fore edge pages ALKGP[11], ALKGP[10], ALKGP[9], . . . are set in the first left fore edge ALKG sequentially from the right side. In addition, the first right fore edge pages ARKGP[13], ARKGP[14], ARKGP[15], . . . are set in the first right fore edge ARKG sequentially from the left side. The second enlargement page BWP, the second left fore edge BLKG (third fore edge region), and the second right fore edge BLRG (fourth fore edge region) are set in the second page region BPA. In the synchronization mode, the second enlargement page number BP displayed in the second enlargement page BWP synchronizes with the first enlargement page number AP displayed in the first enlargement page AWP. Since BP=AP+1, the second enlargement page BWP=PD[BP (=13)]. At this time, the second left fore edge pages BLKGP[12], BLKGP[11], BLKGP[10], . . . are set in the second left fore edge BLKG sequentially from the right side. In addition, the second right fore edge pages BRKGP[14], BRKGP[15], BRKGP[16], . . . are set in the second right fore edge BRKG sequentially from the left side.

FIG. 16B is a view for explaining the independent mode according to the fourth embodiment. When setting the independent mode, the first enlargement page AWP, the first left fore edge ALKG, and the first right fore edge ALRG are set in the first page region APA, as shown in FIG. 16B. When first enlargement page AWP=PD[BP (=12)], the first left fore edge pages ALKGP[11], ALKGP[10], ALKGP[9], . . . are set in the first left fore edge ALKG sequentially from the right side. In addition, the first right fore edge pages ARKGP[13], ARKGP[14], ARKGP[15], . . . are set in the first right fore edge ARKG sequentially from the left side. On the other hand, the second enlargement page BWP, the second left fore edge BLKG, and the second right fore edge BLRG are set in the second page region BPA. In the independent mode, the second enlargement page number BP and the first enlargement page number AP are independent. For example, when BP=100, the second enlargement page BWP=PD[BP=100)]. At this time, the second left fore edge pages BLKGP[99], BLKGP[98], BLKGP[97], . . . are set in the second left fore edge BLKG sequentially from the right side. In addition, the second right fore edge pages BRKGP[101], BRKGP[102], BRKGP[103], . . . are set in the second right fore edge BRKG sequentially from the left side.

FIG. 16C is a view showing a state in which the user is operating the electronic book 10 according to the fourth embodiment while holding it by both hands. The user performs a page turning operation by touching or tracing the fore edges (ALKG/ARKG/BLKG/BRKG) displayed on a display device 15 by fingers of one hand or both hands.

Page Turning Processing (Overall)

Page turning processing according to the fourth embodiment will be described below with reference to the flowchart of FIG. 17.

In step S801, the whole page region PA as shown in FIG. 16A or 16B is set in the display device 15. In addition, the first page region APA and the second page region BPA are set in the whole page region PA. In step S802, book contents are loaded via a memory card or a network. The loaded contents are stored in the page data PD[i] (i=0, 1, 2, . . . . ) Page data PD[0] is empty and represents the blank page at the start of the book. In step S803, the display mode is set to the synchronization mode. In step S804, initialization is performed to set the first enlargement page number AP=0 and the second enlargement page number BP=1. The first enlargement page AWP=PD[AP(=0)] and the second enlargement page BWP=PD[BP(=1)] are thus set. In step S805, the currently set page data are displayed as a double-page spread in the home position. In this case, as the home position in the synchronization mode, the first enlargement page AWP is displayed at the center of the first page region APA, and the second enlargement page BWP is displayed at the center of the second page region BPA.

In step S806, it is determined whether to switch the display mode (synchronization mode/independent mode). The display mode switching is determined based on press of a mode button in operation buttons 17 of the electronic book 10. If YES in step S806, the process advances to step S807. If NO in step S806, the process advances to step S808. In step S807, mode switching processing is performed, and the process then advances to step S808. Details of the mode switching processing will be described later.

In step S808, it is determined whether the display device 15 is touched. If YES in step S808, the process advances to step S810. If NO in step S808, the process advances to step S809 to do display in the home position, and the process then advances to step S817. Note that the display form in the home position in step S809 changes depending on whether the current display mode is the synchronization mode or the independent mode. That is, when the synchronization mode has been set, a double-page spread is displayed such that two pages continue, as in step S805. When the independent mode has been set, the left/right enlargement pages are independently displayed.

In step S810, it is determined whether the touch on the screen is a single touch. If YES in step S810, the process advances to step S811. If NO in step S810, the process advances to step S813. In step S811, the touch detected in step S808 is set as a first touch TA1. In step S812, single touch processing is performed, and the process then advances to step S817. Details of the single touch processing will be described later.

In step S813, it is determined whether the touch on the screen is a double touch. If YES in step S813, the process advances to step S814. If NO in step S813, the process advances to step S817. In step S814, a touch different from the first touch TA1 set in step S811 is set as a second touch TA2. In step S815, double touch processing is performed, and the process then advances to step S816. Details of the double touch processing will be described later.

In step S816, the first touch TA1 and the second touch TA2 are exchanged, and the process advances to step S817. In the fourth embodiment as well, the first touch TA1 and the second touch TA2 are always continuously exchanged in a short time, as in the above-described first embodiment.

In step S817, the processing timing is adjusted, and the process then advances to step S818. All loop processes passing through step S817 are repetitively performed until the end of all processes is determined in step S818. In step S817, the interval of the repetitive loop is set to a predetermined very short time (for example, WAIT=100 msec). All loop processes synchronize by the WAIT time. This makes it possible to simultaneously execute a plurality of touch event processes and rendering processes in parallel. In step S818, it is determined, based on, for example, press of an end button (not shown), whether to end the processing. Upon determining to continue the processing, the process returns to step S806.

Mode Switching Processing

The mode switching processing in step S807 will be described below in detail with reference to the flowchart of FIG. 18.

In step S901, the first enlargement page number AP and the second enlargement page number BP are acquired. In step S902, it is determined whether the current mode is the synchronization mode. If the mode is the synchronization mode, the process advances to step S903 to set the display mode to the independent mode. On the other hand, if the current mode is the independent mode, the process advances to step S904 to set the display mode to the synchronization mode.

After the setting to the synchronization mode is in step S904, in step S905, it is determined whether the current state is the release state. If YES in step S905, the process advances to step S906. If NO in step S905, the process advances to step S907. In step S906, the second enlargement page number BP is set to BP=AP+1 to synchronize it with the first enlargement page number AP, thus ending the mode switching processing.

In step S907, it is determined whether the current state is the single touch state of the first enlargement page AWP. If YES in step S907, the process advances to step S908. If NO in step S907, the process advances to step S909. In step S908, the second enlargement page number BP is set to BP=AP+1 to synchronize it with the first enlargement page number AP, thus ending the mode switching processing.

In step S909, it is determined whether the current state is the single touch state of the second enlargement page BWP. If YES in step S909, the process advances to step S910. If NO in step S909, the mode switching processing ends. In step S910, the first enlargement page number AP is set to AP=BP−1 to synchronize it with the second enlargement page number BP, thus ending the mode switching processing.

Single Touch Processing

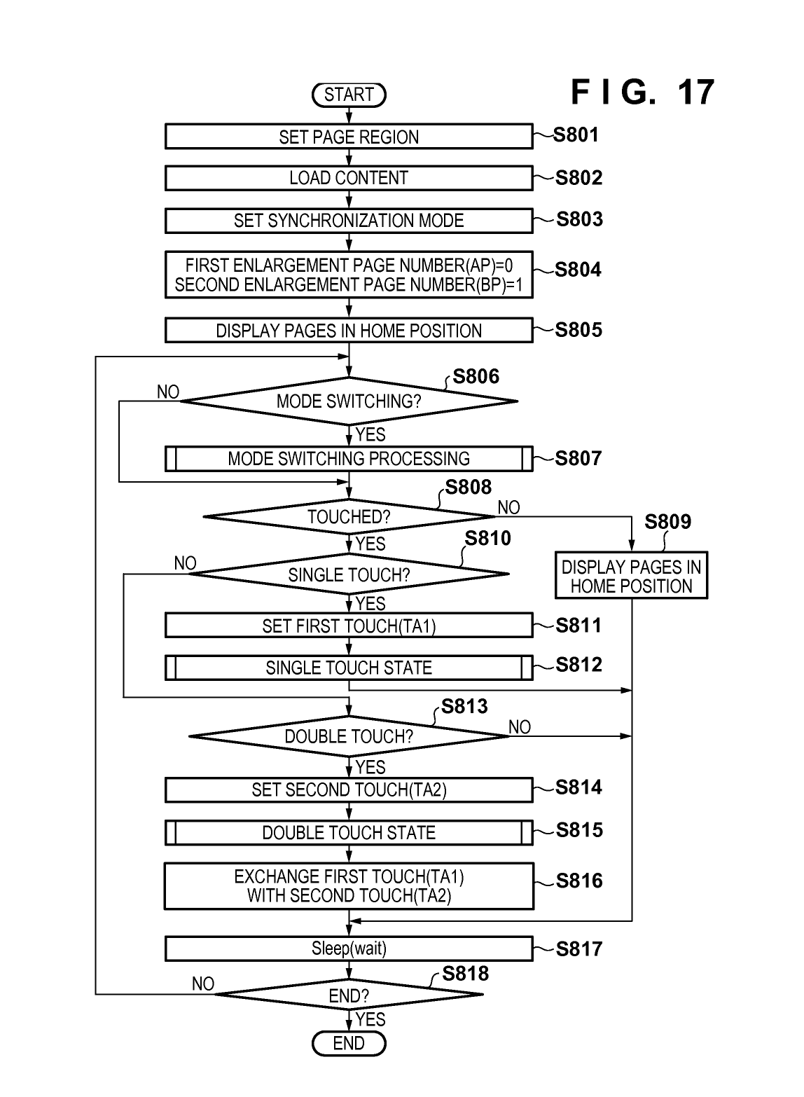

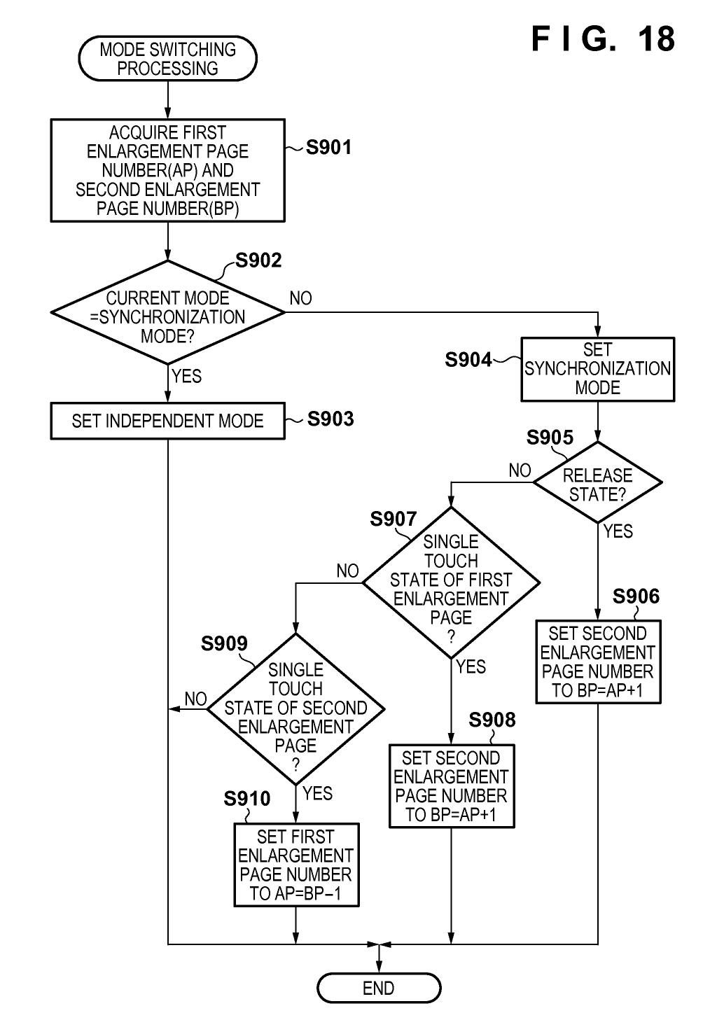

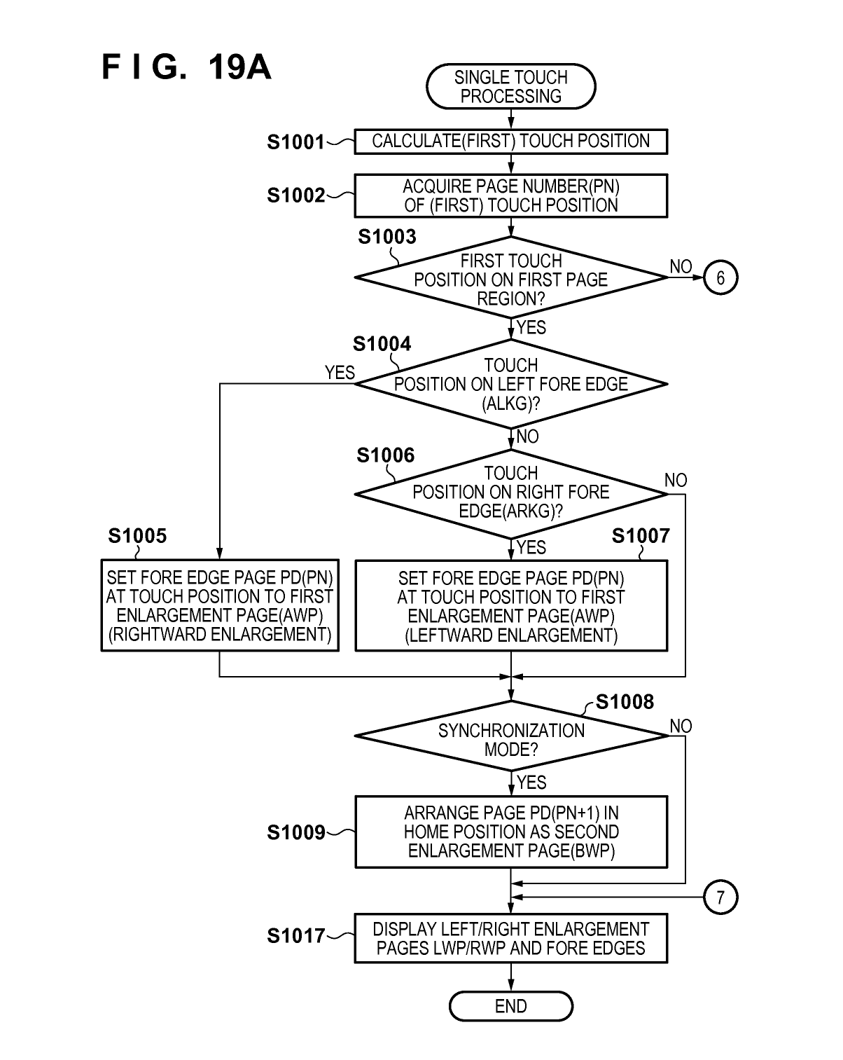

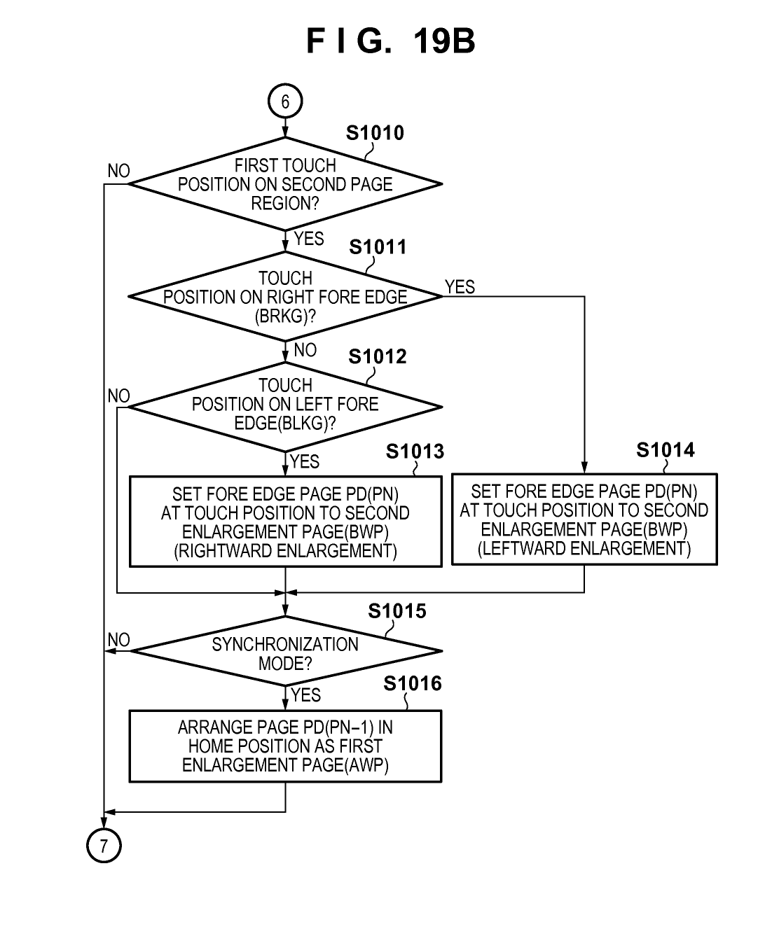

The single touch processing in step S812 will be described below in detail with reference to the flowcharts of FIGS. 19A and 19B.

In step S1001, a first touch position CTA1 is calculated as the center of gravity of the contact region of the first touch TA1. In step S1002, a page number PN of the first touch position CTA1 is acquired. That is, PN that satisfies CTA1⊂PD[PN] is obtained. In step S1003, it is determined whether the first touch position CTA1 is located in the first page region APA. If YES in step S1003, the process advances to step S1004. If NO in step S1003, the process advances to step S1010.

In step S1004, it is determined whether the first touch position CTA1 is located on the left fore edge ALKG. If YES in step S1004, the process advances to step S1005. If NO in step S1004, the process advances to step S1006. In step S1005, the page data is enlarged rightward while fixing the left edge of the fore edge page PD[PN] under the touch position CTA1 and set as the first enlargement page AWP (=PD[PN]), and the first enlargement page number is set (AP=PN).

In step S1006, it is determined whether the first touch position CTA1 is located on the right fore edge ARKG. If YES in step S1006, the process advances to step S1007. If NO in step S1006, it is determined that the first touch position CTA1 is located on the first enlargement page AWP, and the process advances to step S1008. In step S1007, the page data is enlarged leftward while fixing the right edge of the fore edge page PD[PN] under the touch position CTA1 and set as the first enlargement page AWP (=PD[PN]), and the first enlargement page number is set (AP=PN).

In step S1008, it is determined whether the display mode is the synchronization mode. If YES in step S1008, the process advances to step S1009. If NO in step S1008, the process advances to step S1017. In step S1009, the second enlargement page BWP is set to PD[PN+1], and the second enlargement page number is set (BP=PN+1). In addition, the second enlargement page BWP is displayed at the center of the second page region BPA, and the process then advances to step S1017.

On the other hand, in step S1010, it is determined whether the first touch position CTA1 is located in the second page region BPA. If YES in step S1010, the process advances to step S1011. If NO in step S1010, the process advances to step S1017. In step S1011, it is determined whether the first touch position CTA1 is located on the right fore edge BRKG. If YES in step S1011, the process advances to step S1014. If NO in step S1011, the process advances to step S1012. In step S1014, the page data is enlarged leftward while fixing the right edge of the fore edge page PD[PN] under the touch position CTA1 and set as the second enlargement page BWP (=PD[PN]), and the second enlargement page number is set (BP=PN).

In step S1012, it is determined whether the first touch position CTA1 is located on the left fore edge BLKG. If YES in step S1012, the process advances to step S1013. If NO in step S1012, it is determined that the first touch position CTA1 is located on the second enlargement page BWP, and the process advances to step S1015. In step S1013, the page data is enlarged rightward while fixing the left edge of the fore edge page PD[PN] under the touch position CTA1 and set as the second enlargement page BWP (=PD[PN]), and the second enlargement page number is set (BP=PN).

In step S1015, it is determined whether the display mode is the synchronization mode. If YES in step S1015, the process advances to step S1016. If NO in step S1015, the process advances to step S1017. In step S1016, the first enlargement page AWP is set to PD[PN−1], and the first enlargement page number is set (AP=PN−1). In addition, the first enlargement page AWP is displayed at the center of the first page region APA, and the process then advances to step S1017.

In step S1017, the enlargement page that is not touched is arranged in the home position, and the contents are displayed in the first enlargement page AWP=PD[AP] and the second enlargement page BWP=PD[BP]. The page data PD[i] before and after the first enlargement page AWP and the second enlargement page BWP are associated with the fore edge pages ALKGP[i], ARKGP[i], BLKGP[i], and BRKGP[i] while maintaining the order of pages. No contents are displayed in the fore edge pages. Note that each enlargement page may be displayed together with, for example, a frame to improve the visibility.

Double Touch Processing

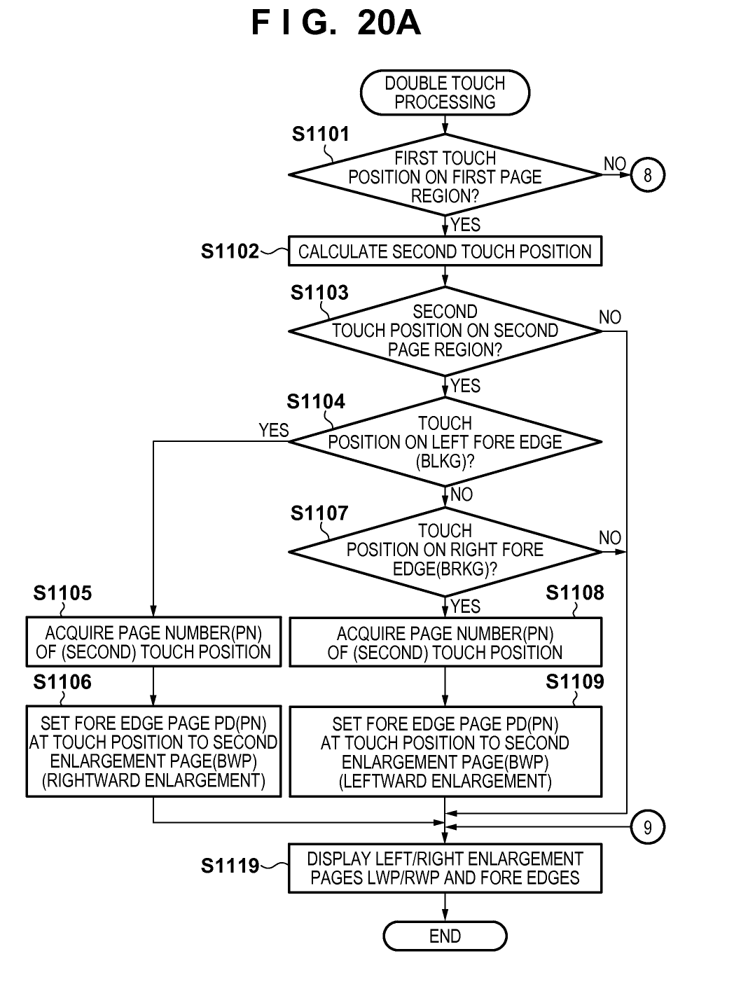

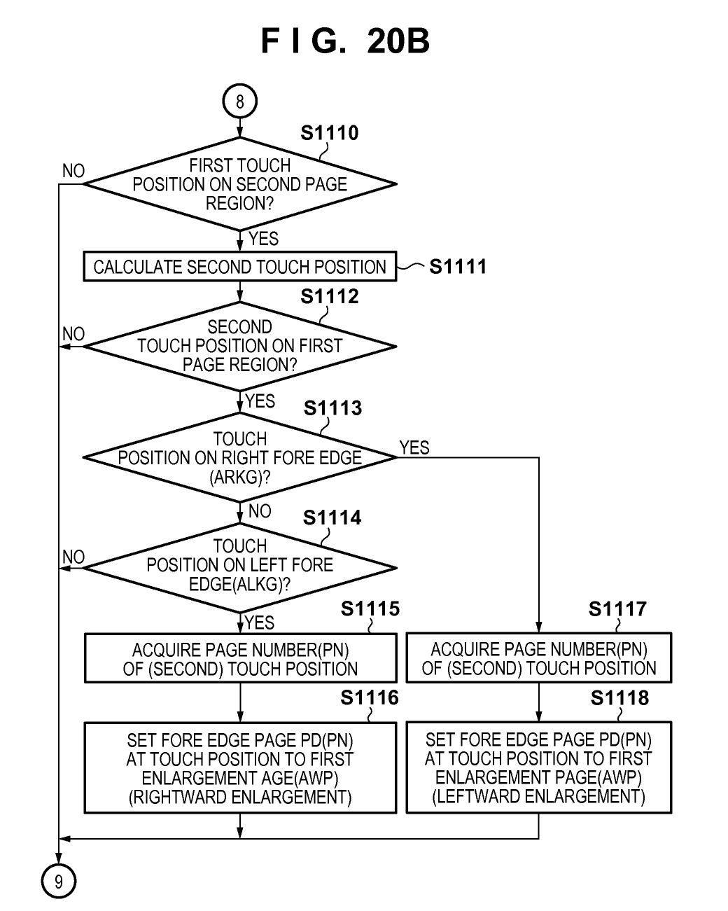

The double touch processing in step S815 will be described below in detail with reference to the flowcharts of FIGS. 20A and 20B. Note that transition to the double touch state according to the fourth embodiment always occurs via the single touch state, as in the above-described first embodiment. Hence, the double touch processing in step S815 is also executed after the single touch processing in step S812 of the previous loop processing. That is, when executing the double touch processing, the first touch position CTA1 has already been calculated, and the display of the first and second enlargement pages and the fore edges has already been done in accordance with the first touch position CTA1 and the display mode.

In step S1101, it is determined whether the already calculated first touch position CTA1 is located in the first page region APA. If YES in step S1101, the process advances to step S1102. If NO in step S1101, the process advances to step S1110. In step S1102, a second touch position CTA2 is calculated as the center of gravity of the contact region of the second touch TA2. In step S1103, it is determined whether the second touch position CTA2 is located in the second page region BPA. If YES in step S1103, the process advances to step S1104. If NO in step S1103, the process advances to step S1119.

In step S1104, it is determined whether the second touch position CTA2 is located on the left fore edge BLKG. If YES in step S1104, the process advances to step S1105. If NO in step S1104, the process advances to step S1107. In step S1105, the page number of the fore edge page PD[i] under the second touch position CTA2 is acquired to set PN=i. In step S1106, the page data is enlarged rightward while fixing the left edge of the fore edge page PD[PN] obtained in step S1105 and set as the second enlargement page (BWP=PD[PN]), and the second enlargement page number is set (BP=PN). The process then advances to step S1119.

In step S1107, it is determined whether the second touch position CTA2 is located on the right fore edge BRKG. If YES in step S1107, the process advances to step S1108. If NO in step S1107, the process advances to step S1119. In step S1108, the page number i of the fore edge page PD[i] under the second touch position CTA2 is acquired to set PN=i. In step S1109, the page data is enlarged leftward while fixing the right edge of the fore edge page PD[PN] obtained in step S1108 and set as the second enlargement page BWP (=PD[PN]), and the second enlargement page number is set (BP=PN). The process then advances to step S1119.

On the other hand, in step S1110, it is determined whether the first touch position CTA1 is located in the second page region BPA. If YES in step S1110, the process advances to step S1111. If NO in step S1110, the process advances to step S1119. In step S1111, the second touch position CTA2 is calculated as the center of gravity of the contact region of the second touch TA2. In step S1112, it is determined whether the second touch position CTA2 is located in the first page region APA. If YES in step S1112, the process advances to step S1113. If NO in step S1112, the process advances to step S1119.

In step S1113, it is determined whether the second touch position CTA2 is located on the right fore edge ARKG. If YES in step S1113, the process advances to step S1117. If NO in step S1113, the process advances to step S1114. In step S1117, the page number i of the fore edge page PD[i] under the second touch position CTA2 is acquired to set PN=i. In step S1118, the page data is enlarged leftward while fixing the right edge of the fore edge page PD[PN] obtained in step S1117 and set as the first enlargement page AWP (=PD[PN]), and the first enlargement page number is set (AP=PN). The process then advances to step S1119.

In step S1114, it is determined whether the second touch position CTA2 is located on the left fore edge ALKG. If YES in step S1114, the process advances to step S1115. If NO in step S1114, the process advances to step S1119. In step S1115, the page number of the fore edge page PD[i] under the second touch position CTA2 is acquired to set PN=i. In step S1116, the page data is enlarged rightward while fixing the left edge of the fore edge page PD[PN] obtained in step S1115 and set as the first enlargement page AWP (=PD[PN]), and the first enlargement page number is set (AP=PN). The process then advances to step S1119.

In step S1119, the contents are displayed in the first and second enlargement pages AWP=PD[AP] and BWP=PD[BP] under touch selection, but no contents are displayed in the fore edge pages. Note that each enlargement page may be displayed together with, for example, a frame to improve the visibility.

Page Turning Operation

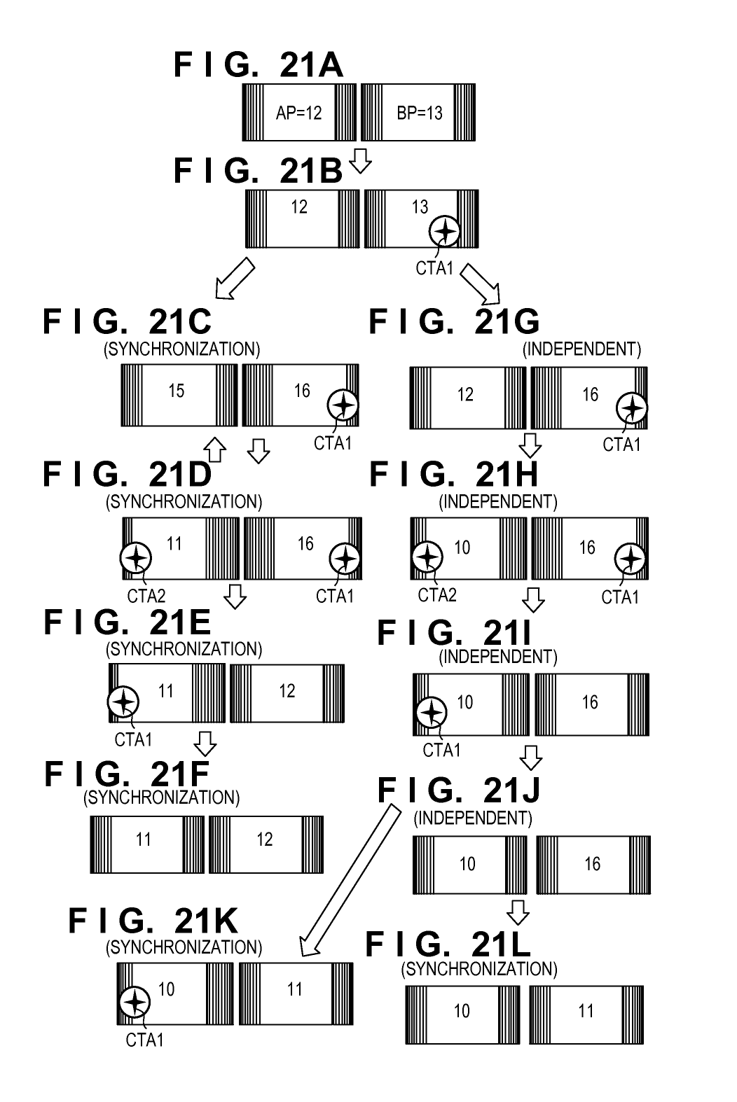

The user's page turning operation and the response of the apparatus according to the fourth embodiment will be described below in detail with reference to the display screens shown in FIGS. 21A to 21L. Corresponding step numbers in FIGS. 17 to 20 will be mentioned for the operations to be described below.

Synchronization Mode

The page turning operation in the synchronization mode will be described first.

The screen shown in FIG. 21A indicates a state in which several pages are turned over, and 12P and 13P are displayed as the first/second enlargement pages (AP=12, BP=13) of the double-page spread in the home position (S809) under the synchronization mode setting. Assume that in this state, the user drags a single touch in the second enlargement page from the first touch position CTA1 shown in the screen of FIG. 21B to the first touch position CTA1 shown in the screen of FIG. 21C. The procedure of processing during the drag operation loops through S808 (YES)-S810 (YES)-S811-S812-S817-S818 (NO)-S806 (NO)-S808 (YES). At this time, in the single touch processing (S812), the processing is performed on the path S1001-S1002-S1003 (NO)-S1010 (YES)-S1011 (YES)-S1014-S1015 (YES)-S1016-S1017. At this time, the position CTA1 during the drag is calculated as needed (S1001), PN that satisfies CTA1⊂PD[PN] is acquired (S1002), BWP=PD[PN] and BP=PN are set (S1014), and AWP=PD[PN-1] and AP=PN−1 are set (S1016). During the drag, AWP and BWP sequentially change in synchronism as (AWP=PD[13], BWP=PD[14]), (AWP=PD[14], BWP=PD[15]), and (AWP=PD[15], BWP=PD[16]).

Next, assume that in the single touch state shown in the screen of FIG. 21C, the user gives the second touch position CTA2 to a position PD[11] in the first left fore edge ALKG as shown in the screen of FIG. 21D (double touch state). In this case, the processing loops through S808 (YES)-S810 (NO)-S813 (YES)-S814-S815-S816-S817-S818 (NO)-S806 (NO)-S808 (YES). At this time, in the double touch processing (S815), the processing is performed on the path S1101 (NO)-S1110 (YES)-S1111-S1112 (YES)-S1113 (NO)-S1114 (YES)-51115-S1116-S1119. At this time, the second touch position CTA2 is calculated (S1111), PN (=11) that satisfies CTA2⊂PD[PN] is acquired (S1115), AWP=PD[11] and AP=11 are set (S1116), thereby obtaining the display as shown in the screen of FIG. 21D.

Assume that the user cancels the left-side second touch position CTA2 from the double touch state shown in the screen of FIG. 21D. In this case, the processing loops through S808 (YES)-S810 (YES)-S811-S812-S817-S818 (NO)-S806 (NO)-S808 (YES). At this time, in the single touch processing (S812), the processing is performed on the path S1001-S1002-S1003 (NO)-S1010 (YES)-S1011 (NO)-S1015 (YES)-S1016-S1017. At this time, PN (=16) that satisfies the first touch position CTA1⊂PD[PN] is acquired (S1002), and AWP=PD[PN−1]=PD[15] and AP=15 are set (S1016), thereby returning the screen state shown in FIG. 21C.

Assume that the user cancels the right-side first touch position CTA1 from the double touch state shown in the screen of FIG. 21D. In this case, the processing loops through S808 (YES)-S810 (YES)-S811-S812-S817-S818 (NO)-S806 (NO)-S808 (YES). At this time, in step S811, the current second touch position CTA2 (⊂PD[11]) is newly set as the first touch position CTA1. In the single touch processing (S812), the processing is performed on the path S1001-S1002-S1003 (YES)-S1004 (NO)-S1006 (NO)-S1008 (YES)-S1009-S1017. At this time, PN (=11) that satisfies the first touch position CTA1⊂PD[PN] is acquired (S1002), and BWP=PD[PN+1]=PD[12] and BP=12 are set (S1009), thereby returning the screen state shown in FIG. 21E.

When the user cancels the touch from the single touch state shown in the screen of FIG. 21E to set the release state, in step S809, the current pages are displayed as a double-page spread in the home position, as shown in the screen of FIG. 21F.

Independent Mode

The page turning operation in the independent mode will be described next.

Assume that under the independent mode setting, the user drags from the first touch position CTA1 shown in the screen of FIG. 21B to the first touch position CTA1 shown in the screen of FIG. 21G. The procedure of processing during the drag operation loops through S808 (YES)-S810 (YES)-S811-S812-S817-S818 (NO)-S806 (NO)-S808 (YES). At this time, in the single touch processing (S812), the processing is performed on the path S1001-S1002-S1003 (NO)-S1010 (YES)-S1011 (YES)-S1014-S1015 (NO)-S1017. At this time, the position CTA1 during the drag is calculated as needed (S1001), PN that satisfies CTA1⊂PD[PN] is acquired (S1002), and BWP=PD[PN] and BP=PN are set (S1014). That is, during the drag, AWP=PD[12] remains unchanged, and only BWP sequentially changes as BWP=PD[14]→PD[15]→PD[16].

Next, assume that in the single touch state shown in the screen of FIG. 21G, the user gives the second touch position CTA2 to a position PD[10] in the first left fore edge ALKG as shown in the screen of FIG. 21H (double touch state). In this case, the processing loops through S808 (YES)-S810 (NO)-S813 (YES)-S814-S815-S816-S817-S818 (NO)-S806 (NO)-S808 (YES). At this time, in the double touch processing (S815), the processing is performed on the path S1101 (NO)-S1110 (YES)-S1111-S1112 (YES)-S1113 (NO)-S1114 (YES)-S1115-S1116-S1119. At this time, the second touch position CTA2 is calculated (S1111), PN (=10) that satisfies CTA2⊂PD[PN] is acquired (S1115), AWP=PD[10] and AP=10 are set (S1116), thereby obtaining the display as shown in the screen of FIG. 21H.

Assume that the user cancels the right-side first touch position CTA1 from the double touch state shown in the screen of FIG. 21H. In this case, the processing loops through S808 (YES)-S810 (YES)-S811-S812-S817-S818 (NO)-S806 (NO)-S808 (YES). At this time, in step S811, the current second touch position CTA2 (⊂PD[10]) is newly set as the first touch position CTA1. In the single touch processing (S812), the processing is performed on the path S1001-S1002-S1003 (YES)-S1004 (NO)-S1006 (NO)-S1008 (NO)-S1017. With this processing, AP (=10) and BP (=16) remain unchanged, and the second enlargement page BWP is displayed in the home position, as shown in the screen of FIG. 21I (S1017).

When the user cancels the touch from the single touch state shown in the screen of FIG. 21I to set the release state, the current pages including the first enlargement page AWP are displayed in the home position, as shown in the screen of FIG. 21J (S809).

Switching from Independent Mode to Synchronization Mode

The page turning operation upon switching from the independent mode to the synchronization mode will be described next.

Assume that switching from the independent mode to the synchronization mode is done in the release state shown in the screen of FIG. 21J. In this case, step S806 results in YES, and mode switching processing in step S807 is performed. In the mode switching processing, the processing is performed on the path S901-S902 (NO)-S904-S905 (YES)-S906. At this time, AP=10 and BP=16 are acquired (S901), and BP=AP+1=11 is newly set (S906). In step S809, the continuous pages are displayed as a double-page spread in the home position, as shown in the screen of FIG. 21L.

Assume that switching from the independent mode to the synchronization mode is done in the single touch state shown in the screen of FIG. 21I. In this case, step S806 results in YES, and mode switching processing in step S807 is performed. In the mode switching processing, the processing is performed on the path S901-S902 (NO)-S904-S905 (NO)-S907 (YES)-S908. At this time, AP=10 and BP=16 are acquired (S901), and BP=AP+1=11 is newly set (S908). In step S1017 of the single touch processing, the continuous pages are displayed, as shown in the screen of FIG. 21K.

Switching from Synchronization Mode to Independent Mode

The page turning operation upon switching from the synchronization mode to the independent mode will be described. In this case, in the mode switching processing (S807), the processing is performed on the path S901-S902 (NO)-S903, and AP and BP do not change. That is, the display does not change.

Effects Obtained by Fourth Embodiment

As described above, according to the fourth embodiment, setting the independent mode as the display mode allows to display two continuous pages as a double-page spread or refer to a relatively close page. Setting the independent mode allows to refer to an arbitrary page far apart. Even during display of an electronic document, the setting of the independent mode and the synchronization mode can be changed. It is therefore possible to efficiently access interesting associated information while following arbitrary associated pages one after another from the origin page.

### Fifth Embodiment

The fifth embodiment of the present invention will be described below. As a characteristic feature of the fifth embodiment, a touch bar is displayed on a display device 15 in place of fore edges.

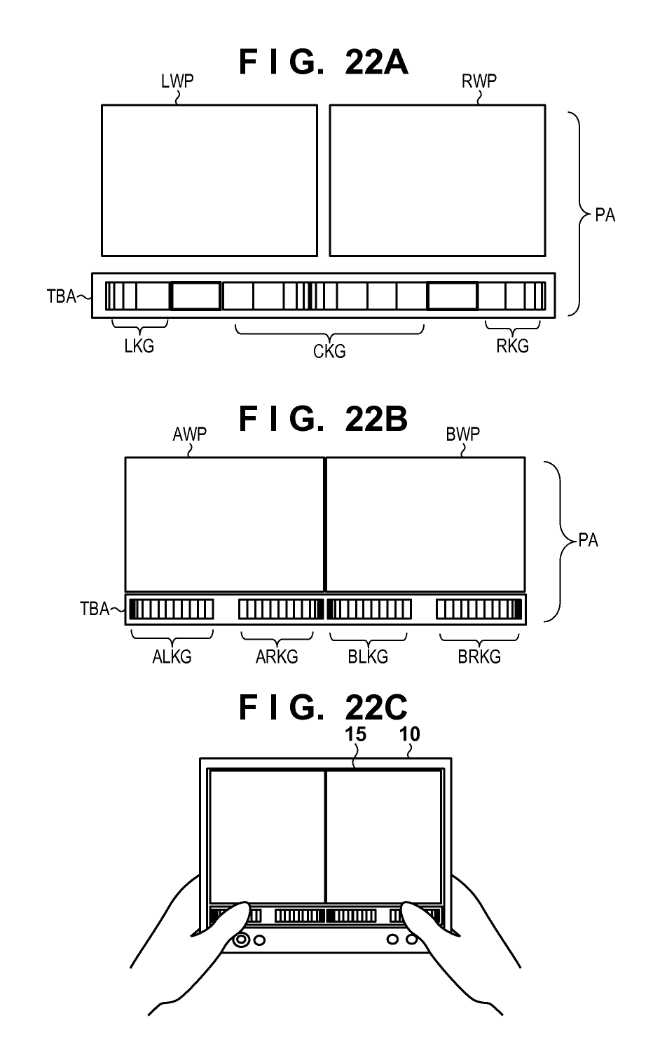

FIGS. 22A to 22C are views showing the page display format of the display device 15 according to the fifth embodiment. In the fifth embodiment, a touch bar TBA is arranged under a double-page spread (LWP/RWP), and wider fore edges are arranged in the touch bar TBA, as shown in FIGS. 22A to 22C.

FIG. 22A shows an example in which a left fore edge LKG, a middle fore edge CKG, and a right fore edge RKG according to the above-described first to third embodiments are arranged in a larger width in the touch bar TBA. Note that in the touch bar TBA, the left/right enlargement pages are added with frames to improve the visibility.

FIG. 22B shows an example in which a first left fore edge ALKG, first right fore edge ARKG, a second left fore edge BLKG, and a second right fore edge BRKG according to the above-described fourth embodiment are arranged in a larger width in the touch bar TBA.

FIG. 22C shows a state in which the user is holding an electronic book 10 with the display shown in FIG. 22B by both hands and operating in the fifth embodiment. The user performs a page turning operation by touching or tracing the fore edges (ALKG/ARKG/BLKG/BRKG) in the touch bar TBA displayed on the display device 15 by fingers of one hand or both hands.

Note that the display position of the touch bar TBA is not limited to the lower portion of the double-page spread. The touch bar TBA can be arranged in one of the left, right, upper, and lower portions of the double-page spread or in a region combining them horizontally or vertically.

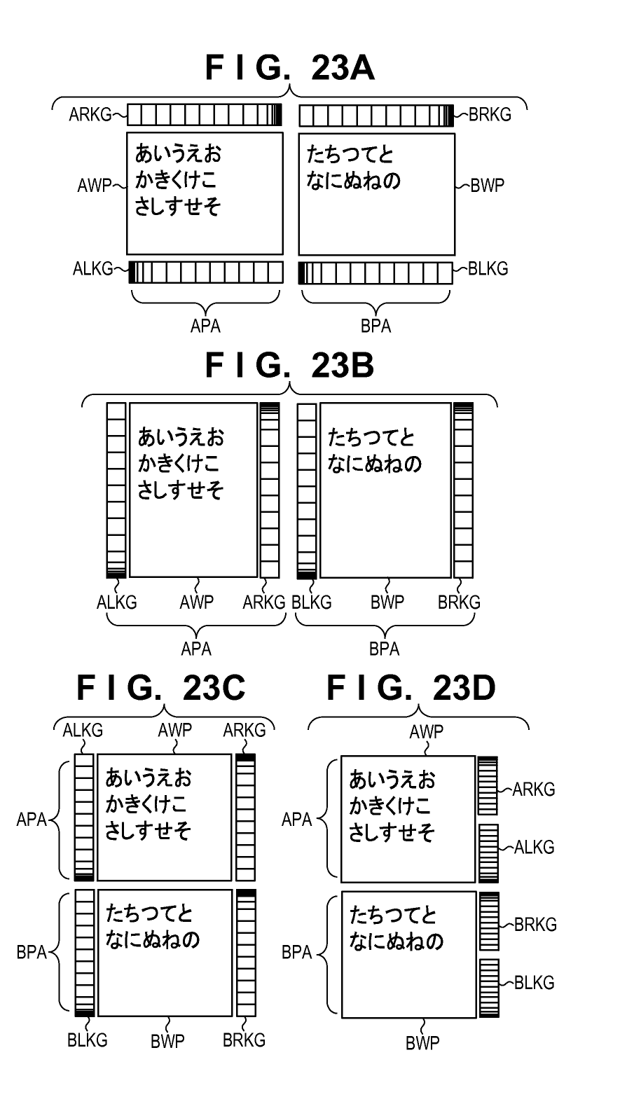

FIGS. 23A to 23D show another form of fore edge display by the touch bar TBA.

FIG. 23A shows an example in which the first left fore edge ALKG is arranged horizontally in the lower portion of a first enlargement page AWP, and the first right fore edge ARKG is arranged horizontally in the upper portion. For a second enlargement page BWP as well, the second left fore edge BLKG is arranged horizontally in the lower portion, and the second right fore edge BRKG is arranged horizontally in the upper portion.

FIG. 23B shows an example in which the first left fore edge ALKG and the first right fore edge ARKG are arranged vertically on both sides of the first enlargement page AWP. For the second enlargement page BWP as well, the second left fore edge BLKG and the second right fore edge BRKG are arranged vertically on both sides.

FIG. 23C shows an example in which a first page region APA and a second page region BPA are vertically arranged, and the fore edges are arranged vertically on both sides of the regions. FIG. 23D shows an example in which the first page region APA and the second page region BPA are vertically arranged, and the fore edges are arranged vertically on one side of the regions.

As described above, according to the fifth embodiment, since the width of each fore edge page can be set larger as compared to the above-described first to fourth embodiments, the user can perform the page turning operation more easily.

According to the above-described embodiments, when displaying an electronic document on the page basis, it is possible to perform a flexible page display operation such as referring to another page in the same size, comparison, jump, or return while browsing an arbitrary page.

### Other Embodiments

In the above-described first to fifth embodiments, an electronic book whose pages are turned over from the left to the right has been exemplified. However, the present invention is also applicable to an electronic book whose pages are turned over from the right to the left.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-264115, filed Dec. 1, 2011, which is hereby incorporated by reference herein in its entirety.

1. A display apparatus comprising:
a display unit that displays a first page display region where a first page of a content is displayed, a second page display region where a second page of the content is displayed, and a fore edge region indicating presence of a page different from the first page and the second page;
a detecting unit that detects a touch position on the first page display region, the second page display region, and the fore edge region displayed by said display unit; and
a changing unit that, when touches to two positions including a first touch position on the first page display region and a second touch position on the fore edge region are detected as a touch operation of a user, changes the second page to a page corresponding to the second touch position without changing the first page.

2. The apparatus according to claim 1, wherein when a touch to one position on the fore edge region is detected as the touch operation, said changing unit changes each of the first page and the second page to a page corresponding to the touch position.

3. The apparatus according to claim 1, wherein when movement of the touch position on the fore edge region is detected as the touch operation of the user, said changing unit sequentially sets a page corresponding to the touch position as the second page in accordance with the movement of the touch position.

4. The apparatus according to claim 1, wherein the fore edge region includes
a first fore edge region indicating presence of a page before the first page,
a second fore edge region indicating presence of a page after the second page, and
a third fore edge region indicating presence of a page between the first page and the second page when the first page and the second page do not continue.

5. The apparatus according to claim 4, wherein said display unit displays the first page display region, the second page display region, the first fore edge region, the second fore edge region, and the third fore edge region in an arrangement order of the first fore edge region, the first page display region, the third fore edge region, the second page display region, and the second fore edge region.

6. The apparatus according to claim 1, wherein a display size of the fore edge region becomes large as the number of corresponding pages increases.

7. The apparatus according to claim 1, wherein the fore edge region includes a plurality of fore edge page regions, and each of the plurality of fore edge page regions corresponds to one of the pages of the content.

8. The apparatus according to claim 7, wherein each of the plurality of fore edge page regions corresponds to two continuous pages of the content.

9. The apparatus according to claim 1, wherein when the touch position is not detected, said display unit displays two continuous pages of the content in each of the first page display region and the second page display region.

10. The apparatus according to claim 1, further comprising a bookmark placement unit that places a bookmark on a displayed page when said display unit displays the first page and the second page beyond a predetermined time in a state in which the first page and the second page do not continue.

11. The apparatus according to claim 10, wherein
said display unit displays the bookmark, and
when a touch to the bookmark is detected as the touch operation, said changing unit sets a page corresponding to the bookmark to one of the first page and the second page.

12. The apparatus according to claim 1, further comprising a setting unit that sets, as a display mode of said display unit, one of a synchronization mode in which the first page display region and the second page display region perform display in synchronism with each other and an independent mode in which the first page display region and the second page display region independently perform display,
wherein when a touch to one position is detected by said detecting unit, said display unit displays two continuous pages in the first page display region and the second page display region when the synchronization mode is set, and sets pages independent from each other as the first page and the second page when the independent mode is set.

13. The apparatus according to claim 12, wherein said setting unit can change the setting of the display mode during display of the content.

14. A display method of a display apparatus, comprising:
a display step of displaying, on a display screen, a first page display region where a first page of a content is displayed, a second page display region where a second page of the content is displayed, and a fore edge region indicating presence of a page different from the first page and the second page;
a detecting step of detecting a touch position on the first page display region, the second page display region, and the fore edge region displayed on the display screen; and
a changing step of, when touches to two positions including a first touch position on the first page display region and a second touch position on the fore edge region are detected as a touch operation of a user, changing the second page to a page corresponding to the second touch position without changing the first page.

15. A non-transitory computer readable storage medium storing a program to be loaded to and executed by a computer,
the computer executing the program to execute:
a display step of displaying, on a display screen, a first page display region where a first page of a content is displayed, a second page display region where a second page of the content is displayed, and a fore edge region indicating presence of a page different from the first page and the second page;
a detecting step of detecting a touch position on the first page display region, the second page display region, and the fore edge region displayed on the display screen; and
a changing step of, when touches to two positions including a first touch position on the first page display region and a second touch position on the fore edge region are detected as a touch operation of a user, changing the second page to a page corresponding to the second touch position without changing the first page.

16. A display apparatus comprising:
a display unit that displays a display region where a content is displayed, and a fore edge region indicating presence of a page different from the page of the content displayed in the display region; and
a detecting unit that detects a touch position on the display region and the fore edge region displayed by said display unit,
wherein when touches to two positions including a first touch position on the display region and a second touch position on the fore edge region are detected as a touch operation of a user, said display unit displays a region where a first page of the content is stationarily displayed in the display region, and a region where pages of the contents are displayed while being turned over in correspondence with the second touch position.

17. A display method of a display apparatus, comprising:
a display step of displaying, on a display screen, a display region where a content is displayed, and a fore edge region indicating presence of a page different from the page of the content displayed in the display region; and
a detecting step of detecting a touch position on the display region and the fore edge region displayed on the display screen,
wherein when touches to two positions including a first touch position on the display region and a second touch position on the fore edge region are detected as a touch operation of a user, in the display step, a region where a first page of the content is stationarily displayed in the display region, and a region where pages of the contents are displayed while being turned over in correspondence with the second touch position are displayed on the display screen.

18. A non-transitory computer readable storage medium storing a program to be loaded to and executed by a computer,
the computer executing the program to execute:
a display step of displaying, on a display screen, a display region where a content is displayed, and a fore edge region indicating presence of a page different from the page of the content displayed in the display region; and
a detecting step of detecting a touch position on the display region and the fore edge region displayed on the display screen,
wherein when touches to two positions including a first touch position on the display region and a second touch position on the fore edge region are detected as a touch operation of a user, in the display step, a region where a first page of the content is stationarily displayed in the display region, and a region where pages of the contents are displayed while being turned over in correspondence with the second touch position are displayed on the display screen.
